(19) United States
(12) Patent Application Publication
(10) Pub. No.: US 2018/0127192 A1
(43) Pub. Date: May 10, 2018

(54) Methods and Apparatus for Automated Food Preparation

(71) Applicant: Adam Cohen, Dallas, TX (US)

(72) Inventor: Adam Cohen, Dallas, TX (US)

(21) Appl. No.: 15/805,074

(22) Filed: Nov. 6, 2017

Related U.S. Application Data
(60) Provisional application No. 62/417,336, filed on Nov. 4, 2016.
(60) Provisional application No. 62/456,008, filed on Feb. 7, 2017.
(60) Provisional application No. 62/471,957, filed on Mar. 15, 2017.
(60) Provisional application No. 62/522,671, filed on Jun. 20, 2017.

(51) Int. Cl. B65D 83/00; A47J 36/32; B26D 7/14; B65D 30/22; B65D 33/00

(52) U.S. Cl. CPC B65D 83/0055; A47J 36/32; B65D 83/06; B65D 31/12; B65D 33/004; B26D 7/14

(57) ABSTRACT

Methods and apparatus for automatically preparing food for consumption in which preparation comprises dispensing, manipulation, heating, and other operations using a wide variety of ingredients. The methods and apparatus described use ingredients efficiently and maintain their quality, while avoiding contact between ingredients and apparatus to minimize the risk of system contamination.

### CROSS REFERENCE TO RELATED APPLICATIONS

U.S. Provisional Patent Application 62/417,336 filed Nov. 4, 2016, U.S. Provisional Patent Application 62/456,008 filed Feb. 7, 2017, U.S. Provisional Patent Application 62/471,957 filed Mar. 15, 2017, and U.S. Provisional Patent Application 62/522,671 filed Jun. 20, 2017. All these applications are incorporated herein by reference as if set forth in full herein.

### STATEMENT OF FEDERALLY FUNDED RESEARCH

Not applicable.

### FIELD OF THE INVENTION

This disclosure generally relates to the fields of robotics/automation and cooking/culinary arts.

### SUMMARY

The automation of food preparation is of significant interest. A highly-automated food preparation system could offer significant benefits, offering a means of reducing labor that is frequently hard to find and costly; increasing the availability of quality food and allowing access in more locations and at more times; facilitating customization to individual tastes, nutritional requirements, and dietary restrictions; reducing the risk of foodborne illness caused by restaurant workers; increasing repeatability by making recipes more quantitative and ensuring they are followed accurately; etc.

It is an object of some embodiments of the invention to assure high ingredient quality by protecting ingredients before use from exposure to the environment, since air and moisture can cause oxidation, desiccation, sogginess, staleness, and other degradation which reduce palatability, and require frequent and wasteful restocking with fresh ingredients.

It is an object of some embodiments of the invention to assure food safety and hygiene by minimizing or eliminating durable components of the apparatus coming into direct contact with ingredients, since otherwise there is danger (without perfect cleaning) of cultivating harmful microbes, or of cross-contamination from other ingredients (including allergens such as peanuts), and if ingredients are not well protected, insects and other vermin may infest them.

It is an object of some embodiments of the invention to offer meal variety by providing dispensing methods and apparatus that are compatible with a very large range of ingredients, including those that might be too delicate, too large, too moist, etc. to dispense by other methods.

It is an object of some embodiments of the invention to provide efficient use of ingredients by minimizing waste when dispensing them.

Other objects and advantages of various embodiments of the invention will be apparent to those of skill in the art upon review of the teachings herein. The various embodiments of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

In a first aspect of the invention a method for automatically transferring at least one food ingredient within at least one sealed flexible package to a receptacle, includes: (a) providing ingredient dispensing means, the dispensing means comprising an actuator-operated mechanized means for unsealing the at least one package; (b) automatically operating the mechanized means to unseal the at least one flexible package; wherein the at least one food ingredient is substantially dispensed from the unsealed package into the receptacle.

Numerous variations of the first aspect of the invention are possible and include, for example: (1) additionally providing a temporary storage location for at least one sealed flexible package that contains at least one food ingredient; (2) variation (1) further including causing an actuator to operate a mechanical means for conveying the at least one sealed package from the temporary storage location to a location more proximate the receptacle; (3) additionally providing compressing means and operating the compressing means to compress the at least one package to assist in dispensing the at least one ingredient; (4) additionally providing a blade, and relatively moving the blade and the package such that at least a portion of the package is moved around the edge of the blade to assist in dispensing the at least one ingredient; (5) the package has at least two sides and wherein the means for unsealing includes gripping means for grasping at least one side of the package, and peeling means for pulling the at least one side of the package away from another side of the package; (6) (i(ba base, and a first surface having at least one port for the passage of air; (ii) a sheet of material having a second and a third surface, the second surface able to contact the first surface of the base and conform to it when air is substantially withdrawn through the at least one port causing the first and second surfaces to come into close contact, and the third surface able to contact the food ingredient; (iii) means for further preparing the ingredient selected from the group consisting of 1) heating, 2) cooling, 3) freezing, 4) boiling, 5) evaporating, and 6) dehydrating; wherein one of the means of element (iii) is operated to further process the ingredient.

In a second aspect of the invention a method for transferring a food ingredient contained within a flexible package having at least one seal to a receptacle, includes: (a) providing an ingredient dispenser in proximity to the receptacle; (b) conveying the flexible package to the dispenser; (c) opening the at least one seal of the flexible package; wherein the food ingredient is dispensed from the flexible package into the receptacle.

Numerous variations of the first aspect of the invention are possible and include, for example: (1) comprising compressing the package to help express the ingredient; (2) providing a blade with an edge and pulling a portion of the package around the edge.

In a third aspect of the invention a method for dispensing a food ingredient from a package, includes: (a) providing a sealed package containing a food ingredient wherein the package comprises at least one flexible film divided into a left portion and a right portion with each portion having an inside and an outside surface with the inside surfaces facing each other and at least a portion of the inside surfaces contacting the ingredient and wherein the portions are sealed to one another to form at least one cavity containing the at least one ingredient and wherein adjacent to the at least one ingredient, the sealing comprises at least one openable seal; (b) providing at least one blade having a lower edge, a near side, and a far side; (c) passing an outside surface of a lower region of one of the portions adjacent to the near side and around the lower edge of the at least one blade to redirect the lower region of the portion to the far side in a direction different than that of the region on the near side of the at least one blade; and (d) tensioning the lower region on the far side of the portion and pulling it around the edge while lowering the package relative to the at least one blade; wherein the seal is opened and at least a portion of the ingredient is dispensed.

Numerous variations of the third aspect of the invention are possible and include, for example: (1) the at least one openable seal joins the portions around at least part of the sides of the at least one ingredient as well as beneath the at least one ingredient and wherein the method further comprises pulling the lower region around the edge enough to at least partially separate the portions on the sides of the at least one ingredient (2) continuing to pull the lower region around the edge to further separate the portions, wherein at least some of the ingredient adhering to the inside surface of the portion are detached from the surface; (3) the variation of (2) wherein at least some of the ingredient comprises substantially all of the ingredient; (4) providing at least one second blade having a lower edge, a near side, and a far side; and passing an outside surface of a lower region of the other portion adjacent to the near side and around the lower edge of the at least one second blade to redirect the lower region of the other portion to the far side in a direction different than that of the region on the near side of the at least one second blade; and tensioning the lower region on the far side of the other portion and pulling the lower region of the other portion around the edge of the at least one second blade while lowering the package relative to the at least one second blade; wherein the seal is opened and at least a portion of the ingredient is dispensed.

In a fourth aspect of the invention a method for dispensing a food ingredient from a package, includes (a) providing a sealed package containing a food ingredient wherein the package comprises at least one flexible film divided into a left portion and a right portion with each portion having an inside and an outside surface with the inside surfaces facing each other and at least a portion of the inside surfaces contacting the ingredient and wherein the portions are sealed to one another to form at least one cavity containing the at least one ingredient and wherein adjacent to the at least one ingredient, the sealing comprises at least one openable seal; (b) grasping a lower region of the left portion using first mechanized grasping means; (c) grasping a lower region of the right portion using second mechanized grasping means; and (d) separating the lower region of the left portion from the lower region of the right portion; wherein the seal is pulled open and at least a portion of the ingredient is dispensed.

In a fifth aspect of the invention a method for manipulating a flexible package to dispense food into a receptacle, includes: (a) providing a flexible package containing at least one ingredient sealed therein to a flexible package handler; (b) operating the flexible package handler to move the sealed flexible package to a flexible package dispensing location; (c) providing a receptacle in a desired lower position relative to the dispensing location; (d) operating a dispensing means, including a means for unsealing the flexible package a predefined amount and for dispensing the at least one ingredient into the vessel.

Numerous variations of the third aspect of the invention are possible and include, for example: (1) comprising compressing the package to expel the ingredient.

In a sixth aspect of the invention, the system for automated food preparation, includes: (a) storage means for storing pouches each containing at least one ingredient; (b) grasping means to hold the packages; (c) transport means for moving the packages to a dispensing location; and (d) dispensing means to unseal the packages at the dispensing location and to dispense the at least one ingredient into a receptacle configured to receive the at least one ingredient.

Numerous variations of the third aspect of the invention are possible and include: (1) the dispensing means comprises at least one element able to squeeze the package.

In a seventh aspect of the invention, a method of dispensing an ingredient from a flexible package into a receptacle, includes: (a) providing a dispenser configured to unseal the package; (b) determining whether the ingredient is flowable; (c) unsealing the package; and (d) compressing the package if the ingredient is flowable; wherein the flowable ingredient is dispensed from the package into the receptacle.

In an eighth aspect of the invention, an apparatus for conductively heating or cooling a food ingredient, includes: (a) a base, and a first surface having at least one port for the passage of air; (b) a sheet of material having a second and a third surface, the second surface able to contact the first surface of the base and conform to it when air is substantially withdrawn through the at least one port causing the first and second surfaces to come into close contact, and the third surface able to contact the food ingredient; (c) means for further preparing the ingredient selected from the group consisting of 1) heating, 2) cooling, 3) freezing, 4) boiling, 5) evaporating, and 6) dehydrating.

Numerous variations of the third aspect of the invention are possible and include: (1) at least one heating or cooling element integrated with the base.

In a ninth aspect of the invention, an automated food preparation system, includes: (a) means for storing a plurality of pouches each containing at least one ingredient; (b) means for mechanically grasping and transporting at least one pouch; (c) means for mechanically opening and dispensing the at least one ingredient into a receptacle from the at least one pouch.

Numerous variations of the third aspect of the invention are possible and include (1) the at least one pouch comprises a plurality of pouches and wherein a plurality of ingredients are dispensed into the receptacle; and (2) means for compressing the pouch

Numerous additional variations of the aspects are possible and may include for example, variations associated with one aspect of the invention being applied to other aspects such as variation (6) of claim 1 being applied to all the other aspects except aspect 8 which already contains these limitations.

Other aspects of the invention will be understood by those of skill in the art upon review of the teachings herein. Other aspects of the invention may involve combinations of the above noted aspects or variations of aspects of the invention. It is intended that variations of one aspect of the invention may be applied to other aspects of the invention and that various features of one or more aspects of the invention be useable in other aspects of the invention and even that sub-combinations of various features of one or more aspects of the invention may provide new aspects of the invention. Combinations are considered appropriate so long as the combinations do not remove all functionality provided by individual components. These other aspects of the invention may provide various combinations and sub-combination of the aspects presented above as well as provide other configurations, structures, functional relationships, processes for making, and/or procedures for using that have not been specifically set forth above.

### BRIEF DESCRIPTION OF THE DRAWINGS

FIGS. 1(a)-(d) depict flexible packages, including approaches to hanging them.

FIGS. 2(a)-(g) are views of packages specialized for certain ingredients.

FIGS. 3(a)-(g) illustrate packages with dispensing elements enabled while opening the packages.

FIGS. 4(a)-(n) depict a manipulator for use with pouches.

FIGS. 5(a)-(i) show a series of steps in the dispensing of an ingredient.

FIGS. 6(a)-(b) are views of apparatus for pushing an ingredient out of a package.

FIGS. 7(a)-(e) illustrate methods and apparatus for regulating the dispensing of ingredients.

FIGS. 8(a)-(k) depict packages including packages with multiple compartments, and steps in dispensing from a pouch.

FIGS. 9(a)-(b) are views of an alternative package for an ingredient.

FIGS. 10(a)-(g) illustrate a vessel comprising a base and liner.

FIGS. 11(a)-(f) depict base, liners, and lids for processing ingredients.

FIGS. 12(a)-(g) are views showing bases, liners, and motions for processing ingredients.

FIGS. 13(a)-(d) illustrate a base and liner from which an ingredient may be dispensed.

FIGS. 14(a)-(d) depict liners combined with elements allowing serving and consumption.

FIGS. 15(a)-(c) are views of specialized approaches to dispensing ingredients.

FIGS. 16(a)-(i) illustrate food preparation tools and associated cleaning approaches.

FIGS. 17(a)-(e) depict a series of steps involving food preparation and tool cleaning.

FIGS. 18(a)-(g) are views of a vessel and steps in emptying it.

FIGS. 19(a)-(l) illustrate an automated system for food preparation and various operations performed by it.

FIGS. 20(a)-(j) depict a vessel, lid, and liners and their use in processing food.

FIG. 21 is a view of a flexible package which may be used in a system.

FIGS. 22(a)-(d) and FIGS. 23(a)-(b) illustrate a system for printing a food.

FIGS. 24(a)-(b) depict an individual peelable package.

FIGS. 25(a)-(j) are views of steps for sealing and loading packages.

FIGS. 26(a)-(b) illustrate a system for preparing a meal from multiple ingredients.

FIGS. 27(a)-(c′) depict ingredient dispensers.

FIGS. 28(a)-(c) are views of steps in a process for dispensing an ingredient.

FIGS. 29(a)-(d) illustrate dispensers, receptacles, and transport components in a system for preparing a meal.

FIGS. 30(a)-(b) depict apparatus for sealing a package.

FIGS. 31(a)-(l) are views of a system for food preparation, including operational steps.

FIG. 32 is a flowchart depicting steps in the production of a meal.

### DETAILED DESCRIPTION OF THE EMBODIMENTS

### Ingredient Pouches

Key problems associated with automated food preparation may be addressed by providing ingredients in containers or packages which can be handled by suitable apparatus, processes, and algorithms in various embodiments of a food preparation system. In this regard, properly-designed flexible packages, or pouches, are particularly advantageous in terms of ingredient quality (e.g., freshness), food safety, and the near-infinite variety of ingredients that can be stored and dispensed. They are also affordable and in many cases, fully recyclable. Among the benefits of pouches over alternative packages such as rigid containers are the following, in no particular order: 1) low cost; 2) compact and lightweight (overall volume is small; can be stored closely together, especially when empty); 3) environmentally friendly, using less material (and often fully recyclable); 4) easily made in different sizes and shapes; 5) can serve as pulseless, pre-primed peristaltic-like pumps to dispense flowable ingredients without contact over a wide range of viscosities; 6) can be evacuated, provided with barrier layers, and filled with gasses to prolong shelf life, avoid oxidation, etc.; 7) can easily be opened by cutting, peeling, etc.; 8) can be opened to their full-width to release large items; 9) allows ingredients to be cooked (e.g., sous vide), warmed, or cooled within the pouch; 10) can be subdivided into compartments; 11) easily sealed, can be re-sealed if desired; 12) allows “on the side” ingredients such as salad dressing to be delivered directly to customers in convenient form; 13) can include fitments such as spouts and vents; 14) can be used for in-pouch processing such as coating (e.g., with breadcrumbs), mixing, beating, blending, marinating, and other operations involving multiple ingredients (e.g., a pouch containing fish can be emptied into another pouch containing a coating mix which is then sealed and tumbled).

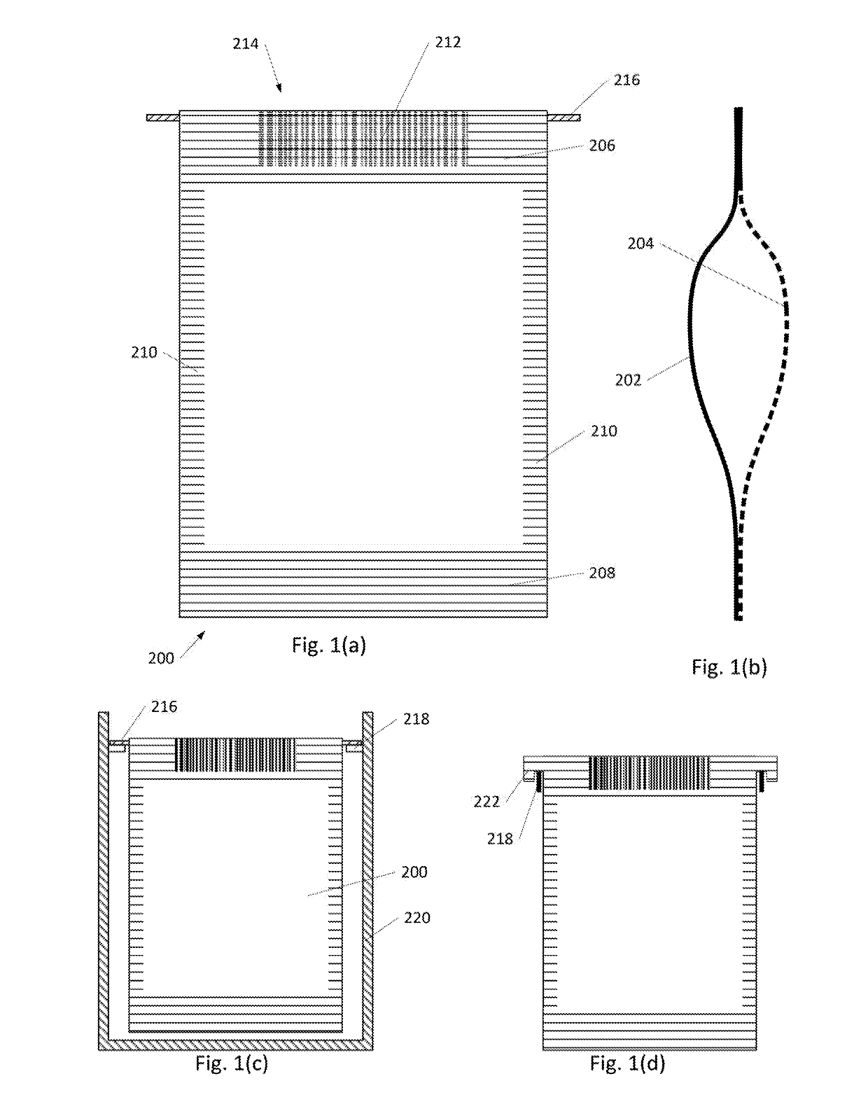

FIGS. 1(a)-(b) depict front elevation and side elevation cross-sectional views, respectively, of a representative pouch able to contain one or more food ingredients, a fully-prepared meal, etc. Pouches may have very different appearances than as shown, especially if vacuum packed. Pouches may be made in different shapes and sizes (e.g., wide for items such as steaks, chicken breasts, fish fillets, cheese and bread slices, tortillas, and sliced tomatoes; or narrow for asparagus). Pouch contents may be as-supplied or in a partially-processed state (e.g., ingredients added to a pouch for use at a later time during the preparation process of a specific meal). Hereinafter, the term “ingredient” shall generally refer to any and all contents of a pouch, including multiple distinct ingredients which may co-occupy a pouch, as applicable. The pouch can be made from various materials including combinations of materials (e.g., in different layers) such as polymers (e.g., polyethylene, polypropylene, polyethylene terephthalate) and metals. For longer term storage of food, for example, the pouch may comprise a barrier layer known to the art such as EVOH or a metal film, as is typically found in a retort pouch. Pouches may be produced in various sizes and shapes, depending on the ingredients they are meant to hold.

In some embodiments a pouch 200 is formed from two sheets of material such as a polymer film, forming walls 202 and 204. The lines (solid and dashed to easily distinguish them) representing pouch walls 202 and 204 in the sectional view (FIG. 1(b)) are shown touching on the top and bottom with a volume/cavity between the walls in the central region for holding ingredients; this cavity may result from the deformation of the flexible walls of the pouch or may be formed (e.g., thermoformed). Walls 202 and 204 may be sealed along four edges, with a top seal 206, a bottom seal 208, and two side seals 210 such that pouch contents cannot normally escape. Some pouches may have seals (e.g., the bottom seal) at a location further from an edge. Pouches are not necessarily four-sided: pouches that are circular, elliptical, or polygonal with other than four sides are also possible. The sealed region may be wide or narrow, and may vary from those shown. Sealing may be achieved (e.g., with pouches having an inner polymer layer) by pressing two sheets together and applying heat at an appropriate temperature, via ultrasonic sealing, etc. as is known to the art of flexible packaging. Before completely sealing food within a pouch, the interior can be evacuated of air (partially or substantially fully) and in some embodiments also filled with an inert gas such as nitrogen. Vacuum and/or an inert gas can be used to delay food spoilage, loss of flavor or color, etc., as is well known in the art. Pouches can be designed for single use (and are preferably recycled) or designed for re-use at least several times. In some embodiments, the pouch is at least partially transparent/translucent, and in some embodiments text and/or graphic elements may be incorporated into the pouch.

In some embodiments a bar code 212 is incorporated in the pouch that can be read externally using a standard bar code reader, camera, or other means, to identify the contents of the pouch. In some embodiments, a quick response (QR) code, an RFID tag, a near field communications (NFC) tag, or other machine-readable code may be used for identification. The location of these elements may be toward the top of the pouch 214 as shown for the bar code in the figure, or elsewhere, depending on how the pouch is accessed. In some embodiments, a bar code may be located along the (e.g., narrow) upper edge of the pouch. In some embodiments, the code may be located where it will still be readable once the pouch is opened, and in some embodiments multiple codes or code types (e.g., RFID, bar code) may be provided for redundancy). Codes as well as other markings may provide information in addition to ingredient identification (e.g., peas, spaghetti sauce) such as method of dispensing (e.g., if the ingredient is flowable, dispensing it with the aid of apparatus that can compress the pouch), date of manufacture, lot number, “best before”/expiration date, manufacturer/packing facility, volume, weight (e.g., both filled and empty weights, so that the system can determine the pouch fill level and even detect leaking pouches by measuring weight, etc.) and/or volume, configuration (e.g., number and location of compartments, described below), anticounterfeiting authentication-related data or markings, etc. Indeed, systems can be implemented that will automatically allow a single food preparation apparatus to signal others directly or through a network that a problem exists with a particular ingredient, and according to an algorithm or human intervention, pouches of the same lot or manufacturer/packer can be quarantined. This capability can prevent the spread of foodborne illness before it has gone very far. In some embodiments the codes may be written in a common language and be interpretable or understandable directly by humans or other markings may be added to the package that are interpretable directly by humans. In some embodiments codes may provide processing instructions to a preparation system either for processing a single pouch or for processing a plurality of associated pouches in a desired order.

In some embodiments, holes (e.g., two circular holes, one circular hole and one slot) or a support (e.g., stiff wire 216, a thicker plastic film) is incorporated in pouch 200 (e.g., during sealing), to allow it to be suspended from a support rail 218 e.g., within a storage chamber (e.g., refrigerated) or tank 220 that may be filled with cold water, an ice/water/salt mixture for freezing, or heated water for sous vide cooking as shown in FIG. 1(c), with the weight of the pouch allowing it to hang vertically. The sides of chamber/tank 220 prevent lateral motion which may cause the support to slide off the rail. In other embodiments, pouch 200 is die cut, etc. to produce tab 222 (FIG. 1(d)) which may have a notch to accept a rail, much like a hanging file folder. In other embodiments, one or more through holes may extend through a sealed portion of the pouch into which guides may be inserted or into which grippers or other grasping elements may take a firm hold.

Pouches may be purchased pre-loaded with ingredients, for example, at a grocery store, or delivered by a meal kit delivery service company such as Blue Apron (New York, N.Y.). Pouches may be provided either individually or as kits which include all the ingredients needed for a specific dish in a set of pouches. Pouches that are part of a kit can be gang-loaded into the system (e.g., a storage chamber) all at once. Pouches can also be loaded by the user of the food preparation system. Ingredients within pouches are, depending on system capabilities, ready for use in food preparation. If the system is capable of slicing, for example, then the ingredient may be unsliced, while if the system if incapable of peeling, for example, then the ingredient may be pre-peeled (e.g., by the delivery service company). If the system is modular, then additional capabilities can be added over time, minimizing the required amount of preparation in the ingredients (and maximizing freshness: e.g., providing the system with an unpeeled apple versus one which is peeled and sealed to avoid discoloration).

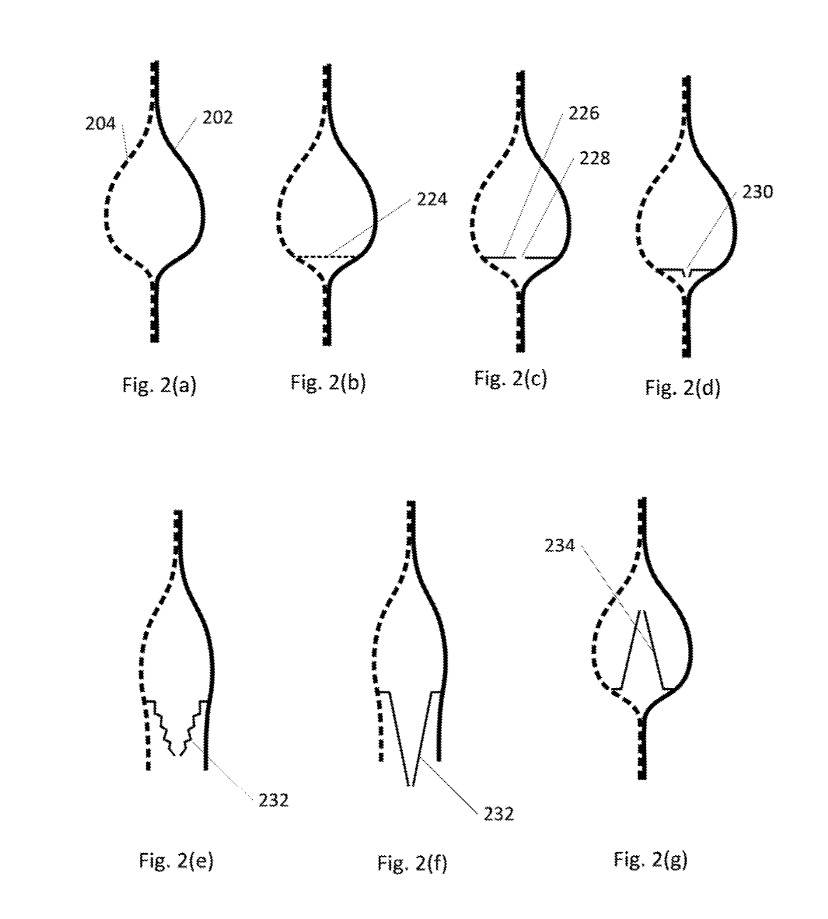

FIGS. 2(a)-(g) depict side elevation cross-sectional views of pouches intended to contain a number of different types of ingredient. The (still-sealed) pouch of FIG. 2(a) is intended for ingredients which are relatively large, or which can be dispensed all at once or gradually (as described below) from the pouch or one of its compartments (as described below) when the pouch is opened. The pouch of FIG. 2(b) contains internal sieve 224 (e.g., a perforated membrane) and is intended for ingredients which are in powdered form such as herbs and spices, and which should be dispensed gradually and/or partially (e.g., by vibrating the pouch). The pouch of FIG. 2(c) contains internal membrane 226 having one or more holes 228 and is intended for ingredients which are in liquid/paste form (e.g., sauce, basting gravy) and should be dispensed gradually and/or partially (e.g., by squeezing the pouch). The pouch of FIG. 2(d) is similar to that of FIG. 2(c); however, spray nozzle 230 is provided adjacent to hole(s) 228 (in some embodiments hole(s) 228 may be used as a spray nozzle). Such a pouch is intended for liquid ingredients (e.g., oil) that should be dispensed gradually and/or partially (e.g., by squeezing the pouch) in the form of a spray or otherwise, and which might leak from the pouch if a large aperture is provided. However, in some embodiments pouches can incorporate high surface area structures (e.g., a sponge) within, allowing them to hold low viscosity ingredients within an open pouch, and release them gradually as the pouch is compressed. Pouches with other features such as built-in brushes, narrow slots, etc. may also be provided. Pouches such as those of FIGS. 2(b)-(g) may have internal funnels or similar shapes (not shown) to help direct ingredients to the holes, nozzle, etc.

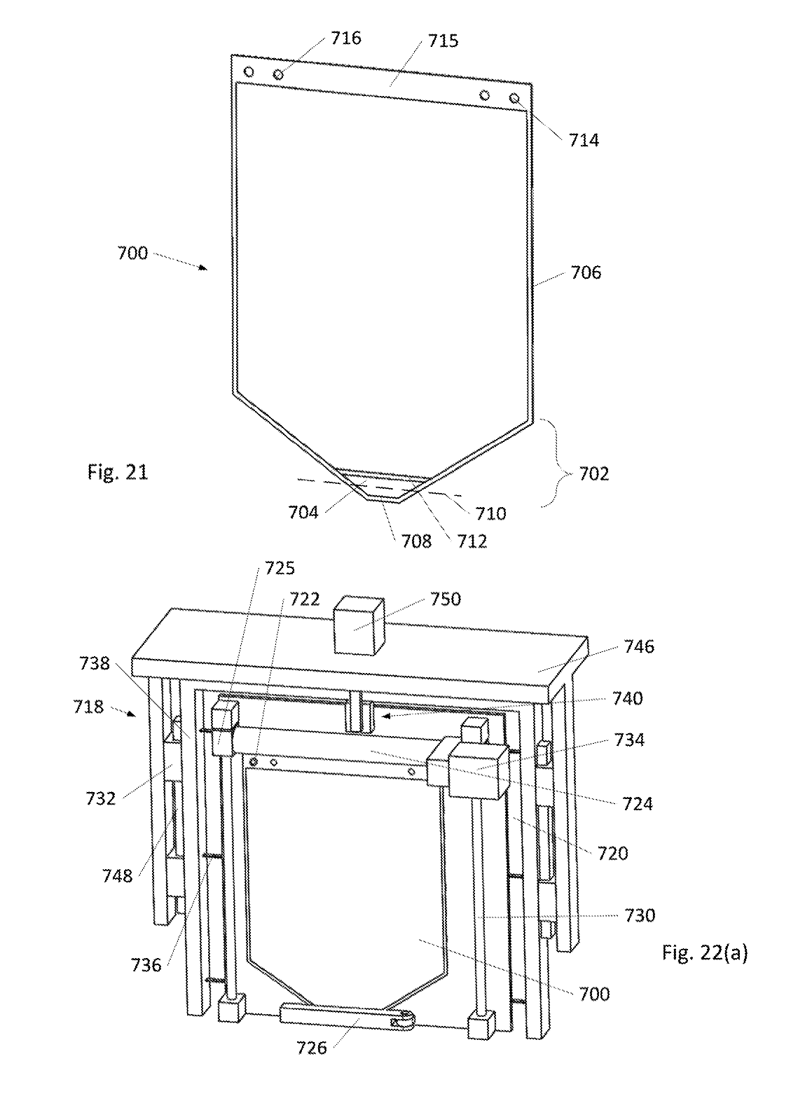

The opened/unsealed pouch of FIG. 2(e) contains extrusion nozzle 232 through which liquid/paste ingredients can be dispensed (e.g., by squeezing the pouch). The nozzle may be initially collapsed (e.g., by virtue of bellow-like corrugations, etc., as shown in FIG. 2(e)), or be coiled up, so as to fit entirely within the pouch when the adjacent pouch edge is sealed. Nozzle 232 can then extend as shown in FIG. 2(f). Nozzle 232 may also be extended always, and simply closed off with a removable (e.g., twist-off) cap, cut-able seal (e.g., similar to the tip of a caulking gun), etc. As shown in FIG. 2(g), a nozzle 234 can also be provided which can be initially everted (inside-out) while it is inside the pouch, and then turned right-side-out for use. Once extended (or if extended as-provided) nozzles 232 or 234 can be stabilized mechanically (e.g., near its tip), and then used to extrude ingredients in a pattern that is determined by a design which may be generated using computer aided design software. To extrude in a pattern, the nozzle and/or the entire pouch may be translated by motion stages as required. The pattern can be planar and single-layer (e.g., when decorating the flat surface of a cake with frosting), non-planar and single-layer, or multi-layer (with planar or non-planar layers) when 3D printing (additive manufacturing) food using one or more ingredients. In some embodiments, the pouch itself may form an extrusion nozzle, as will be described below in connection with FIGS. 21-23.

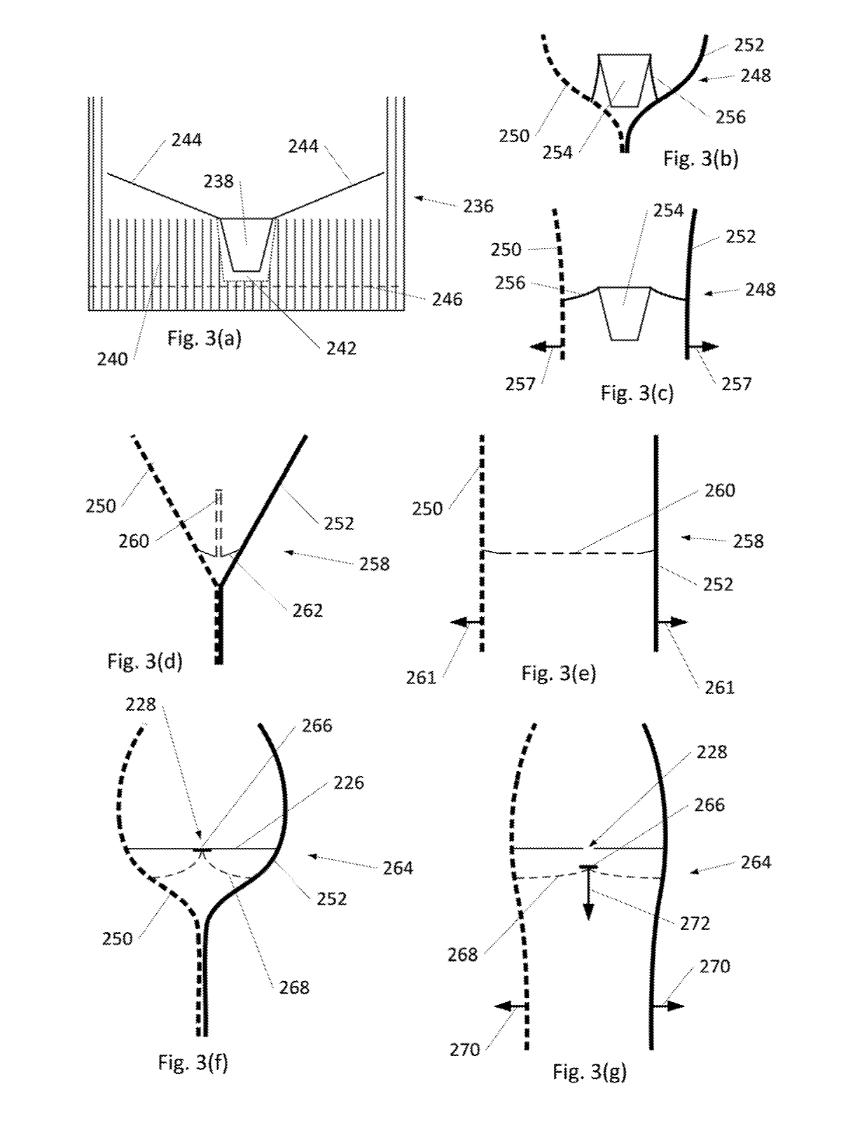

Some of the pouches in FIG. 2 may be subject to migration of ingredients from the upper region (e.g., above the sieve, above the hole) to the lower region when inadvertently vibrated or squeezed (e.g., in handling or shipping) if the pouch packaging does not itself protect against these risks. If too much of an ingredient migrates to the lower region, then an excessive amount may be dispensed when the pouch is first opened/unsealed. FIGS. 3(a)-(g) depict elevation cross-sectional views of representative pouches which minimize such migration, by using the opening of the pouch to enable an internal dispensing element to function. FIG. 3(a) is a front elevation cross-sectional view, while FIGS. 3(b)-(g) are side elevation cross-sectional views. FIG. 3(a) shows pouch 236 having nozzle 238 (e.g., spray or extrusion) wherein pouch 236 has seal 240 surrounding at least a portion of nozzle 238, leaving chamber 242 surrounding the tip of nozzle 238 with a very small (e.g., virtually zero) volume, thus preventing migration of the ingredient through nozzle 238. Pouch 236 may incorporate internal seals 244 which defines a funnel leading to nozzle 236. Pouch 236 an be opened by cutting or tearing along line 244, adjacent to and not intersecting chamber 242, and then pulling apart the side walls. To assist with this, pouches can be pre-scored (e.g., laser scored (Preco, Lenexa, Kans.). This minimizes the potential for contamination of a cutting blade or apparatus used for tearing; however, in some embodiments the cut or tear can intersect the chamber. In some embodiments the walls of pouch 236 are held together with peelable seals so that cutting or tearing is not required.

FIG. 3(b) shows a pouch 248 comprising pouch walls 250 and 252 and nozzle 254. Nozzle 254 is surrounded, while pouch 248 is sealed, by continuous folded membrane 256 that nearly encloses it, again providing a small volume. When the pouch is opened/unsealed as in FIG. 3(c) as shown by arrows 257, membrane 256 is pulled away and nozzle 254 can extend for use. FIG. 3(d) depicts pouch 258 comprising sieve 260; sieve 260 is folded initially and surrounded in some embodiments by unperforated membrane 262. In its folded configuration, there is little volume available past sieve 260 into which ingredients can migrate. When the pouch is opened as shown by arrows 261 as in FIG. 3(e), sieve 260 is unfolded, allowing ingredient to be dispensed. FIG. 3(f) shows pouch 264 similar to that of FIG. 2(c) but in which hole 228 in membrane is obscured by plug 266 connected to perforated membrane 268 or tether (e.g., with one or more spokes) around which ingredients can pass. Initially plug 266 is against hole 228, preventing ingredient migration. Plug 266 can be attached to unperforated membrane 226 by adhesives, welding (e.g., ultrasonic), etc., and may have the form of a cork or stopper filling hole 228, or can be held against hole 228 by perforated membrane 268 or another structure. When pouch 264 is opened/unsealed as in FIG. 3(g) as shown by arrows 270, enough force is produced to pull the plug free of the hole as shown by arrow 272 and allow ingredients to be dispensed. Various techniques known to the art of origami may also be used to allow for pouches which prevent ingredient migration until the pouch is intentionally opened.

In some embodiments pouches may also contain cutting elements, such as fibers (e.g., metal wires). For example, a pouch may contain one or more hard boiled eggs (or other ingredients such as tofu or cheese), and a set of thin approximately parallel (when tensioned) thin wires can be located within the pouch, e.g., with their ends anchored on opposite walls (though in some embodiments a single wire may weave back and forth between walls). Before opening the pouch these wires may not be tensioned, but opening/expanding it and/or the force of the egg against it tensions them. Once the pouch is cut open, the egg will be trapped in the pouch by the wires. However, when one or more rollers or other mechanism advances against the egg, it is pushed through the wires, slicing it and releasing the slices to a waiting vessel or dish below. Fibers may be used at different orientations (e.g., crossed to produce French fries from potatoes that are forced through them, or to cut apart garlic, etc. Fibers may in some embodiments be actuated from outside the pouch in various directions by suitable mechanisms, and not simply passively respond to ingredients pressed against them.

### Pouch Manipulation

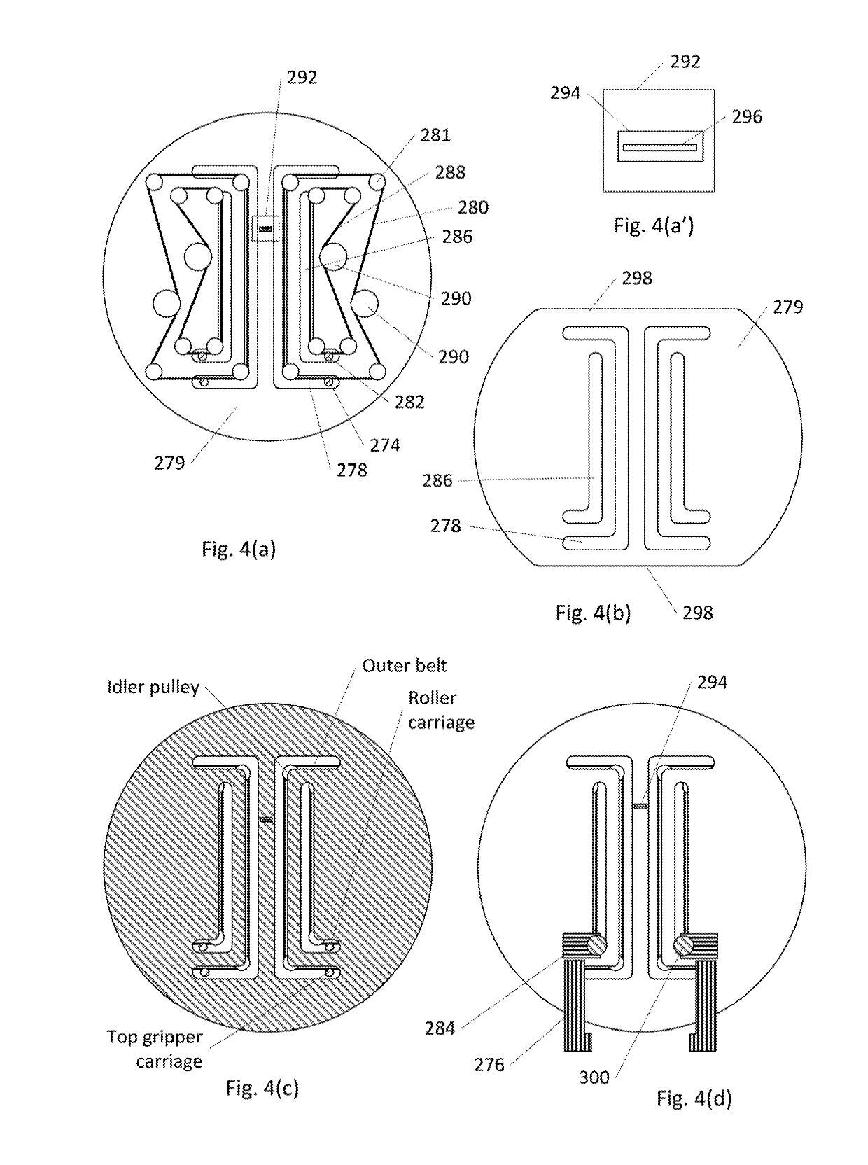

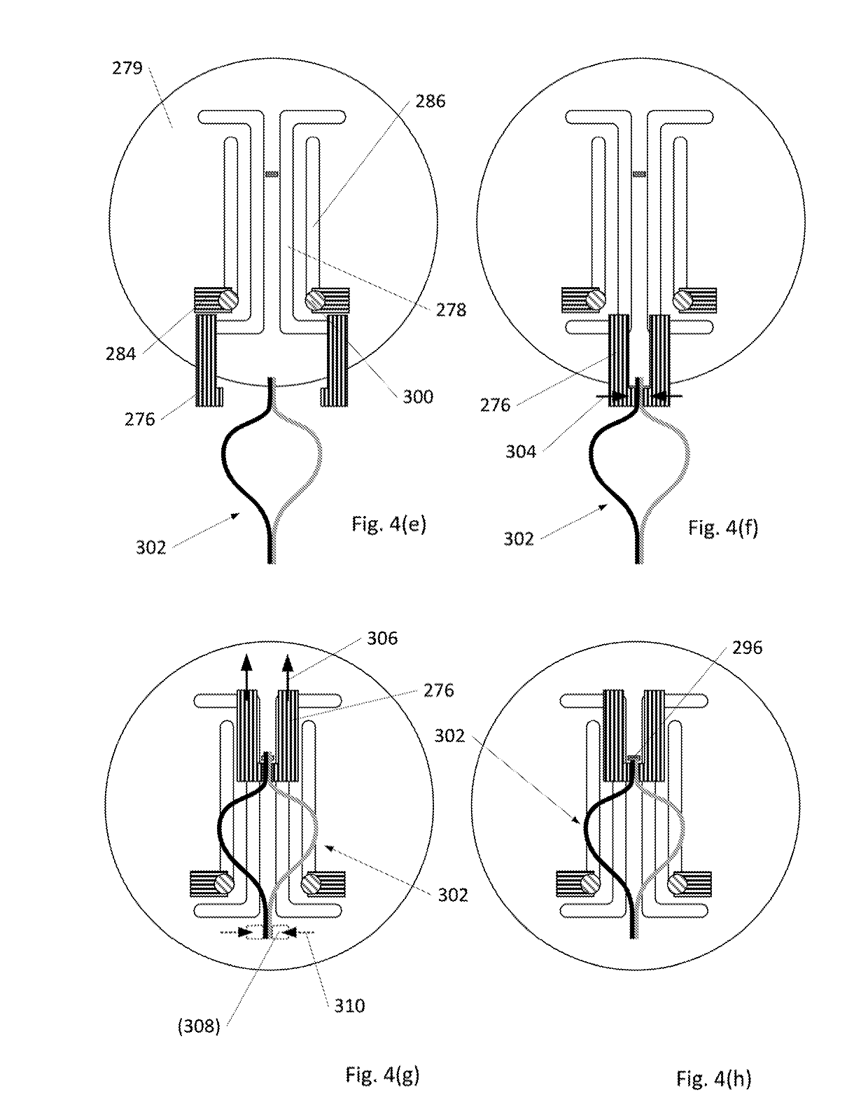

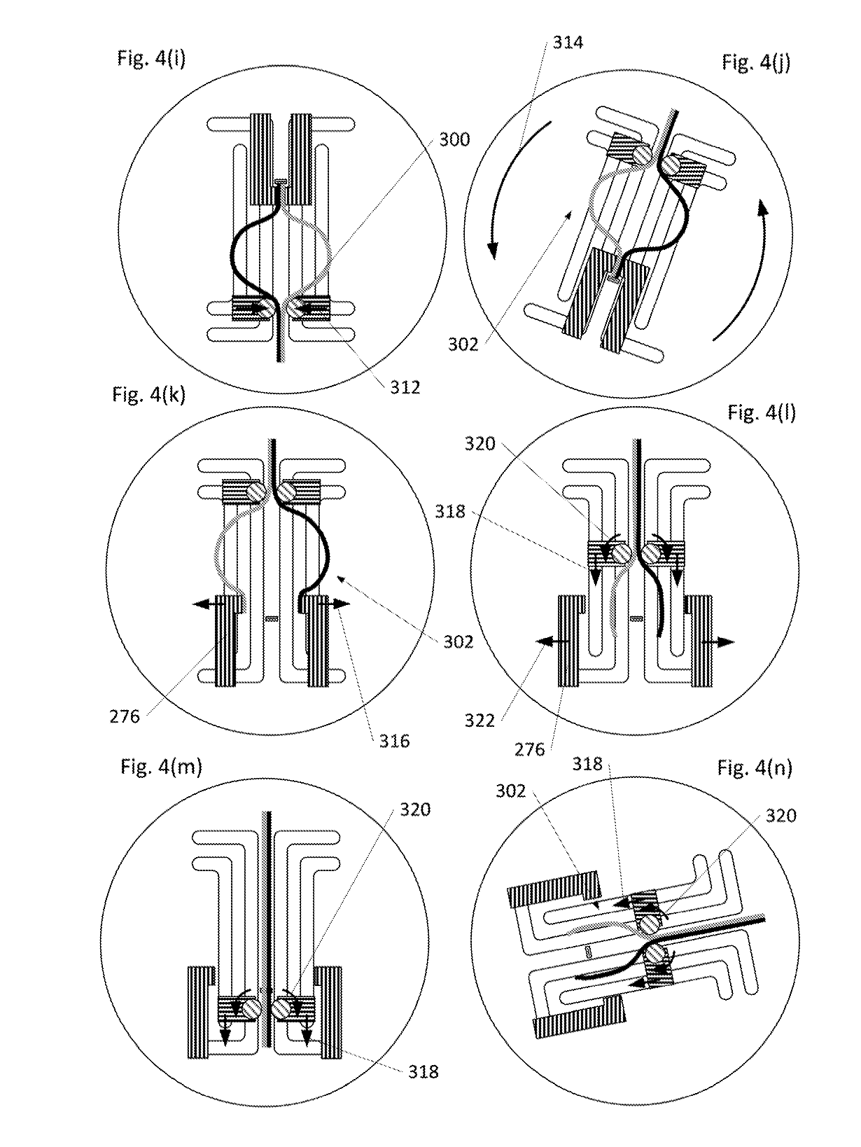

Pouches may be manipulated by the system in the process of preparing food for consumption. Manipulation in some embodiments may involve grasping the pouch in a storage chamber or tank, transporting the pouch to an area where ingredients will be dispensed or to an area where a pouch (whose ingredients have been dispensed) can be disposed of, unsealing/opening the pouch, dispensing ingredients (e.g., thoroughly, with minimal waste), and in some embodiments, tensioning the pouch, rotating and/or vibrating the pouch, and/or sealing/resealing the pouch. As described herein, the functions of grasping, unsealing, dispensing, rotating, and sealing are performed in some embodiments by a pouch manipulator, or handler, such as that of FIG. 4, while the function of transporting the pouch is performed by one or more motion stages (e.g., a multi-axis stage equipped) which transports the manipulator and its pouch payload. In other embodiments, these functions may be partitioned differently.

FIGS. 4(a)-(n) depict in elevation views a pouch manipulator which comprises top grippers which grasp the top of a pouch and translate to adjust its position, one or more rollers (or a blade-like squeegee in some embodiments) which compress the pouch to dispense ingredients, and a cutter (in some embodiments: however in other embodiments the manipulator may use a peelable pouch and means of grasping portions of the pouch, such as vacuum, or mechanical clamps or grippers). The manipulator, or the carriage on which it is mounted, may also include a reader for bar codes, RFID tags, etc. to identify the pouch. The motions of the top grippers may comprise an inward-directed motion to grasp the pouch, a motion (e.g., along a perpendicular direction) to reposition the pouch, and an outward-directed motion to separate the pouch walls from one another for purposes of dispensing or filling. The motion of the rollers may comprise translating along the pouch (in some embodiments while rotating) to push out ingredients within, an inward-directed motion (e.g., along a perpendicular direction) to impinge on the pouch (and optionally, an outward-directed motion to release the pouch). The manipulator of FIGS. 4(a)-(d) is capable of the required motions, and moreover comprises a disk which can rotate the pouch to a desired orientation (e.g., inverted or angled for dispensing) as needed, or continuously rotate it (e.g., for tossing ingredients), and a cutter to unseal the pouch. The top grippers may furthermore incorporate a vacuum grasper to pull on the pouch walls, and a pouch vacuum pump and heater to seal/re-seal the pouch.

Many of the desired gripper and roller motions of the manipulator can be achieved using independent linear and rotary stages or other actuators (electric, pneumatic, or hydraulic). However, to the extent that the required manipulations are consistent from pouch to pouch, a less flexible and potentially less costly system relying on cams and followers or using belts (or chains) can also be used, as is depicted in the rear elevation view of the pouch manipulator shown in FIG. 4(a). In the figure, the details of the manipulator are seen. The apparatus is symmetric about a vertical centerline. Top gripper carriage 274, attached to top grippers 276 (FIG. 4(d)), is driven through C-shaped outer slot 278 in disk 279 by outer belt 280. Also shown is roller carriage 282, attached to roller supports 284 (FIG. 4(d)), which is driven through L-shaped inner slot 286 by inner belt 288. Both belts 280 and 288 are moved by drive pulleys 290 turned by motors (not shown); belts pass around idler rollers 281 at each location where the belt direction changes, other than where drive pulleys 290 are located. Carriages 274 and 282 can slide in slots 278 and 286, respectively, as if along tracks while moved by belts 280 and 288, respectively, or can be more fully supported by the belts, with the slots only providing access from one side of disk 279 to the other. Four motors are assumed here, and motors can be driven in pairs using the same driver, in parallel or series. In some embodiments, fewer motors can be used, since the motions on the left side of the manipulator are mirrored on the right.

As is best shown in FIG. 4(a′) which magnifies region 292, also shown is slot 294 through which cutter 296 can be passed to cut open the pouch. The manipulator shown in most views of FIG. 4 has the overall shape of a disk onto which various elements are mounted; however, other shapes are possible and may be advantageous in some embodiments to allow the pouch to be located as close as possible to other elements of the system, such as cooking vessels. FIG. 4(b) shows a modified disk shape incorporating two flats 298, for example.

FIG. 4(c) depicts a front cross-sectional elevation view of the manipulator while FIG. 4(d) shows a normal elevation view of the front. Grippers 276 can be moved along a C-shaped path as outer belt 280 moves, while rollers 300, supported by roller carriages 282, can be moved along an L-shaped path while inner belt 288 moves. Side grippers (discussed below) are not shown for clarity.

FIGS. 4(e)-(n) do not show any of the components on the rear of the manipulator for clarity. FIGS. 4(e)-(m) depict a sequence used in some embodiments for manipulating a pouch and dispensing the ingredients within. FIG. 4(e) shows the manipulator positioned adjacent to pouch 302, seen in a side elevation cross-sectional view, which may be suspended in a chamber from its supports. Grippers 276 need not be as far apart as depicted. In the embodiment of FIG. 4, the pouch is supported with its top up and its bottom down, and it is opened near its top edge, after which the pouch is rotated to dispense its contents. This is particularly useful, for example, if the pouch is opened by a cutter (or tearing mechanism) in a region inward of the seal. In this case, the cutter (or mechanism) can become contaminated by ingredients as it cuts (or tears) open the pouch and the ingredients immediately fall out. With the cut made at the top, ingredients (other than some possible residue) will remain below the cutter, especially if the pouch has been in the orientation for some time before cutting, since they may have drained away from the cut region. If on the other hand, the cut is made within the sealed region (e.g., just adjacent to the unsealed region containing the ingredient), then the contents will not immediately issue, and the remaining task of fully opening the pouch can be achieved by pulling apart the pouch walls (described below). In such embodiments, the pouch may be opened near its bottom edge (e.g., the pouch need not be rotated). In some embodiments, in addition to a seal there is an internal closed zipper (similar to that found on a ZIPLOC® bag) which can prevent migration of ingredients toward the cut edge until the zipper halves are separated. In some embodiments, rather than seals which are cut or torn, pouches can be provided with peelable seals or zippers, which may allow for pouch reclosing as well as opening using the grippers.

In FIG. 4(f), outer belt 280 has been moved, causing grippers 276 to close around pouch 302 as shown by arrows 304, grasping it. In some embodiments, especially those in which the weight and/or thickness of the pouch varies considerably, force or pressure sensors may be used to adjust the final position of the grippers. In the case of fixed gripper motions as is provided by the mechanism discussed herein, variations in pouch thickness can be accommodated by an elastomeric element on the gripper faces; such an element may be used due to its high frictional coefficient. In FIG. 4(g), pouch 302 has been lifted by grippers 276 as shown by arrows 306 as top gripper carriages 274 move along outer slots 278. All pouches, regardless of height, can be brought to the same position, such that their top seals are in a position suitable for opening the pouch. However, to accommodate pouches of very different heights, the rollers may be actuated using a more flexible approach than the fixed slot shown. In some embodiments, a bottom gripper 308 (shown in outline) which may move in only one axis, may be moved toward pouch 302 as shown by arrows 310 once it is raised, so as to secure the bottom of pouch 302. In FIG. 4(h), the cutter 296 (e.g., a blade, possibly angled, possibly V-shaped with the pouch entering the “throat” of the V) passes through slot 294 and moves across at least a portion of pouch 302 (in a direction normal to the drawing) to cut open pouch 302, in some embodiments. It may be useful to not completely cut through the pouch, so that the cut portion does not fall (e.g., into a vessel containing food to be processed or directly eaten).

In FIG. 4(i), inner belt 288 has been moved, causing rollers 300 to impinge on pouch 302 as shown by arrows 312. The rollers may contact the pouch just above the bottom seal, or at a higher position (e.g., if the goal is to release only part of the pouch contents, partitioning the pouch contents into currently-used versus later-used quantities).

In some embodiments, especially those involving very flowable ingredients, the pouch isn't cut; rather, the top seal is weaker than other seals, and can be broken through simply by pressurizing the ingredients (e.g., using the rollers). In some embodiments, the grippers and rollers can be pushed together (each gripper toward the other, each roller toward the other) by one or more external (not necessarily fixed to the manipulator) actuators and then remain together, impinging on the pouch (e.g., using a catch, ratchet, or clutch) until released.

In FIG. 4(j), the manipulator is rotating to invert the pouch as shown by arrows 314. Such rotation (continuous or oscillating) can also be used for coating (e.g., meat with breadcrumbs), marinating (non-refrigerated), tossing (e.g., salad and dressing), beating eggs, etc. This can be achieved with pouches that have never been open, with pouches which have been resealed, and with pouches which are temporarily resealed (e.g., by holding together their open edges under pressure using the grippers).

In FIG. 4(k), the pouch is at the orientation desired for dispensing the ingredient. Top grippers 276 are in some embodiments provided with means of pulling on the walls of the pouch 302, such as vacuum (assumed herein) which may be plumbed to the grippers. With the vacuum turned on (if required, since the outflowing ingredients may themselves open the pouch), grippers 276 then separate as shown by arrows 316, opening pouch 302. Pouch 302 may not be opened as widely as is shown, and may not be oriented directly upside down as shown, both in order to better regulate the dispensing process. If pouch 302 was cut at a location within the sealed region, the separation of the grippers now additionally breaks the seal to release the pouch contents; if pouch 302 contains an internal zipper, the halves of this may now be separated.

Once pouch 302 is open, its contents may now be entirely released (e.g., into a cooking vessel (with a reusable, cleanable interior), cooking vessel liner (described below), or plate) by gravity alone. This is especially true for pouches with low surface energy internal surfaces and for certain solid ingredients. However, some ingredients are flowable and may be too viscous to move easily due to gravity alone, or more significantly, may tend to adhere to the inner walls of the pouch. Thus rollers 300 as provided in some embodiments are provided to roll (translate and rotate) as shown in FIG. 4(l) by arrows 318 and 320 toward the cut edges of the pouch as in FIG. 4(m), with top grippers 276 separately widely if required as shown by arrows 322 to let rollers 300 and supports 284 through. The motion of rollers 300 can be achieved by translating them and letting them rotate passively, by rotating them and letting them translate passively, or by actively both rotating and translating them. Rollers 300 may stop before reaching the pouch edges as in in FIG. 4(m), to minimize the risk of contamination by ingredients. As they move, rollers 300 squeeze out/express the ingredient, leaving little behind as waste. Complete removal also minimizes the risk of ingredients dripping or oozing out spontaneously, contaminating the system; indeed, in some embodiments, a wiping element (e.g., including a vacuum wand) may be used to remove any residue at the edge of the pouch before it can drip or ooze, prior to disposal of the pouch.

In some embodiments in lieu of rollers, sliding, non-rolling elements such as squeegees may be employed to slide along the external pouch external walls. In some embodiments, the contents of the pouch are expelled by having the pouch pressed on by an external element other than a roller or sliding element, such as an expanding gas-filled bag, or by pressurized gas (if the pouch is within a chamber). In some embodiments, the pouch can be directly pressurized (e.g., by introducing gas directly into the pouch to eject the contents. In such embodiments, a flexible membrane surrounding the contents and isolating it from the gas may be provided within the pouch (e.g., forming a pouch within a pouch). In some embodiments, grasping and squeezing of the pouch need not be symmetric: there can be one gripper and/or one roller sandwiching the pouch between them and a fixed element(s). For example, a single roller can be used to expel the contents of the pouch if pouch is backed by a sufficiently rigid plate.

Once pouch 302 has been emptied, the manipulator can transport the pouch to a waste bin or similar, opening jaws 276 to release it. Belts 280 and 288 can then reverse so as to reset the manipulator to the state it may need to be in (FIG. 4(d) to manipulate the next pouch. If pouch 302 is not completely empty, it can be returned to a storage chamber/tank. Before being returned, it can be resealed in some embodiments: grippers 276 may include heat or ultrasonic sealing elements for that purpose, and if vacuum sealing is required, grippers 276 may also include a small sealed chamber surrounding and sealing around the edges of the pouch (similar to a FOODSAVER® system) and/or a snorkel known the art of vacuum packaging, allowing pouch evacuation and possibly, backfilling with a modified atmosphere gas.

In some embodiments, the pouch manipulator can accommodate more than a single pouch at a time, allowing rapid switching between ingredients (e.g., when 3D printing a meal having multiple components) or allowing a larger quantity of an ingredient to be dispensed than can be held in a single pouch. For example, two or more relatively narrow pouches may be held in the top grippers side by side (side seals in contact/near contact), or two or more full-width (e.g., as wide as the grippers) pouches may be held and simultaneously opened and the contents squeezed out (e.g., by rollers) if placed with their walls in contact. In the latter situation, multiple pouches, if adjacent, can be grasped while the manipulator is near the storage chamber/tank, and the grippers and rollers may adjust their final positions to accommodate the extra thickness of multiple pouches; this can be accomplished using force/pressure sensors, for example. Multiple pouches can also be temporarily stored near the area of the system where they are needed, rather than being returned to a storage region.

FIG. 4(n) shows a pouch that is angled rather than being vertical while dispensing, so as for example, to better control the outflow of ingredients. The manipulator may be designed so that no portion of it is in the path of ingredients issuing from the pouch, regardless of the angle of the pouch, and so may be of a different, smaller design than shown here.

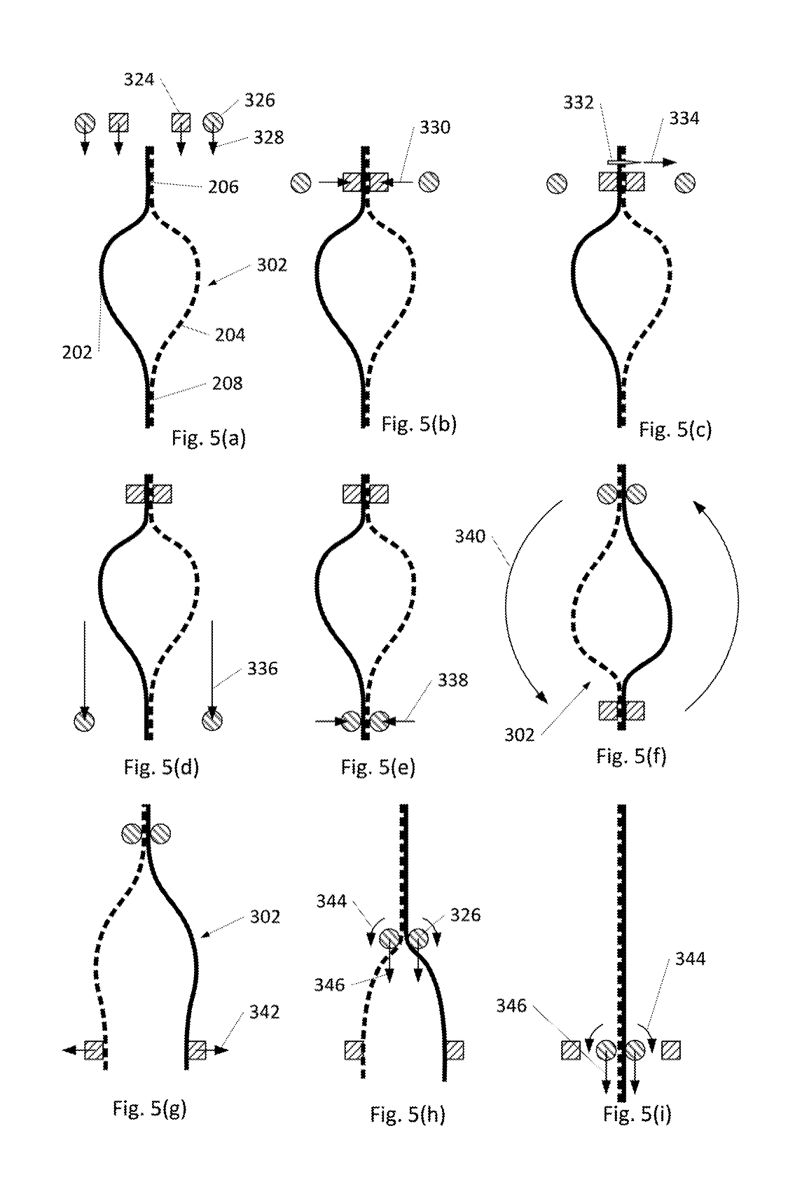

FIGS. 5(a)-(i) depict elevation cross-sectional views of similar, alternative sequence for manipulating a pouch and dispensing ingredients in some embodiments. In FIG. 5(a), grippers 324 and rollers 326 are located near the top seal 206 of pouch 302 and are moving as shown by arrow 328. In FIG. 5(b), they have descended and come to together as shown by arrows 330 to grasp pouch 302. In FIG. 5(c), cutter 332 (moving in the plane of the drawing as shown by arrow 334) cuts the pouch open. Then, in FIG. 5(d), rollers 326 descend as shown by arrows 336 to a position where they can close in on pouch 302 (FIG. 5(e)) as shown by arrows 338 either to squeeze out substantially all the contents (as shown), or to a higher position (for a shorter pouch, or to dispense less than the entire contents). Then, the manipulator (only key elements of which are shown) and pouch 302 rotate as shown by arrows 340 in FIG. 5(f). The center of rotation is not necessarily where suggested by the figure and may be, for example, at the height of the grippers or rollers. In FIG. 5(g), pouch 302 is opened as grippers 324 separate as shown by arrows 342, and in FIGS. 5(h)-(i), rollers 326 push out the contents while rolling and translating (arrows 344 and 346). Using the approach of FIG. 5, grippers may need just one degree of freedom, while rollers may need two degrees of freedom (not including rotation).

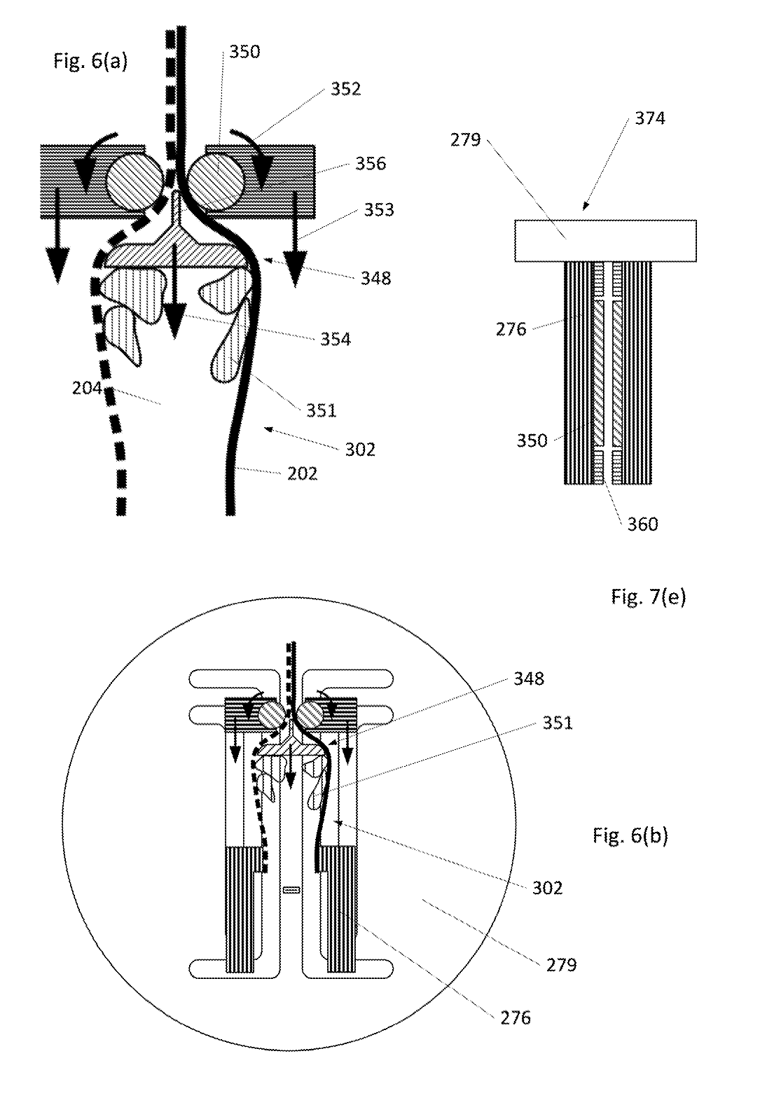

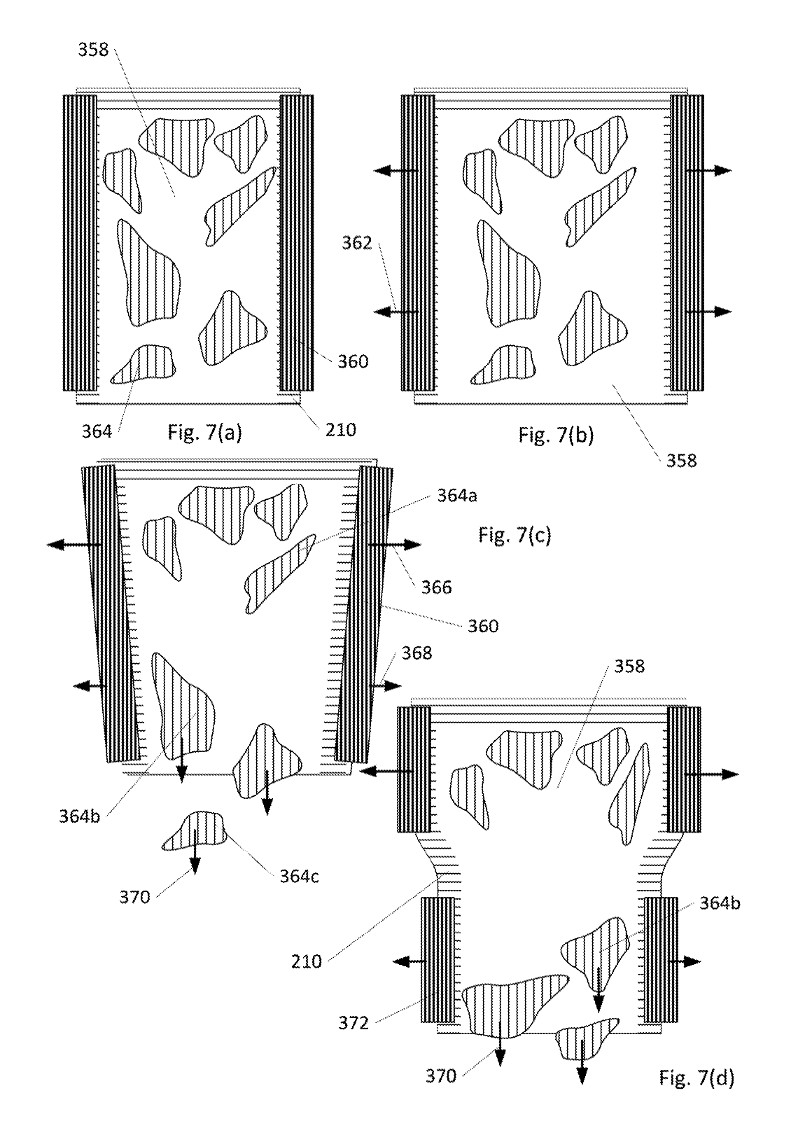

FIG. 6(a) depicts a front elevation cross-sectional view of pouch 302 having walls 202 and 204 and a portion of a manipulator, wherein the pouch is provided with an internal pusher 348. Uses of pusher 348 include acting as an intermediary between the ingredient and rollers, preventing the rollers 350 from crushing and/or “riding over” ingredients 351 as they rotate and translate (shown by arrows 352 and 353, respectively) that tend to adhere to the inner walls of the pouch, and providing an effective squeegee/scraping action as pusher moves (shown by arrow 354) that thoroughly removes food from the walls to minimize waste. To maintain close contact between pusher 348 and the inner walls, in some embodiments pouch 302 is compressed from the outside (e.g. using inflatable elements) while in other embodiments it is held under tension (e.g., applied to, or near, the side seals/edges) (as discussed further in conjunction with FIG. 7). Pusher 348 may be provided with keel 356 that fits within pouch walls 202 and 204 near the nip of the rollers, preventing pusher 348 from rotating/tipping. Pusher 348 is designed to be too large to exit pouch 302 (e.g., the pouch opening is smaller than it), and/or is tethered to the pouch, magnetically attracted to the rollers, etc., so it is prevented from falling out into a cooking vessel, plate, etc. FIG. 6(b) shows a front elevation cross-sectional view similar to that of FIG. 6(a), but with other parts of a manipulator similar to that of FIG. 4, used in some embodiments, included.

### Control of Dispensing

A number of methods may be used to control the outflow of ingredient from a pouch: both moderating the rate and allowing only a portion of the contents to be dispensed at one time. Already mentioned is the approach of introducing the rollers not at the end of the pouch, but closer to the edge at which ingredients exit, thus leaving ingredients above the roller un-dispensed. Another is to not advance the roller all the way toward the open pouch edge, although for ingredients which can easily slide out, this may not be effective. Other methods are possible. For example, a pouch may only be cut or torn open partially (e.g., parallel to the top seam, or at an angle (in some embodiments the top seam is at an angle to the cutter, and not perpendicular to the side seams, for example) if doing so would enable a slower outflow. This can be particularly effective with liquid ingredients. In some embodiments the grippers can only open partially, limited the area available for ingredient outflow.

In some embodiments, pressure can be provided on the walls of the pouch, such as placing one or more expanding bags or other shapes adjacent to the pouch walls, or surrounding the pouch with an expanding torus. Such pressure can prevent pouch contents from simply dropping out, or at least slow their pace. FIG. 7 depicts in elevation view an approach to applying an inward pressure to the walls of pouch 358 by applying tension to the sides of the pouch, by using side grippers 360 to grasp and pull them as shown by arrows 362. Grippers 360 may grasp the pouch only in the region of the side seals 210 as shown, so no gripper pressure is exerted on the internal cavity of the pouch and the side grippers do not interfere with roller movement. The pouch may be tensioned and even slightly stretched (shown exaggerated for most pouch materials in FIG. 7(b), causing inwards pressure on ingredient pieces (or volumes) 364 within. If these are flowable, this can push them out faster, and indeed, tension applied to the pouch sides can be used in some embodiments in lieu of rollers to press ingredients out of the pouch. However, if the ingredients are not very flowable (e.g., chunks of vegetables, strips of meat), the pressure can help retain them (by pressing on them, and depending on the shape of the ingredient and the flexibility of the pouch, by wrapping partially around them), preventing them from sliding out until the tension is released. Thus tension can be used in some embodiments to retain ingredients within a pouch that is unsealed (e.g., by cutting, tearing, or opening a zipper) along its bottom edge, without rotating it as described above.

Furthermore, as shown in FIGS. 7(c)-(d), the tension can be applied non-uniformly, to control which portion of the ingredients are released and which are retained. In FIG. 7(c), the upper portions of the grippers 360 are moved a greater distance as shown by arrow 366 than the lower portions (which may not be moved at all) as shown by arrows 368, causing the inwards pressure in the upper portion of the pouch to be great enough to retain ingredient pieces 364a until tension on the upper portion of the pouch is released. Meanwhile, the lower pressure in the lower portion may allow ingredient pieces 364b located there to be released immediately and fall; the motion of piece 364c in free fall is shown by arrow 370. Given the vertical gradient in inwards pressure, ingredient pieces in-between these portions may be released, e.g., at a slow rate. Thus by applying appropriate tension to the pouch, it is possible to first release ingredients from the lower portion of a pouch and then later release them from the upper portion (possibly after resealing and storing the bag, or much sooner). This approach may be used, for example, to distribute a pizza topping to different regions of a pizza, versus dropping the topping all in one location.

Pressure or tension applied to the walls of the pouch may not be constant and may be modulated in a continuous or “binary” fashion. For example, pressure or tension may be pulsed on and off, such that when not applied, ingredients can migrate within the pouch and escape the pouch for a brief period of time, and then are immobilized/retained again when pressure/tension is reapplied.

The rate at which ingredients exit the pouch can be controlled in closed-loop fashion using a sensor such as a video camera to image the ingredients through the pouch, using a sensor to weigh the pouch (and possibly additional hardware such as the pouch manipulator), etc. Such approaches can also be used to determine how much of the ingredients remain in the pouch. FIG. 7(d) depicts in elevation views two pairs of parallel side grippers 372 which achieve an effect similar to that of the tilting grippers 360 of FIG. 7(c); but with each pair of grippers 372 independently controlled. Two zones are thus created, with a transition zone between them. More than two pairs of side grippers can be used in some embodiments. FIG. 7(e) depicts a pouch manipulator similar to that of FIG. 4 in plan view, with top gripper 276 and side grippers 360 both visible. Also visible are rollers 350 which may be used; if so, they fit between side grippers 360 so that the latter do not interfere with the rollers' access to the pouch. It should be noted that optional bottom grippers 308 of FIG. 4(g) may not be used if side grippers 360 are used, since pouch 302 would be supported by grippers 360 as rollers 300 descend.

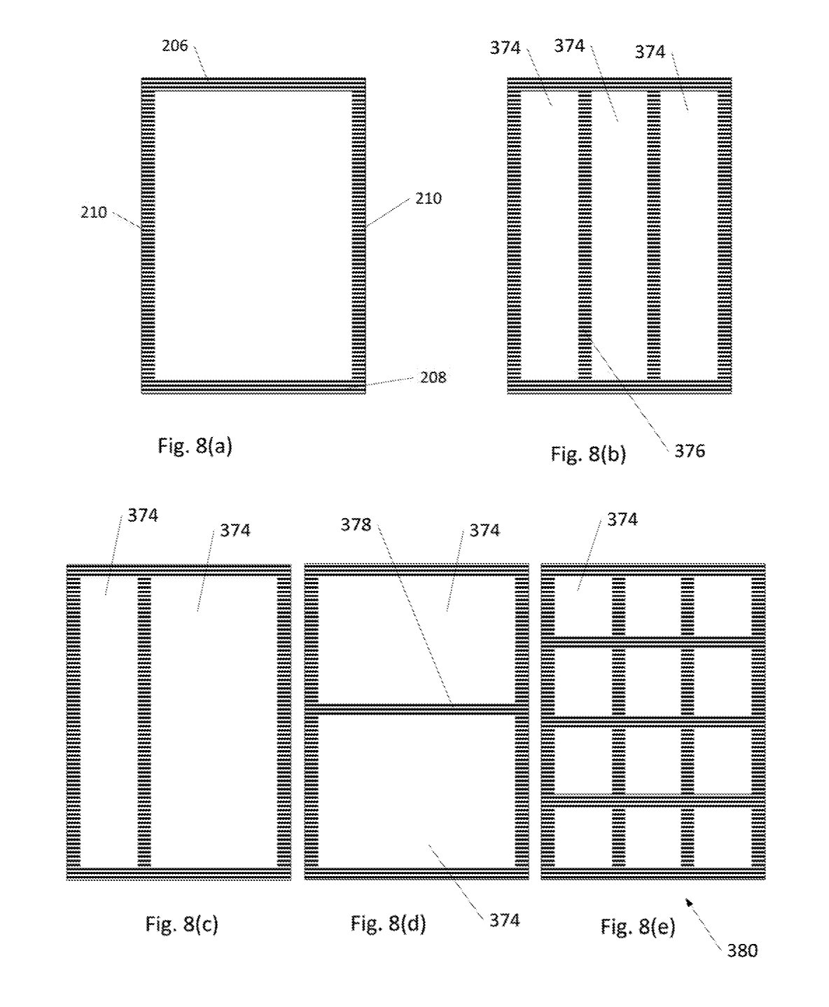

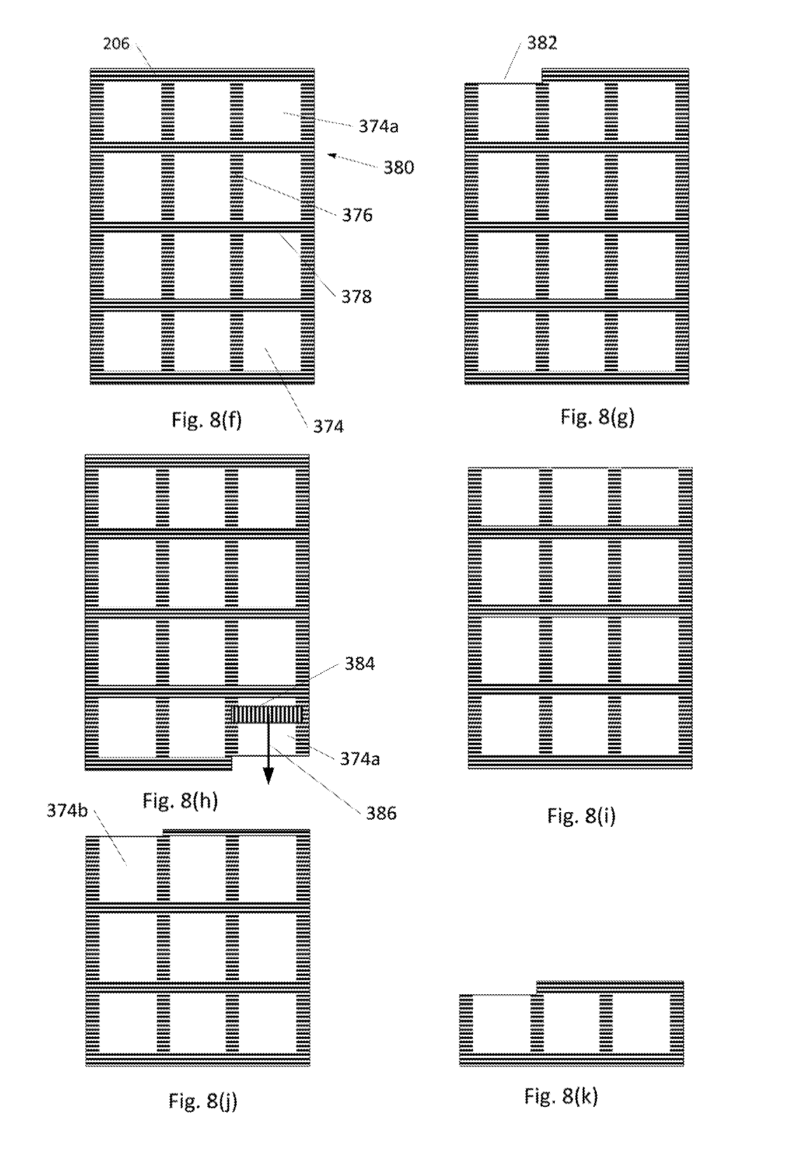

FIGS. 8(a)-(k) show elevation views of an approach to controlling the amount of ingredients dispensed, and also provides a way to minimize the number of pouches required and the time required to fetch and position them within a food preparation system. While a typical pouch with one internal compartment (and having top, bottom, and side seals as in FIG. 1) is shown in the plan view of FIG. 8(a), the approach comprises i) subdividing the pouch into multiple compartments 374 as shown in FIGS. 8(b)-(e) with seals (e.g., produced by heating or ultrasonic sealing (e.g., using equipment from Herrmann Ultrasonics (Bartlett, Illinois)) similar to the outer (top, bottom, side) seals, or other types of seals or walls used to isolate each compartment from its neighbor(s), and 2) releasing ingredients from each compartment independently. A pouch can be subdivided vertically as shown in FIGS. 8(b)-(c) with vertical seals 376, horizontally as shown in FIG. 8(d) with horizontal seals 378, subdivided both vertically and horizontally as in pouch 380 of FIG. 8(e), or subdivided at other angles (e.g., 45 degrees to the horizontal). Compartments need not be of equal size, and may be arranged in a more varied pattern than shown (not in neat rows and columns). Depending on the ingredients, compartments may be isolated by liquid-tight seals/walls or by porous/partial barriers (e.g., for solid foods such as sliced vegetables) or combinations thereof.

Each compartment may contain the same ingredient, allowing a single pouch to be used to supply an ingredient in relatively small quantities for multiple meals prepared at different times, or allowing an ingredient that is used in different locations (e.g., in an entrée and in its sauce) or at different times within a given recipe to be separately dispensed without carefully controlling the outflow of ingredients from a single-compartment pouch or reseal the pouch after each use. Each compartment may also contain a different ingredient, thus allowing just a single pouch or a few pouches to be used in the preparation of a complex recipe. For example, a recipe calling for six different unusual herbs and spices might be made using a pouch divided into six compartments, which can be opened as needed. If ingredients interact and should not be combined until shortly before the food is consumed, they can be kept isolated (e.g., lettuce and salad dressing should be kept separate until needed).

The amount of an ingredient may vary from compartment to compartment, even if the compartments are of equal capacity, depending on the amount needed. In some embodiments, to provide an ingredient in small quantities using a standard-size pouch, the pouch may be provided with some compartments left unfilled. Approaches to applying pressure to the pouch to control dispensing of ingredients can be applied to multi-compartment pouches if desired.

If compartments are “external” (i.e., they have one edge that is common with the pouch as a whole), then compartments can be emptied selectively by altering the location of the cut or tear. For example, the rectangular pouch of FIG. 8(d) has two external compartments (in the figure, these are of equal volume, though they may be of unequal volume). The upper compartment can be opened by cutting along the top seal; upon inverting the pouch, another cut made along the bottom seal will open the lower compartment. A square pouch subdivided into triangular compartments (i.e., with the divisions along diagonals) can be rotated and cut four different times, etc. “Internal” compartments, on the other hand, may be easiest to access after removal of other compartments; however, they may also be accessed from their sides (e.g. by piercing their side walls, peeling a peelable seal on their side walls).

As shown in the sequence of FIGS. 8(f)-(k), the contents (not shown) of a multi-compartment pouch can be gradually released, e.g., by starting at one edge and moving toward the opposite edge (one can also move inwards from multiple edges). FIG. 8(f) shows pouch 380 f FIG. 8(e). In FIG. 8(g), a section 382 of the top seal has been cut out, opening up the upper left compartment. In FIG. 8(h), pouch 380 has been inverted to empty compartment 374a. One or more rollers 384, for example no longer than the compartment is wide, may be moved to express the contents of the compartment as shown by arrow 386. Pouch 380 is then turned right-side up and after two more compartments 374 have been emptied, it looks as shown in FIG. 8(i). After the entire first (upper) row of empty compartments 374 has been cut off and the upper left compartment 374b of the second row has been cut open, it looks as shown in FIG. 8(j), and when only three compartments are left (one cut open), it looks like FIG. 8(k). In general, if a pouch or a pouch compartment does not hold enough of an ingredient to meet the requirements of a recipe, more than one pouch can be used, or more than one compartment can be opened (or if compartments of different size are available in a pouch, a larger one can be used if accessible).

In some embodiments, seams or walls between compartments are designed to burst open when pressure is applied to the compartment (e.g., direct external pressure, roller pressure, tension on the pouch walls forming the compartment). In such embodiments, a vertical column of compartments, for example, can be emptied one at a time by first cutting open the pouch edge for an exterior compartment, then (when the next compartment above is to be emptied) applying pressure to that compartment, then applying pressure to the compartment above that, and so on until all compartments in the column are emptied. For pouches using barriers instead of seals/walls between compartments, these can be designed to deform (e.g., bend over or break off (partially, so as not to fall out of the pouch and mix in with the meal being prepared) when forces are applied to the compartment above the barrier.

In some embodiments, before any edge of the pouch is opened to release the ingredients within, a multi-compartment pouch with internal seals between compartments can have those seals broken (e.g., by external pressure or tension), allowing ingredients (e.g., salad greens and dressing) to be mixed, blended, tossed, etc. (e.g., by rotation of the pouch manipulator) entirely within the sealed pouch, which is then opened.

### Other Ingredient Packages

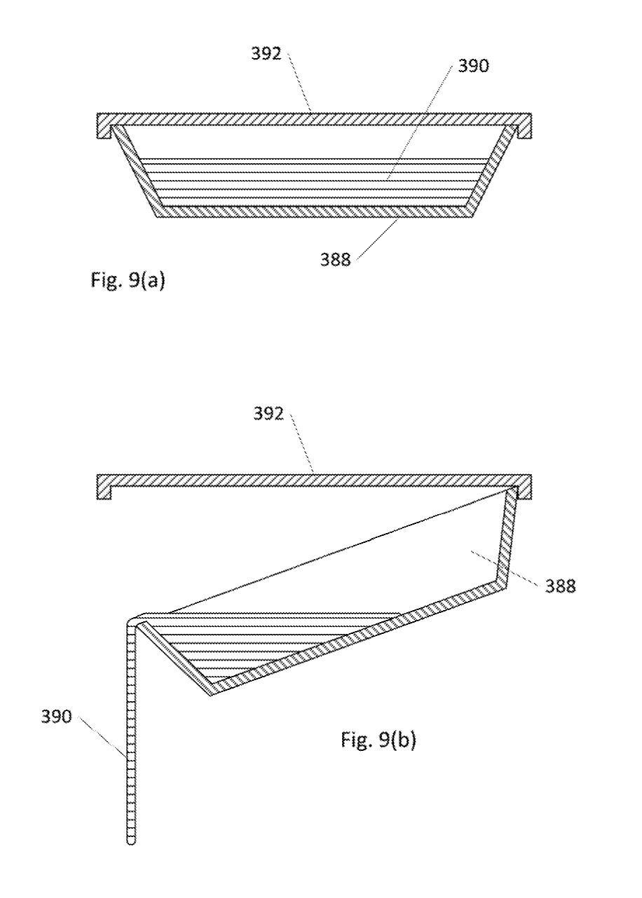

In some embodiments, in lieu of or in addition to pouches which contain ingredients, other containers may be used, and many of the approaches described herein may still be applicable. Such containers may be more appropriate for ingredients which are of general use (rather than more specific to a recipe) and may therefore be stored in the food preparation system for an extended period. For example, ingredients can be stored within and dispensed from tubes (e.g., vertical), cartridges, cylinders, and tubs. In the case of tubes, these can be similar to the barrels of hypodermic-type syringes (e.g., with a hole at one end and able to be pressurized by gas or a sliding piston): such a configuration is suitable for packaging and dispensing liquids and pastes. The hole can be equipped with an extrusion nozzle (e.g., for dispensing in patterns or 3D printing) or a spray nozzle. A tube in which a granular ingredient such as flour or sugar is kept can be equipped with a sieve on its lower surface; the tube can then be vibrated or tapped to release the ingredient. A tub 388 capable of tilting may be provided to house an ingredient 390, along with an optional lid 392 as in FIGS. 9(a)-(b). When not being used, tub 388 can remain horizontal and tightly closed by lid 392 as in FIG. 9(a). When the controller commands the release of at least a portion of the ingredient inside the tub 388, it can be tilted as in FIG. 9(b) using a suitable actuator, which also pulls tub 388 at least partly away from lid 392, allowing ingredient 390 to be poured out from the tub (if flowable as shown), or fall/tumble out (if more solid). Alternative ingredient packages can be stored in storage chambers and if sufficiently sealed, or if the liquid level is sufficiently low, can be at least partially immersed in tanks of cooling liquid to remain cool or frozen. A manipulator which dispenses ingredients from tubes or tilting tubs may also be required, as is apparatus for transporting these to where they are needed, or transporting vessels to them (described below).

### Vessels and Tumbling

An automated food preparation system may employ receptacles or vessels into or onto which ingredients can be dispensed for processing and/or delivery to a user. Processing may include heating (e.g., frying, sautéing, simmering, boiling, baking, broiling, grilling), cooling, blending, mixing, chopping, cutting, whisking/whipping, stirring, etc., and combinations thereof. Moreover, the system may require dishes (plates, platters, bowls, etc.) or their equivalent, in which prepared food can be delivered to the user for serving or direct consumption. In some embodiments, vessels may serve as dishes.

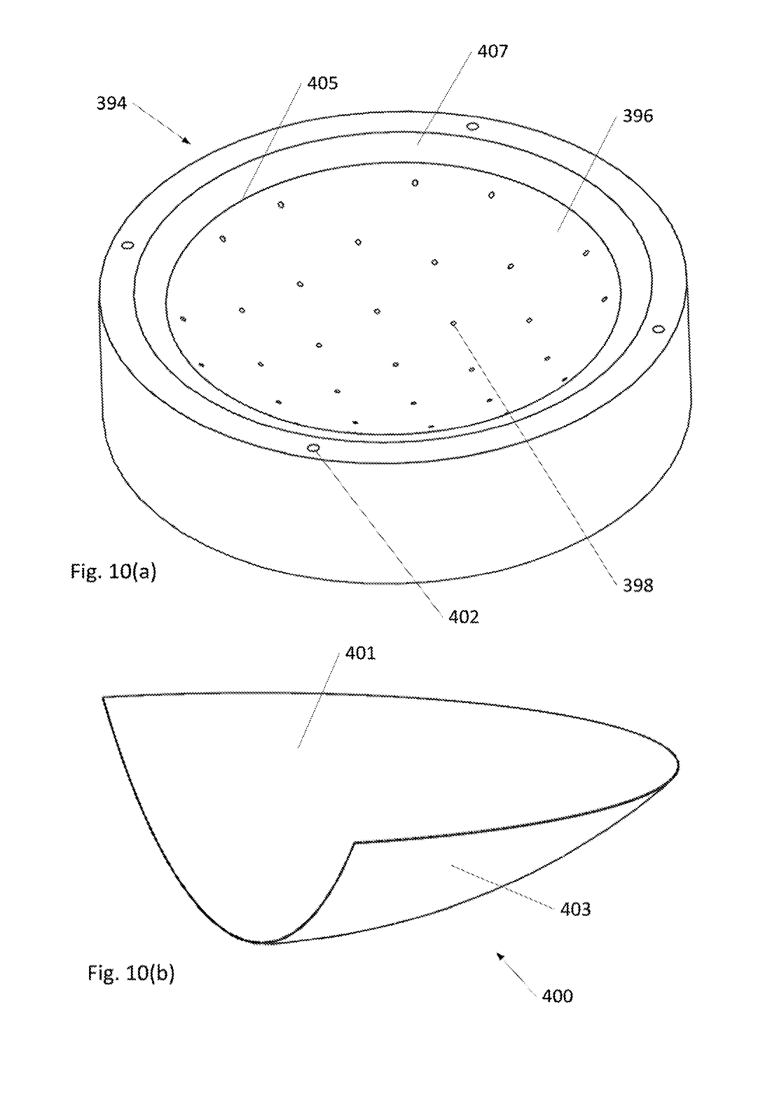

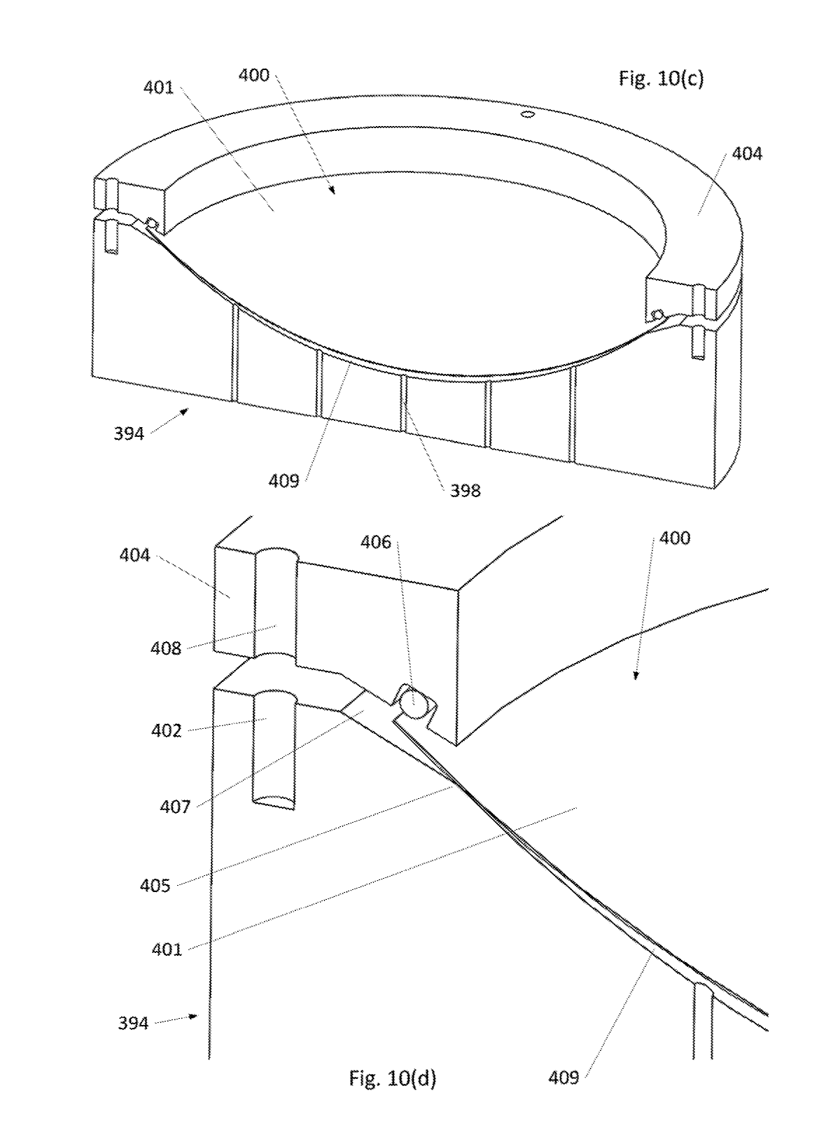

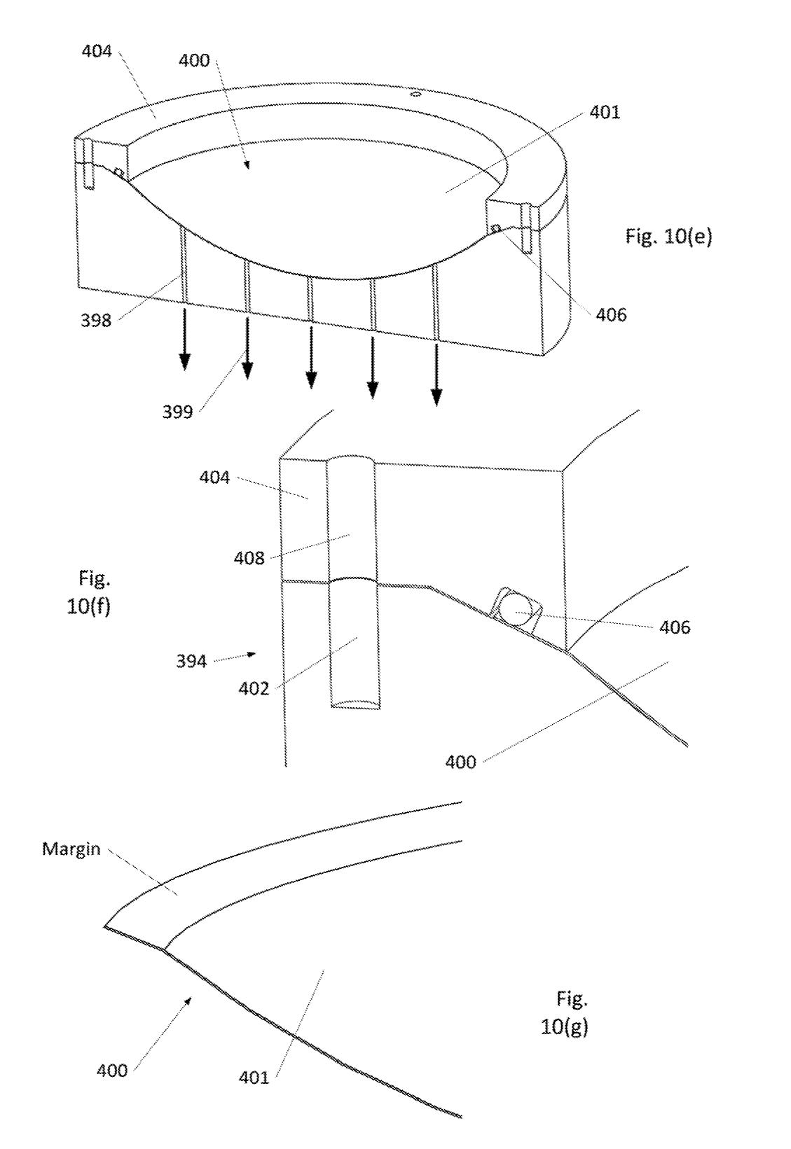

Given the goal of minimizing contamination of portions of the apparatus that are durable and used repeatedly and the desire to minimize the need for cleaning, a vessel which is easily cleaned or disposable may be employed. Thus, FIGS. 10(a)-(g) depict in 3D views a vessel comprising at least two main components: base 394 and removable, possibly single use (or cleanable, if desired) liner 400. Such a vessel can be used to heat ingredients in the same way that pots, pans, woks, or similar vessels are used conventionally. Depending on the materials used, the liner may be used inside an oven, broiler, microwave oven, or solid state RF energy oven, for example. The liner may be or may be formed from a thin (e.g., 0.010-0.300 mm, for minimal cost and stiffness) sheet comprising a metal such as aluminum, anodized aluminum, ceramic-coated aluminum, copper, stainless steel, or another metal, or a ceramic, or combinations thereof. Liner 400 may also comprise at least partially a chemically-resistant (and optionally, heat-resistant) food-safe coating such as silicone elastomer, PTFE-coated metal, or metal pre-coated with a cooking oil. For use in a microwave or solid state oven, the liner may comprise thin ceramic, glass, glass-ceramic, or medium-high temperature-resistant food-safe polymers such as polyethylene terephthalate, PTFE, polypropylene, polyethylene, and silicone. High thermal conductivity materials may be used, and fillers may be used to enhance conductivity in some embodiments.

FIG. 10(a) depicts the base 394 of a vessel which has a concave inner surface 396 intended to make contact with the liner, which may be shaped as a section of a sphere, as a pan- or pot-like shape (e.g., rectangular or trapezoidal in cross-section, sauteuse or sautoir shaped), etc. In some embodiments the surface of the base in contact with the liner may be substantially flat (e.g., for processing ingredients whose components (initially or once cooked) are not very flowable/mobile and will thus be retained on such a surface: pancake dough and eggs are examples. The surface may even be convex if desired. Surface 396 in plan view can be circular, elliptical, racetrack, polygonal (e.g., rectangular), etc. Base 394 may include at least one conventional heating or cooling element or one or more flow channels for heated or cooled liquids (not shown); alternatively heating/cooling may be provided by standard apparatus outside the base. The base further comprises a set of vacuum ports/channels 398 (which may be different in size than shown). Vacuum ports/channels 398 can controllably supply vacuum to the space between base and liner (i.e., remove air from that space) and pull the relatively flexible liner 400 (shown in the 3D sectional view of FIG. 10(b)) against surface 396, holding it there in intimate contact with surface 396, so as to achieve excellent heat transfer between base 394 and liner 400. Liner 400 may be concave as manufactured, though in some cases significantly shallower than the concave surface of the base, for example if the liner can be stretched upon the application of vacuum. The temperature of base 394 may be precisely controlled, e.g., by PID temperature controllers known to the art. Base 394 may also include holes 402 for clamping (e.g., using screws) a ring 404 (FIG. 10(c)) used in some embodiments, to promote sealing of liner 400 against base 394, and may be also used to manipulate liner 400. In some embodiments other means of clamping the ring to base 394 may be provided such as cam action hold-down clamps or spring clamps, which may be easier and faster to use. Base 394 may also incorporate edge 405 formed at the interface between surface 396 and surface 407 surrounding it. Base 394 may also incorporate strain gauges or other sensors (either as part of the apparatus that mounts the base to the system, or as part of the base) to measure the mass or weight of ingredients added to the vessel (the weight of the pouch contents may also be measured), verify that liner 400 (and optionally, ring) is installed on the base, etc. Base 394 may also incorporate other sensors such as those sensing food quality, temperature, pH, volume, etc. Base 394 may be adequately thermally isolated from most other components of the food preparation system, allowing it to be heated or cooled efficiently while minimally affecting those components.

FIGS. 10(c)-(f) are sectional 3D views showing liner 400, base 394, and ring 404, which may be furnished with an 0-ring 406 (or gasket) as shown. Assuming screws or similar fasteners are used, ring 404 may also have holes 408 in it whose location matches holes 402 in base 394. In FIGS. 10(c)-(d), liner 400 is not yet clamped to base 394, and there is normally at least a small gap 409 between the two (gap 409 may be smaller or larger than implied by the figures). The presence of gap 409 makes it difficult if not impossible to efficiently cook in liner 400. Moreover, liner 400 may be thin and lacking contact with surface 396, it is poorly supported and therefore fragile. Thus an approach to substantially reducing gap 409 is of great importance, and this may be achieved through vacuum. In FIGS. 10(e)-(f), ring 404 has been clamped to base 394, pressing liner 400 against base 394 near its circumference (e.g., at edge 405). Once a seal is obtained, vacuum has been applied to the space between liner 400 and base 394 by removing air in the direction shown by arrows 399 through ports 398, such as using a cavity or manifold of standard design (not shown) connecting all ports 398. This serves to pull outer surface 403 of liner 400 tightly against surface 396 of base 394. O-ring 406 may be used to prevent ingredients within liner 400 from seeping under ring 404. Another conventional O-ring or gasket (not shown) may be provided in some embodiments between liner 400 and 394 (e.g., in base 394) to help seal any gaps between liner 400 and base 394 so as to obtain good vacuum. However, incorporation in some embodiments of edge 405 on base 394, as shown in FIGS. 10(a) and 10(d), can improve sealing.

If base 394 is heated, for example, and no vacuum is applied, liner 400 warms; however, a significant temperature gradient may exist between the surface 396 and liner 400 due to the insulating layer of air between them, and the lack of thermal paths for direct conduction except where clamped by the ring (moreover, the thermal path from the perimeter of liner 400 to its center is very resistive due to the liner's minimal thickness). If desired in some embodiments, however, the temperature gradient can be enhanced by introducing cooled air (if the base is heated) or heated air (if the base is cooled) into the space between liner 400 and surface 396. With the vacuum switched on (e.g., by a solenoid valve), the air is rapidly extracted and intimate contact is established, with significant pressure (e.g., up to 15 PSI) forcing outer surface 403 of liner 400 against surface 396. In effect, the base serves as a vacuum chuck (such chucks are known to the art of machining and semiconductor wafer processing) that is heated or cooled, with precise temperature control and a concave shape. Given the low thermal mass of liner 400 and its high thermal conductance (especially if thin and metallic), the temperature of inner surface 401 of liner 400 can very rapidly increase to a value very close to that of surface 396. This allows liner 400 to behave much like a pot or pan having an inner surface which is inexpensive and in some embodiments can be disposed of, instead of needing to be laboriously washed and scrubbed to remove adherent food residues.

Moreover, due to the low thermal mass, rapid transitions in temperature can be achieved than would be possible with a pot or pan, which is ordinarily of much thicker material for reasons of mechanical stability and lateral heat spreading. The ability to rapidly heat or rapidly cool the liner (by reducing or turning off the vacuum so that air enters gap 409) provides control that is useful for cooking. For example, oil that is heated in a standard pan may spatter, and the spatter can contaminate equipment such as the pouch manipulator (if above the vessel dispensing an ingredient into the liner). To prevent this, air can be briefly (and ideally slowly enough to prevent sudden liner movement) introduced into the gap 409, causing a sudden drop in oil temperature and cessation of spattering. If the base is cooled vs. heated, rapid transitions in temperature can also be achieved with possible use (e.g., flash freezing of ingredients mixed inside the liner). Such intentional rapid changes in temperature can be achieved even faster by introducing a cooled or heated fluid into the gap between base and liner.

In some embodiments, liner 400 is thin, flexible, and elastic (e.g., a stainless steel), and surface 396 is ribbed or ridged, much like a grill. When air is pumped out of the gap 409, liner 400 may conform at least partially to the ribbed surface, thus providing a hot, ribbed cooking surface which can be perfect for searing ingredient such as steaks and producing grill marks. When air is reintroduced into gap 409, the surface of liner 400 can flatten out again at least partially (to the extent is has not plastically deformed), providing a lower-temperature, smooth surface which may be suitable for simmering an ingredient with an added sauce, etc. Alternatively, a liner may be ribbed and the inner surface of the base smooth, such that pressing the liner against the base using vacuum smooths out the liner. Thus, surface geometry and texture of the liner can be modified by the application of vacuum, and this can be done reversibly unless the liner is plastically deformed.

The liner, though thin (e.g., 0.001-0.005″ aluminum) is backed by the rigid base against which it is tightly held by vacuum. It is therefore very unlikely to tear while vacuum is applied, especially in the controlled environment of the machine, where tools can be kept out of direct contact with the liner if desired (e.g., following a well-controlled 3D trajectory that avoids the liner surface), used with light contact only (e.g., as measured by a load cell), or be made from compatible, relatively soft materials such as silicone elastomer. If aluminum is used for the liner, the inner surface may be coated (e.g., anodized) so that acidic ingredients such as tomato sauce minimally interact with it. Once unclamped from base 394 (e.g., prior to disposal or delivery to the use, or to pour its contents into another liner or a pouch, or to enter an oven) liner 400 may be slightly deformed near its margin as in FIG. 10(g), by having been bent over edge 405 (if provided). The specific design of the base, ring, and liner may be significantly different than that shown in FIG. 10 in various embodiments. Because the liner temperature can be changed quickly, the temperature of the base need not necessarily change quickly. It can therefore be heated electrically instead of using gas, making for a safer system (e.g., one not needing a gas supply), and making it easier to provide connections to the base if, in some embodiments, it is to move.

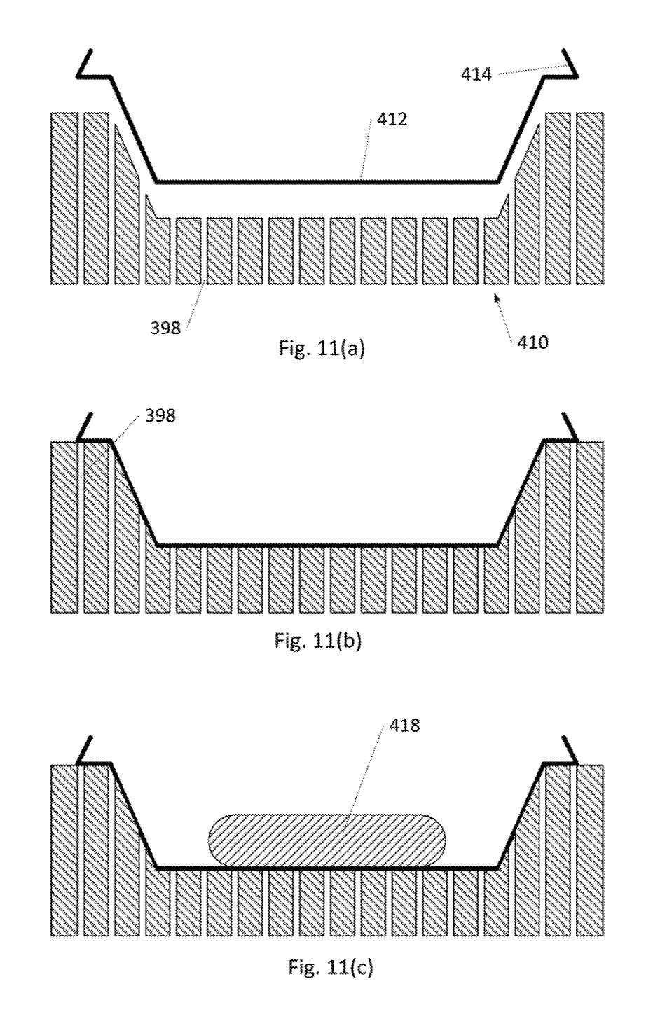

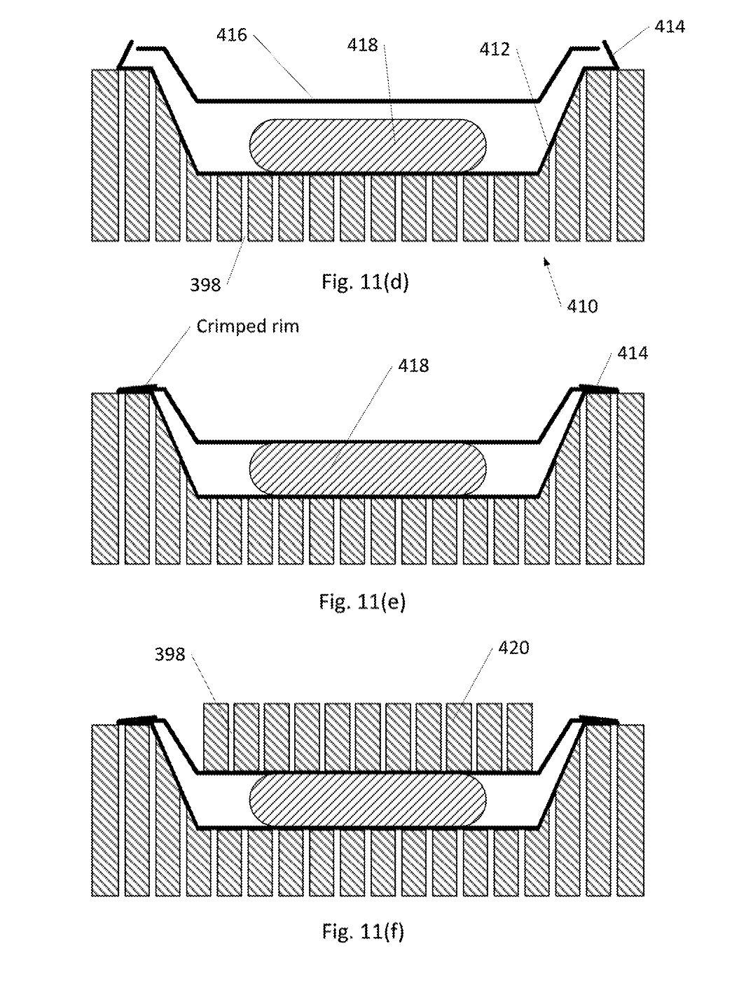

FIGS. 11(a)-(f) depicts in elevation cross-sectional views a vessel comprising a base 410 and a liner 412 having a different design than that of FIG. 10, used in some embodiments. In this case, for purposes of illustration, both elements have a trapezoidal cross-section, similar to a conventional pan, though spherical cap and other cross-sectional shapes are also possible. The overall shape of base 410 and liner 412 in plan view can be circular, elliptical, racetrack, polygonal (e.g., rectangular), etc. Base 410 includes vacuum ports 398 though in some embodiments these are not provided. Liner 412 may be provided with a rim 414 which is able to be crimped. A lid 416 may also be provided, which can serve as a second heating surface and also seal food within the liner 412 (e.g., for delivery to a customer using an automated food preparation system in a restaurant, or in the form of a vending machine). In FIG. 11(a), liner 412 is above base 410 while in FIG. 11(b) it has been laid into it, and vacuum has been applied. In the example shown, clamping of liner 412 near its edges is not necessarily needed to obtain a good seal with base 410. Unlike base 394 of FIG. 10, here ports 398 may in some embodiments extend further out radially and can help hold down liner 412 near its perimeter. Moreover, an elastomeric gasket or 0-ring may be provided in the base near the edge of liner 412 to facilitate sealing, or a liquid such as cooking oil may be used to provide a good seal.

In FIG. 11(c) an ingredient 418 such as a boneless chicken breast (depicted as one piece, but which may be a number of pieces) has been added to the liner and is cooking, being heated from below. In FIG. 11(d), lid 416 (e.g., made from the same material as liner 412) has been added. As shown in FIG. 11(e), lid 416 has a shape in some embodiments which can make contact with ingredient 418 once installed, though other shapes are possible. Lid 416 can be affixed to liner 412 if desired by crimping/bending rim 414 to retain lid 416 (FIG. 11(e)) or by other means. Heater block 420 provided with ports 398 can be placed against lid 416 (FIG. 11(f)) and the space between them evacuated to provide intimate contact between lid 416 and block 420, allowing additional heating of ingredient 418 through lid 416 from above, and obviating the need to flip ingredient 418 over to obtain uniform cooking, or to achieve simultaneous (e.g., faster) cooking. This is useful for example when cooking a panini, burger, steak, boneless chicken breast, etc. If desired, the means of joining liner 412 and lid 416, and crimping can be such that the combination of 412 and 416 is substantially leak-proof, and can even be turned on its side (e.g., to tumble the ingredients inside), or inverted. While crimping is shown prior to introduction of the heater, it can be subsequent to it (e.g., the last step), allowing vapor generated during cooking to escape between the liner and lid.

In some embodiments in lieu of or in addition to means of joining liner 412 and lid 416 (e.g., if not sufficiently leak-proof), a ring can be provided that holds the lid in intimate contact with the liner. The ring can be combined with heater block 420, making the combination of the two similar to, or even identical to, base 410.

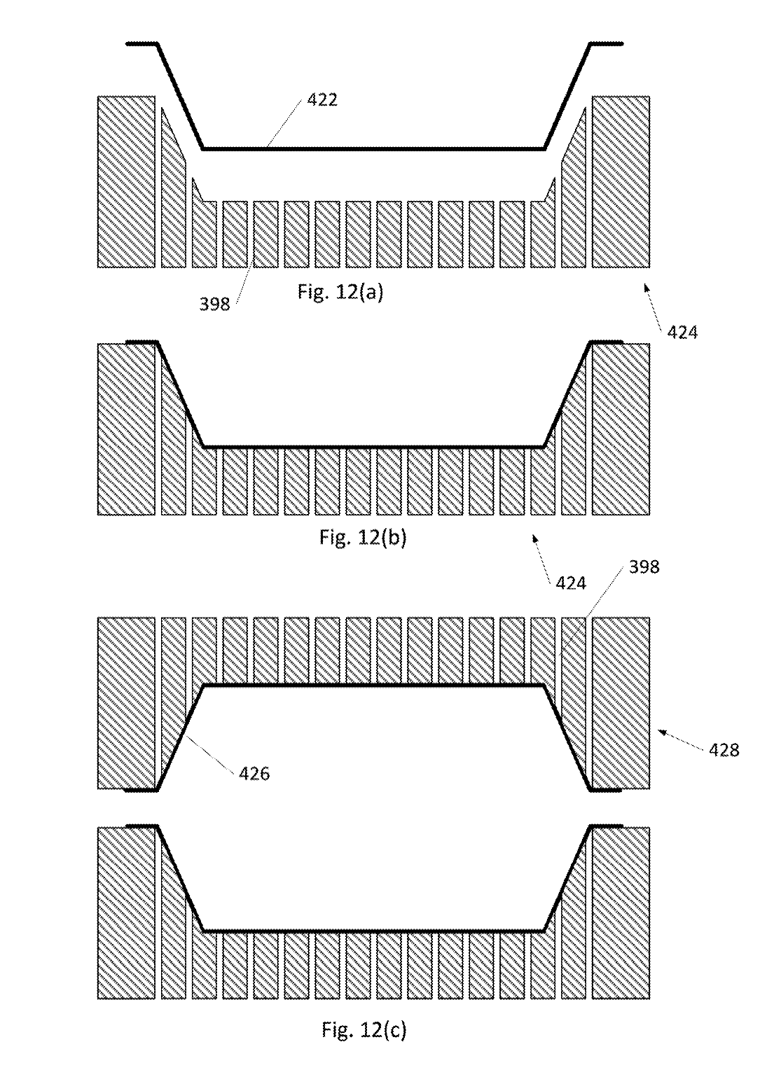

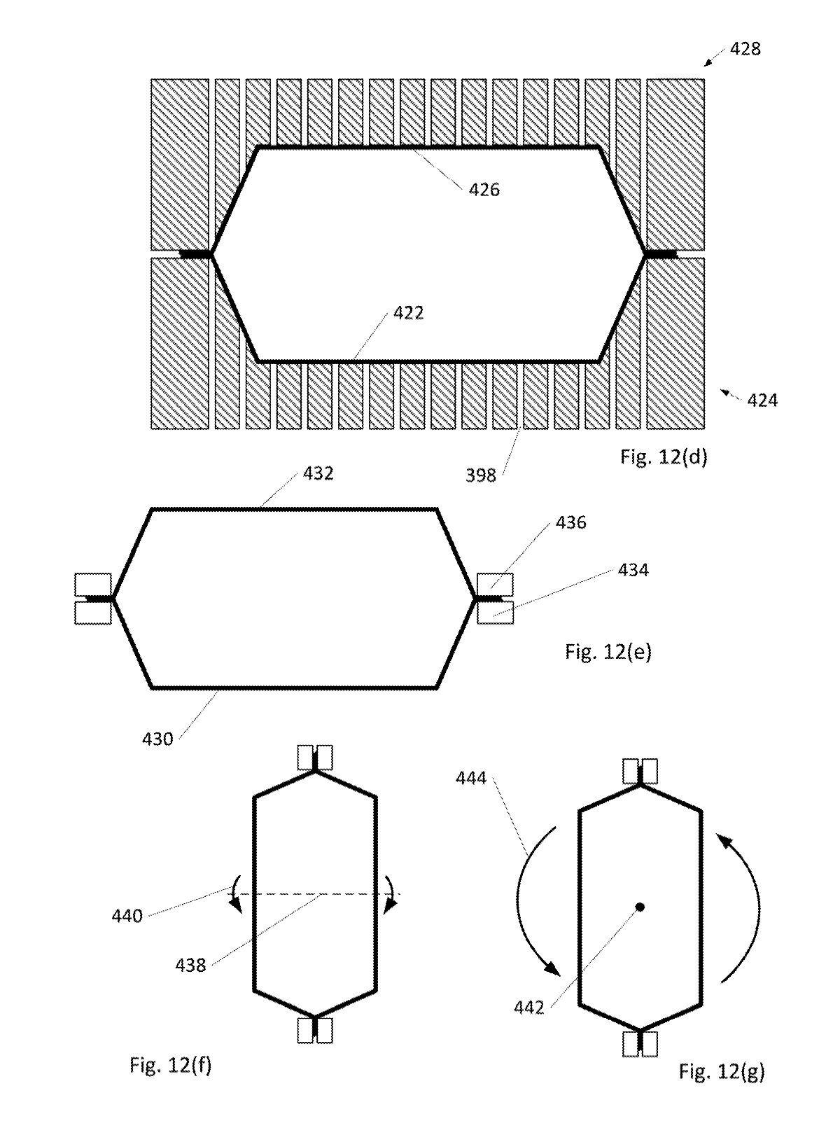

FIGS. 12(a)-(d) depict in elevation cross-sectional views lower liner 422 and lower base 424, the latter similar to base 410. However, in this case, the lid (now called an upper liner 426) is of similar shape and is heated by upper base 428. The actual shapes may be different than shown, and may be shallower, deeper, with flat or curved geometry, similar to a pot, pan, wok, etc. The overall shape of liners 422 and 426 and bases 424 and 428 in plan view can be circular, elliptical, racetrack, polygonal (e.g., rectangular), etc. Each base may receive, and have vacuumed against it, a liner; the two liners 422 and 426 may be arranged as shown in FIG. 12(c) and then brought into contact as in FIG. 12(d) such that they are pressed together by the two bases 424 and 428. If the material of at least one liner is not too hard, pressure applied to the liners can cause the two liners 422 and 426 to form a substantially leak-free joint while the two bases 424 and 428 are urged together. In some embodiments liners 422 and 426 can be welded (e.g., low-temperature/cold weld, resistance weld) together so they remain joined once bases 424 and 428 are separated. In some embodiments a sealing material may be provided around the circumference of one or both liners which can form a seal upon contact (e.g., a pressure-sensitive adhesive), upon heating (a heat-seal polymer), etc. In the case of a sealing material using heating to form a seal, such heating may be provided indirectly through heating of the base(s), or directly through dedicated heaters. In some embodiments a gasket or 0-ring can be included between the liners to seal them.

With the two liners joined, ingredients can be processed (e.g., heated) inside the vessel without spatter or loss, and the liners can be manipulated to tumble, toss, stir, and otherwise process the items inside. This can be done while heating or cooling one or both bases, or without doing so. A steaming basket may be located between liners 422 and 426, supported by either or both the liners, for purposes of steaming ingredients.

FIGS. 12(e)-(g) depict sectional elevation views of a similar pair of liners 430 and 432 which are held together (if not otherwise sealed) by lower ring 434 and upper ring 436; these rings may be smaller and lighter than bases 424 and 428. Rings 434 and 436 may be held together by quickly-removable clamps such as cam-based clamps or spring-based snap-on clamps; rings 434 and 436 may extend past the edges of liners 430 and 432 to facilitate this. Liners 430 and 432 can be heated by lower and upper bases or block similar to block 420, or just one liner may be heated (e.g., using a lower base below) at a time, using vacuum to draw the liner against the base, or by other methods including flame heating, convection, radiative heating, etc. If liners 430 and 432 have the same shape and a single base is heated (or cooled), combined liners 430 and 432 can simply be inverted (e.g., while the rings clamp them together), placed in the base and held again it by vacuum, so as to heat the ingredients through one liner or the other, in alternation (e.g., with the inversion occurring rapidly compared to the time a liner spends within the base). Thus an ingredient such as a hamburger patty may be efficiently cooked on both sides as if it were on a grill being flipped. In this case, however, the ingredient is only contacted by liners 430 and 432, with the base remaining perfectly clean and uncontaminated. Moreover, the flipping may be performed easily, reliably (regardless of the particular shape of the ingredient(s)), and without any loss of ingredient(s) due to spatter, etc. If desired, the internal height of combined liners 430 and 432 can be made small enough that the ingredient(s) cannot rotate inside during flipping (or tumbling).

As shown in FIG. 12(f), combined liners 430 and 432 can also be rotated (e.g., around axis 438 as shown by arrows 440, or around another axis such axis 442 of FIG. 12(g) as shown by arrows 444 so as to process (e.g., tumble, toss, evenly cook, mix, stir) the ingredient(s) within. Rotation can be continuous in one direction, or oscillatory/reciprocating. While rotating, heat can be applied to the liner for purposes of cooking. This can be achieved using for example lightweight heated bases in contact with the liners (e.g., resistively heated bases powered through wires (allowing a limited range of rotation) or slip rings), using inductive heating, using a flame impinging on the liners (e.g., from below), a hot air or liquid stream, immersion in hot liquid, microwave or solid state RF energy transmitted through the liners (if not metallic), etc. If the liners are metallic (or for example, involve a metallic layer), the sealed chamber they form can become a self-contained microwave/RF oven if radiation is introduced through one or more holes; radiation reflecting from the liner surfaces would eventually be absorbed by the ingredients within. The liners may include features such as projections (“speed bumps”) which help cause ingredients to ride up on the internal surfaces as the liners spin/tumble causing them to roll and fall, rather than just slide and remain at the bottom; this creates an effect similar to using a spatula or spoon to turn over ingredients in a pan. The projections may be formed in the liner(s) much like the ribs mentioned above, by vacuum contact with projections in the base(s). If a liner is not plastically deformed, once released from the base it would no longer have such projections, which may facilitate food being consumed directly from the liner.

Vessels comprising disposable or multi-use liners, at least one vacuum-equipped base, and possibly, lids, can be a product in their own right, apart from an automated food preparation system: essentially serving as a pot or pan which doesn't need to be cleaned, or can be more easily cleaned (e.g., since multi-use liners are not attached to handles, they can fit more easily into a dishwasher). The base can be place on a stove burner, or can be electrically heated as a countertop appliance, or can even be built into a stove.

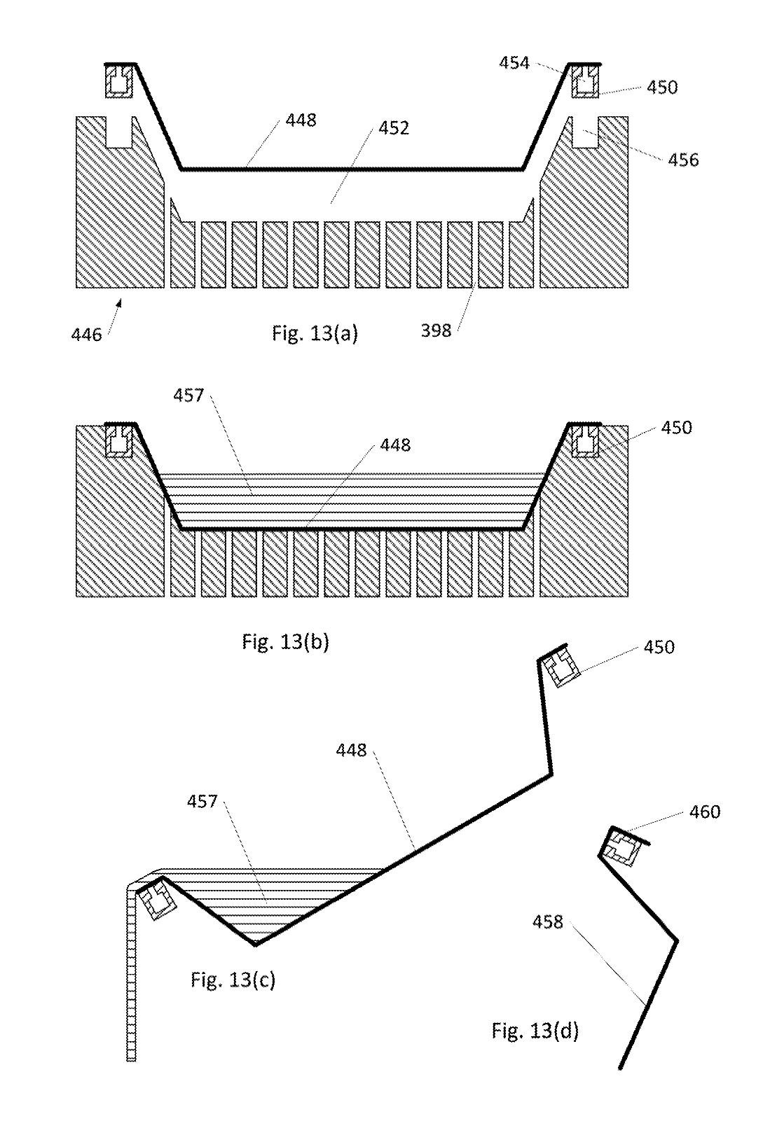

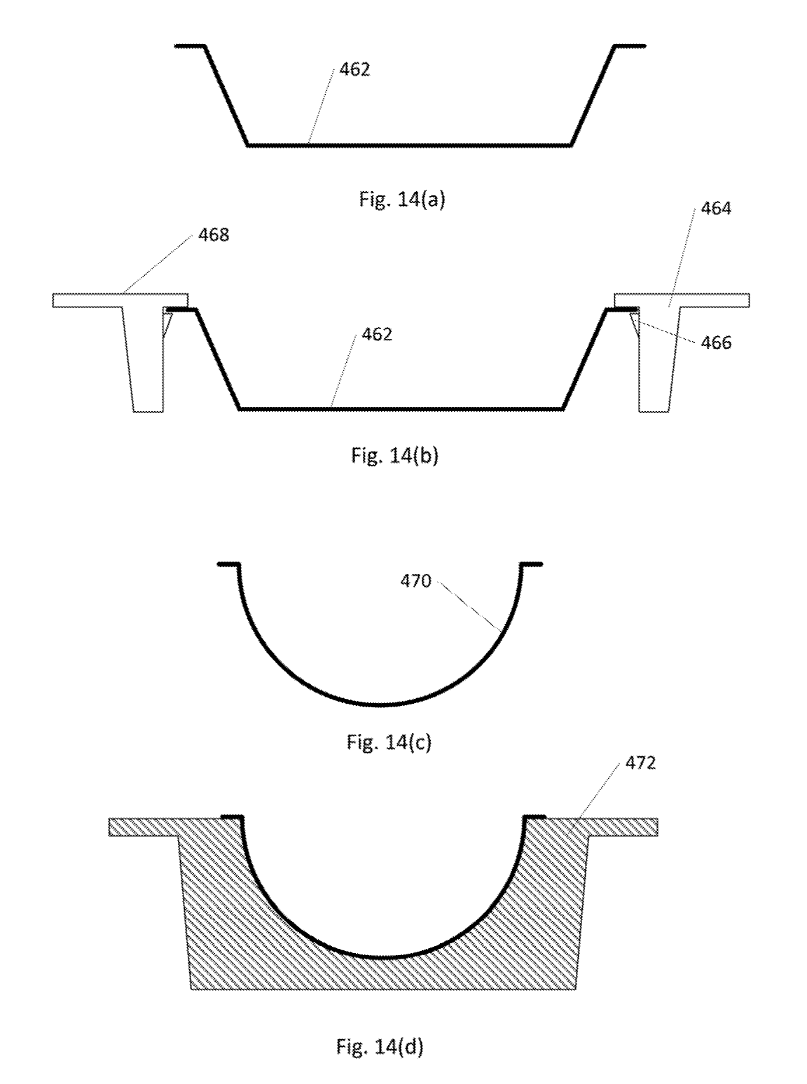

FIGS. 13(a)-(d) show a set of elevation cross-sectional views. FIG. 13(a) depicts a vessel comprising base 446, liner 448, and ring 450. The actual cross-sectional shape of liner 448 and the corresponding recess 452 in base 446 may be different than shown, and may be shallower, deeper, with flat or curved geometry, similar to a pot, pan, wok, etc. The overall shape of liner 448 in plan view may be circular, elliptical, racetrack, polygonal (e.g., rectangular), etc. Ring 450 may be equipped with vacuum channel 454, allowing it to hold onto the liner securely; in some embodiments the ring may include one or more 0-rings/gaskets for sealing. Base 446 may be provided with groove 456 to accommodate the ring when liner 446 is inserted into recess 452 as in FIG. 13(b), though in some embodiments base 446 is of smaller size and ring 450 simply surrounds it.

In general, the contents 457 of a liner such as liner 448 can be transferred to another destination (e.g., a dish or another liner) by means of scooping, grasping (e.g., tongs, forceps), spearing (e.g., with a fork or skewer), by surface tension (e.g., dipping in a brush or sponge), through vacuum extraction (e.g., a syringe, pipette, turkey baster, eyedropper, tube connected to a pump, etc.), and simply by tilting it. In some embodiments the entire base 446 may be tilted to allow for pouring (or tumbling/falling out of an ingredient), while in other embodiments as is shown in FIG. 13(c), ring 450 may raise liner 448 above the base and tilt it to pour ingredient 457 within into a receptacle, allowing base 446 to remain fixed. Liner 448 may extend further past ring 450 than shown in FIGS. 13(a)-(c), to avoid ring 450 from being contacted by food during pouring. As an alternative or a supplement to a vacuum channel 454 in ring 450, in some embodiments the liner may have a lip 460 as with liner 458 in FIG. 13(d) that wraps around ring 450 at least partially (or fully as in FIG. 13(d)) so the liner is retained when tilted for pouring. Groove 456 within base 446, if provided, can accommodate lip 460 as well as the ring 450.

In additional to supporting liners during pouring operations, rings mounted to suitable actuators can be used to fetch liners (e.g., from a stack of liners). For example, the ring can pull liners off the bottom of a stack that is properly supported (e.g., as in a cup dispenser). Or, if the ring can rotate through a sufficient angle, an inverted liner may be pulled off the top of a stack, and then oriented before insertion into the base. A liner may also be grasped initially by another mechanism (e.g., by a central vacuum pickup) and raised so that the ring can access it from underneath.

FIG. 14 depicts several elevation cross-sectional views of liners which are transformed dishes from which food can be served or directly consumed, thus obviating the need to make a dish dirty. In FIG. 14(a), a plate-style liner 462 is shown, which can be inserted into a reusable serving rim 464 to form an integrated, transportable plate by placing the latter over the liner and snapping the rim onto the liner as in FIG. 14(b). One or more releasable catches 466 on rim 464 can be provided to retain liner 462 when rim 464 is moved. The top surface 468 of rim 464 can be decorative, and rim 464 can be formed at least in part from typical dish materials such as ceramics. If desired, rim 464 can support liner 462 so that no part of liner 462 makes contact with the table on which the dish is placed, or liner 462 can be flush with the bottom of rim 464 as shown, such that it is supported by the table during use. Liner 462 can be distorted, or catch(es) 466 released, to allow liner 462 to be separated from rim 464 for liner disposal, while rim 464 can be washed as needed. In FIG. 14(c), bowl-style liner 470 is shown, which is inserted into a cavity in serving support 472 from above. Support 472 cradles liner 470, gives it strength, and prevents it from tipping over while food within is consumed. In some embodiments the food preparation system can insert liners into serving rims and serving supports automatically.

### Specialized Ingredient Dispensing

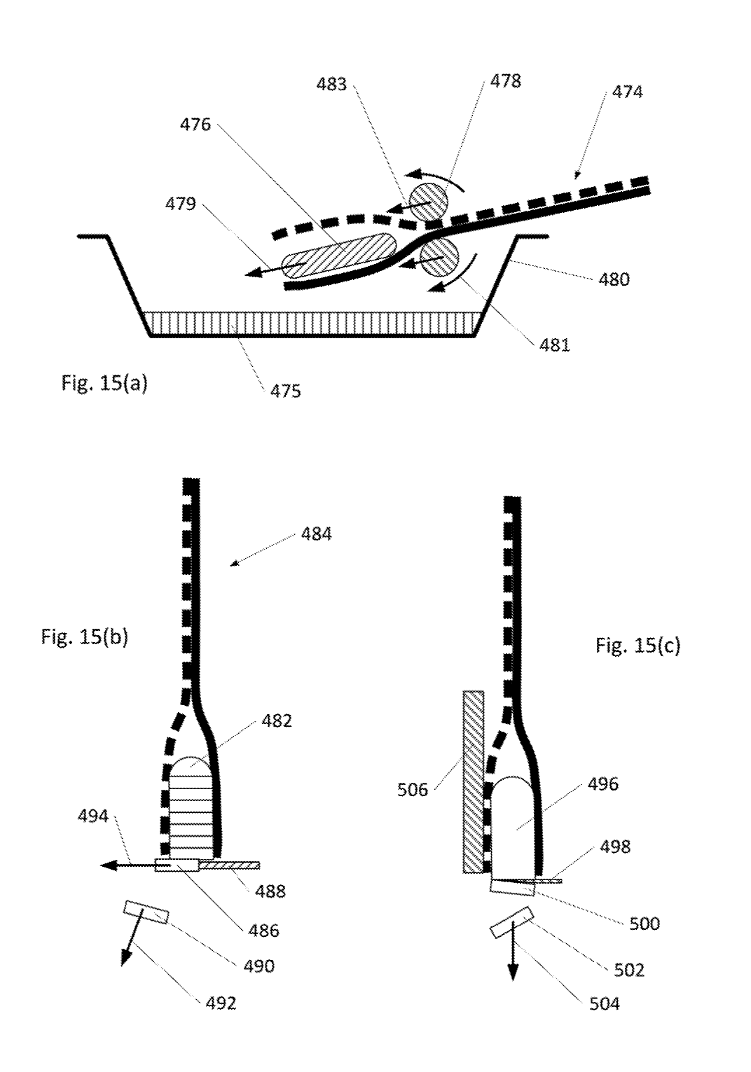

FIG. 15 shows several elevation cross-sectional views of specialized methods and apparatus for dispensing of ingredients from pouches. In FIG. 15(a), pouch 474 has been rotated (e.g., by a pouch manipulator or dispenser) so that it is at a shallow angle to the horizontal, which can provide more control over ingredient delivery. For example, if an ingredient is relatively large (e.g., a chicken breast, filet of fish, or steak), the pouch is vertical, and the receptacle receiving the ingredient contains a liquid 475 such as hot oil or sauce, for example, the ingredient once issuing from the pouch will likely fall over and in so doing, cause splashing of the liquid. Such splashing can contaminate the system and waste ingredients, so is undesirable. In the figure, ingredient 476 is pushed out by rollers 478 or other means (e.g., vibration) in the direction shown by arrow 479 into receptacle (e.g., liner 480 as shown, which may be supported by a ring or base) which has another ingredient(s) (e.g., a liquid) already within. Rollers 478 rotate in the direction of arrows 481 and translate in the direction of arrow 483. Since ingredient 476 is delivered to liner 480 at a shallow angle, it will not rotate very much as it settles into liner 480, and so the risk of splashing is much reduced. Another example of the use of shallow-angle delivery is as a means of reducing the speed at which ingredients within the pouch are delivered, since at a shallower angle, ingredients will tend to slowly slide or roll along the inside surface of the pouch, rather than quickly fall out, since the vertical component of the gravitational force is smaller. Pouches which are placed at non-vertical angles to slow the delivery of ingredients can in some embodiments be fitted with a channel at their open ends that diverts the flow of ingredients into a vertical nozzle, or the pouch tip can be bent through 90 degrees, etc. A pouch can also have one or more side holes so it can discharge its contents from the side (e.g., near the bottom). For example, the multi-compartment pouches of FIG. 8 can have the compartments accessed in any order by cutting open, piercing, peeling, etc. individual compartments while the compartment (or entire pouch) is at a desired angle (e.g., horizontal).

FIG. 15(b) depicts a controllable delivery approach for ingredients which are pre-sliced or which have a shape (e.g., flat, parallel top and bottom) suitable for stacking. Such ingredients may include vegetables (e.g., cucumber, tomato, pickle), deli meats, bread, cheeses, hard eggs, crackers, etc. If ingredient pieces are arranged in a stack 482 (easily achieved for ingredient slices obtained from a larger unit, such as a pickle), then stack 482 can be oriented as shown in FIG. 15(b) such that as stack 482 is advanced toward the open bottom end of pouch 484 (e.g., by rollers as in FIG. 15(a), not shown, and possibly using a pusher as in FIG. 5), individual slices 486 can be released and like slice 490, and fall (e.g., into a liner) as shown by arrow 492. In some embodiments a pushing tool 488 may be used to push slices 486 off of slack 482 as shown by arrow 494 and allow them to fall. In some embodiments a method (such as the pouch tensioning approach of FIG. 7) might be used to retain a stack which might otherwise slide out due to gravity. For example, pouch tensioning and pusher movement can be alternated and synchronized so that the stack advances downward controllably (by the thickness of one slice) as each piece 490 is pushed off.

FIG. 15(c) depicts a controllable delivery approach in which ingredient 496 is not pre-sliced and is sliced as it issues from the pouch (e.g., cucumber, pickle, bread, eggs). Means of advancing ingredient 496 such as rollers (not shown, possibly in conjunction with a keel) may be used, and cutter 498 (e.g., a blade, reciprocating or rotating blade, bandsaw- like blade, small diameter wire, heated wire, etc.) is moved relative to the ingredient to separate slice 500 which then falls, as does slice 502 in the direction shown by arrow 504. In some embodiments, in lieu of a cutter which forms slices, ingredients may be subdivided into other forms as they issue from the pouch using a grater, spiralizer, chopper, or other apparatus. In some embodiments a method and apparatus (such as the pouch tensioning approach of FIG. 7, possibly in conjunction with rollers and a pusher) might be used to retain the ingredient which might otherwise slide out due to gravity and so lower it gradually, allowing cutter 498 to produce pieces of controlled thickness. In some embodiments backing plate 506 may be provided on one or both sides of the pouch to prevent movement of the pouch and ingredient during the subdividing process. Means of cleaning tool 488 or cutter 498 (if not disposable) can be provided.

Whether an ingredient is pre-sliced or not, not all of it may be needed for a given recipe or at a given time. In that case, the pouch can be inverted so that the remaining ingredient are entirely within the pouch, and the pouch can be resealed if desired (e.g., it may have a resealable seal as known to the art of packaging, or may be heat sealed in a different region). When the time comes to dispense the ingredient, the pouch can be opened, inverted, squeezed or tensioned to retain the ingredient. Or, the pouch can simply be inverted and prepared to be opened near the pusher or cutter. The pusher or cutter can be extended to serve as a stop below the pouch, such that when the ingredient is released from the pouch, its position will be determined. The ingredient can then be retained (e.g., again by squeezing or tensioning the pouch) and the pusher or cutter withdrawn. Then the roller (possibly in conjunction with a keel) can push out the ingredient so that pushing/cutting can be continued.

Ingredients which are delivered one slice/piece at a time may be distributed controllably within a vessel or in/on a food product (e.g., vegetables or pepperoni on a pizza) by moving the pouch with respect to the vessel or food product in a synchronous fashion so that the ingredient falls in different locations as determined by the program and algorithms of a controller.

### Cleaning

While many processing operations common in food preparation such as dispensing, heating, stirring, and mixing can be performed using properly-designed pouches, dispensers, bases, liners, and apparatus for tumbling, some operations may still best be achieved using more conventional tools or adaptations thereof, either within vessels (lined or unlined), or within pouches or other containers and packages which can be opened, deformed, peeled apart, etc. so as to expel the contents after processing. Examples of such operations may include stirring, mixing, blending, beating, food processing (i.e., operations performed with a conventional food processor blade or similar), liquefying, pureeing, whipping, whisking, chopping, and grinding. Such tools, unless single-use, should be cleaned regularly. It may be useful to perform such operations within a vessel, pouch, or other container, so as to allow vessels, pouches, or containers already being used for other purposes (e.g., heating ingredients) to also be used for these operations, thus minimizing contact of ingredients with additional surfaces. Therefore in some embodiments, such operations may be carried out using tools which are placed in vessels, pouches, etc. For example, ingredients may be cooked within a vessel comprising a base and liner, while a stirring tool is moving within the vessel to stir the ingredients.

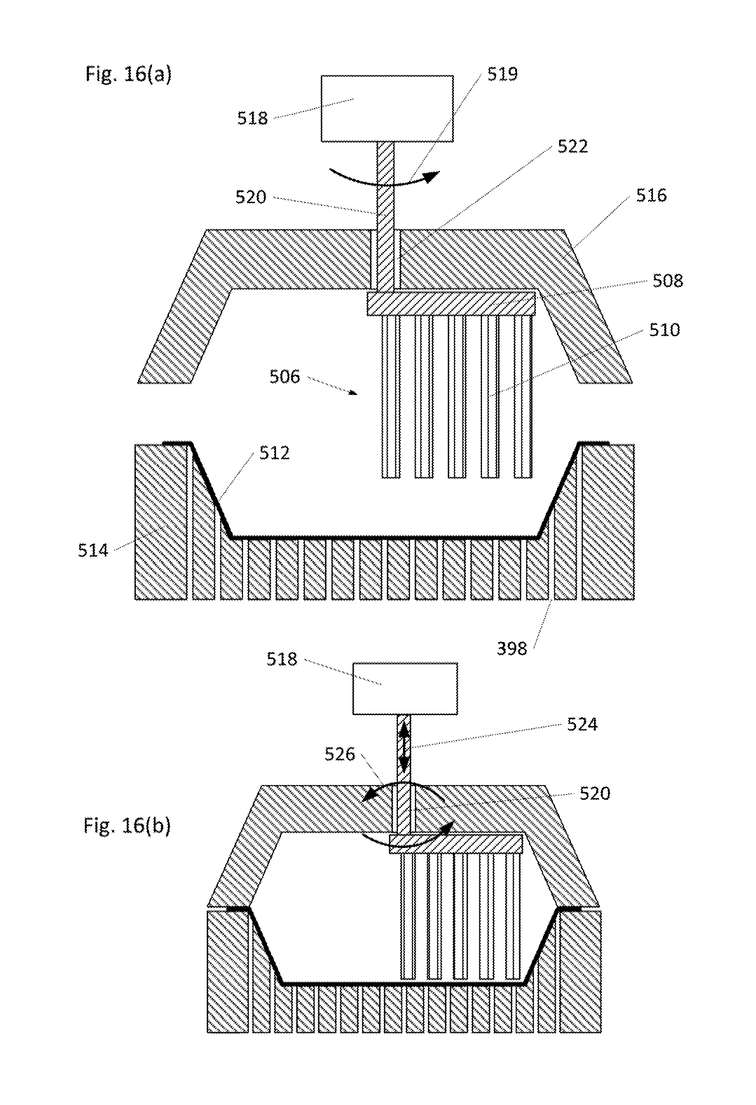

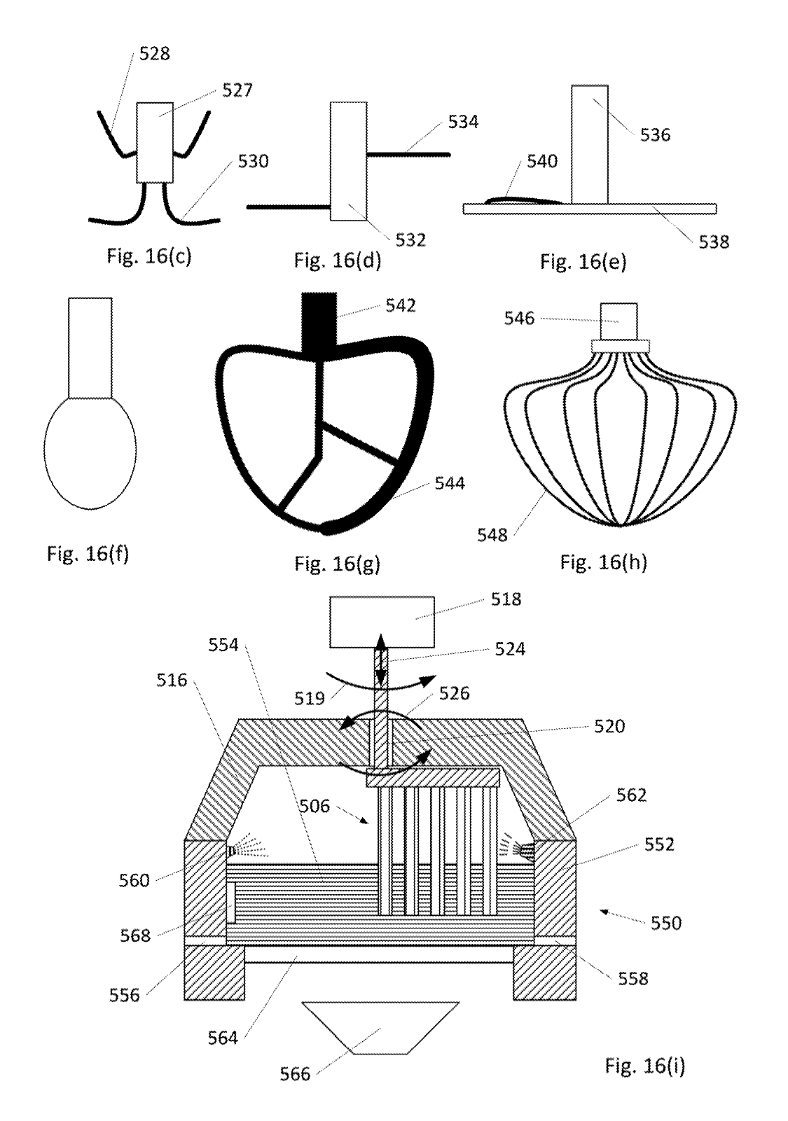

FIG. 16(a) shows a cross-sectional elevation view of a representative tool 506 comprising support 508 and rods 510 which might be used for stirring or mixing. Rods 510 may be rigid or flexible, smooth or textured, of various lengths, widths, and cross-sectional shapes, of various materials, etc., for example. Also shown is a vessel having a liner 512 and a base 514 (which may include vacuum ports as shown for cooking); however, a vessel without a liner may also be used. A splash/splatter-controlling cap 516 (which can also be used to contain steam, odors, etc.), a motor 518 able to rotate tool 506 as shown by arrow 519, etc. are additionally depicted. Cap 516 can be solid, solid with vents, or open (e.g., a screen which prevents spattering) and can be made from more than a single part. Cap 516 may be curved internally (not shown) so as to allow any condensation to run down to the edge of the caps, rather than drip as can happen with a cap horizontal and flat internally (as shown in the figure). In some embodiments each tool may be provided with its own cap, with each tool/cap coupled interchangeably to a single motor 518 and shaft 520. In other embodiments a single cap 516 (which may be integrated with the motor 518 and possibly, shaft 520) can be used with interchangeably with a variety of tools. Tools can be coupled with motors 518 and shafts 520 after passing shaft 520 through cap 516, or if cap 516 is made in more than one piece (e.g., two halves), tools may already be attached to motor 518 and shaft 520 and cap 516 may be assembled around the shaft. In some embodiments, at least some tools have their own motor and shaft. Some tools may not have a cap at all, since in normal use (e.g., operating at low speed) the tool does not splash or splatter ingredients, etc. Motors and actuators may produce motions other than rotation of the tool in some embodiments, such as translation (shown by arrows 524) or tilting (shown by arrows 526) of the tool. Caps in some embodiments may be disposable/single use (e.g., made from thin plastic or aluminum foil). Some tools may be equipped with shields/guards to prevent them from making contact with the sides of vessels or other objects as they move.

In FIG. 16(a), shaft 520 connected to motor 518 passes through cap 516 (e.g., through bearing and/or seal 522) and is attached to tool 506 n some embodiments, while in other embodiments motor 518 and tool 506 are coupled magnetically (e.g., by permanent magnets or electromagnets). Support 508 if used, can be a disk, partial disk, etc. and may cover the opening in cap 516, e.g., especially if there is no seal 522 provided. The assembly comprising motor 518, cap 516, support 508, and rods 510 may be lowered in some embodiments onto base 514 and liner 512. Cap 516 may be lowered until it contacts liner 512 (FIG. 16(b)), substantially sealing the interior volume and preventing ingredients from escaping during operations. Base 514 and liner 512 may be shaped like a pan (as shown), pot, wok, etc., and the interior surface of the liner (or vessel if no liner is used) can comprise such materials as stainless steel, aluminum, anodized aluminum, enamel-coated steel, non-stick materials such as PTFE, etc.

FIGS. 16(c)-(h) depict some examples of alternative tools which may be used in different operations. The tool in FIG. 16(c) comprising shaft 527 and blades 528 and 530 may be used for blending, and that of FIG. 16(d) comprising shaft 532 and blades 534 for chopping, processing dough, or blending (in which case the blades may be at substantially the same height). The tool of FIG. 16(e) comprising shaft 536, disk 538, and blade 540, may be used for cutting/slicing, and similar disks may be used for grating, shredding, julienning, etc., whereas the spoon/paddle/spatula-like tool of FIG. 16(f) may be used for stirring or mixing. The tool of FIG. 16(g) comprising shaft 542 may be used for mixing, and may incorporate a scraping edge 544 which can contact the inside surface of the vessel, liner, pouch, etc. so as to process ingredients adjacent to the inner surface, while the tool of FIG. 16(h) comprising shaft 546 and wires 548 may be used for whisking, whipping, frothing, etc. Conventional helical/spiral dough hooks (not shown), frothing tools, and many other tools may be also be used. All tools may be attached to the motor through a detachable coupling (not shown) known to the art of machine design, allowing tool interchangeability.

When the motor is activated at a desired, the tool rotates as shown in the figure by arrow 524, and a standard linear actuator (not shown) may also translate the tool axially as shown by arrow 524 to vary the depth of the tool within the vessel, etc. This may be done once to set the optimal tool position for the operation, or else the depth may be varied during the operation as needed (e.g., to ensure that the tool has access to the entire volume of ingredients: axial motion similar to this is common when using immersion blenders, for example). Similarly, the speed and/or torque of the motor may be set once or varied during the operation. In some embodiments, the shaft can tilt about one or more axes perpendicular to its rotational axis as shown by arrows 526, allowing the tool to be tilted from side to side in addition to or in lieu of sliding axially. This can be achieved by including in the cap a ball joint or an elastomeric region surrounding the shaft, making the entire cap from an elastomer (e.g., silicone, which also facilitates sealing to the vessel, supporting the motor with a gimbal, etc. If the motor/shaft/tool is able to tilt, tilting can be produced by moving a carriage in one or two axes; the same carriage may be used to position the tool, shaft, motor, and cap over the vessel. In some embodiments the motor may be connected to the shaft through a flexible shaft and in some embodiment variations the motor may be remote and substantially fixed. In some embodiments, the tool may be moved in a planetary or other complex motion such as those found in stand mixers. It may be desirable in some embodiments for tools (e.g., stirring rods) to contact or almost contact the inner surface of the vessel/liner, for example to manipulate ingredients in close proximity to the wall, such as keeping ingredients (e.g., those comprising liquids) from overheating or burning.

FIG. 16(i) depicts a cross sectional elevation view of a method and apparatus for cleaning tools and cap (if the cap is contaminated by ingredients) in which the cap, motor, and tool (or in some embodiments, only the cap and tool) are moved over to cleaning station 550 where they can be cleaned. However, in some embodiments tools or portions thereof may be removed and disposed of (e.g., if made from molded plastic, wood, etc., possibly with metal cutting edges), and in some embodiments the cap is itself disposable (e.g., if made from thin aluminum foil). In some embodiments the tools can be made from thin, low-cost films (e.g., plastic) which are inflated by fluid in use to make them sufficiently stiff.

Cleaning station 550 may in some embodiments comprise any or all of the following: tank 552 holding cleaning solution 554 (e.g., containing a detergent) and equipped with at least one conventional pump (not shown); at least one inlet 556 allowing solution 554 or rinse water to enter, and at least one outlet 558 allowing solution or rinse water to be drained; at least one spray nozzle 560 for spray solution 554 or another liquid; at least one air nozzle 562, at least one window 564 (e.g., at the bottom of tank 552) allowing UV light from at least one UV or pulsed light (Claranor, Avignon, France) source 566 to enter station 550 and reach the surfaces of tool 506 (or any other tool, such as those in FIGS. 16(c)-(h)) and cap 516, and at least one sonic, ultrasonic, or megasonic transducer 568 with associated electronics. Cap 516 is sealed against tank 552 (e.g., by applying clamping pressure, the use of a gasket or 0-ring, etc.) to avoid leakage during operation.

In operation, tool 506 and cap 516 may be cleaned and sanitized/sterilized by any or all of the following processes: immersion in cleaning solution 554 (which can be emptied an replaced with new solution in multiple cycles), agitation (e.g., rotation and/or oscillatory rotation by motor 518 as shown by arrow 519, axial motion of the tool as shown by arrows 524, and/or tilting of the tool within the cleaning solution as shown by arrow 526), which may be done while the tool is immersed or being sprayed, for example; spraying by cleaning solution 554 or another liquid (e.g., using high pressure jets emanating from nozzle(s) 560); steam or high pressure steam delivered by nozzles 560 or other nozzles; sonic, ultrasonic or megasonic agitation of the cleaning solution; UV irradiation (e.g., to kill residual microbes on the surface after cleaning, rinsing, and drying); pulsed light sterilization; ozone; and heating of the tools to eliminate food residues through pyrolysis and/or destroy microbes. Assuming a good seal between tank 552 and cap 516, the level of solution 554 in tank 552 may be raised beyond the top of tank 552 to contact all surfaces of tool 506 and cap 516. After solution 554 has been used, it may be drained from station 550 through outlet 558 and replaced by clean rinse water (e.g., supplied via inlet 568 or nozzle 560), which may be applied to tool 506 by immersion, spray, etc., and to cap 516 by spray, etc. After cleaning, tool 506 and cap 516 may be air dried after separating from tank 552, and/or air dried while still adjacent to/within station 550 by means of spinning at high speed and use of air nozzle(s) 562, which may deliver high velocity, warm/hot air jet(s).

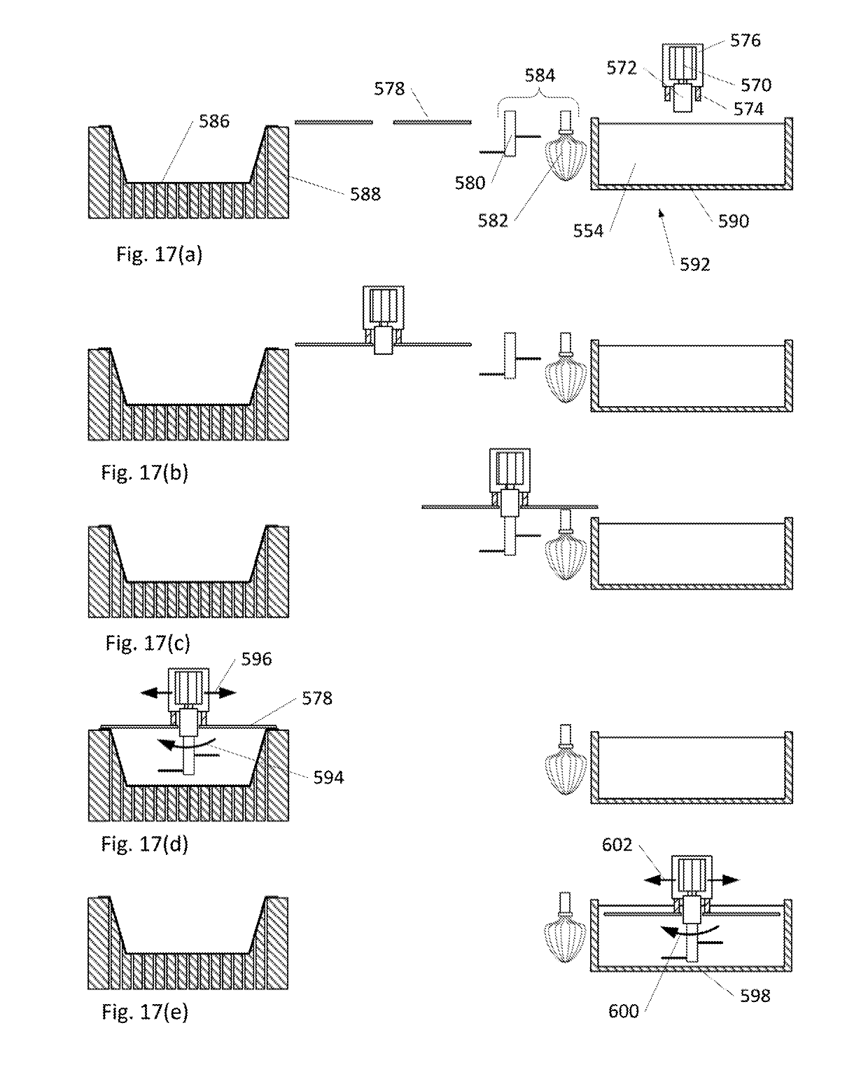

FIG. 17 depicts as cross-sectional elevation views a sequence of steps in some embodiments by which motor 570 with coupler 572 and pickup for a cap 574 is moved by carriage 576 forming part of a conventional motion stage (not shown) or moved by another form of robotic device, such as a jointed arm, to pick up cap 578 (if used), then couple to a tool such as chopper 580 or whish 582 from tool storage area 584, then use the tool within a vessel (e.g., liner 586 and base 588 as shown), and then clean both tool and cap. In this case, multiple tools are used with a single cap, and each tool may have its own cap in some embodiments. Here cap 578 is designed to fit to cleaning tank 590 so it can be cleaned along with the tool. In FIG. 17(a), carriage 576 may be initially positioned over cleaning station 592 as shown, while in FIG. 17(b), it has moved over cap 578, picking it up using one or more pickups 574 (e.g., vacuum, magnetic/electromagnetic, or through a mechanical coupling). Carriage 576 then moves over a tool (here, chopper 580) in tool storage area 584 as in FIG. 17(0 and motor 570 is coupled to tool 580 (e.g., coupler 572 may involve a hexagonal or octagonal shaft fitting into a similarly- shaped socket, with a magnet or electromagnet to retain it). Then, in FIG. 17(d), carriage 576 (capable of vertical as well as horizontal movement) has moved above liner 586 and chopper 580 has been lowered 580 to enter liner 586 to process ingredients therein; cap 578 has closed off liner 586 to control splashing, etc. while the tool is in use. In use, motor 570 rotates chopper 580 as shown by arrows 594 while carriage 576 optionally reciprocates as shown by arrows 596. Finally, in FIG. 17(e) carriage 576 has withdrawn cap 578 and chopper 580 and moved over station 592 and cap 578 and chopper 580 have entered the station and are being cleaned. As shown, station 592 comprises tank 598 and cleaning solution 554; however, other cleaning station designs may be used, including similar to that of FIG. 16, having one or more of the cleaning/sterilizing capabilities described above. Motor rotation 600 as well as horizontal carriage motion shown by arrows 602 can be used to help agitate the cleaning solution and tool and promote cleaning. The motor may be connected through a wiring harness or similar, or may be powered by its own batteries (e.g., rechargeable). Vertical and rotary (around a horizontal axis) motion of the tool and cap within the station may also be used. After the cleaning step of FIG. 17(e), chopper 580 is normally replaced in tool storage area 584 and cap 578 replaced in the location from which it was obtained. In some embodiments, cleaning station 592 is as close as possible to vessel(s) in which tools are used, so as to minimize the risk of ingredients dripping or falling from tools or cap while moving from vessel to cleaning station.

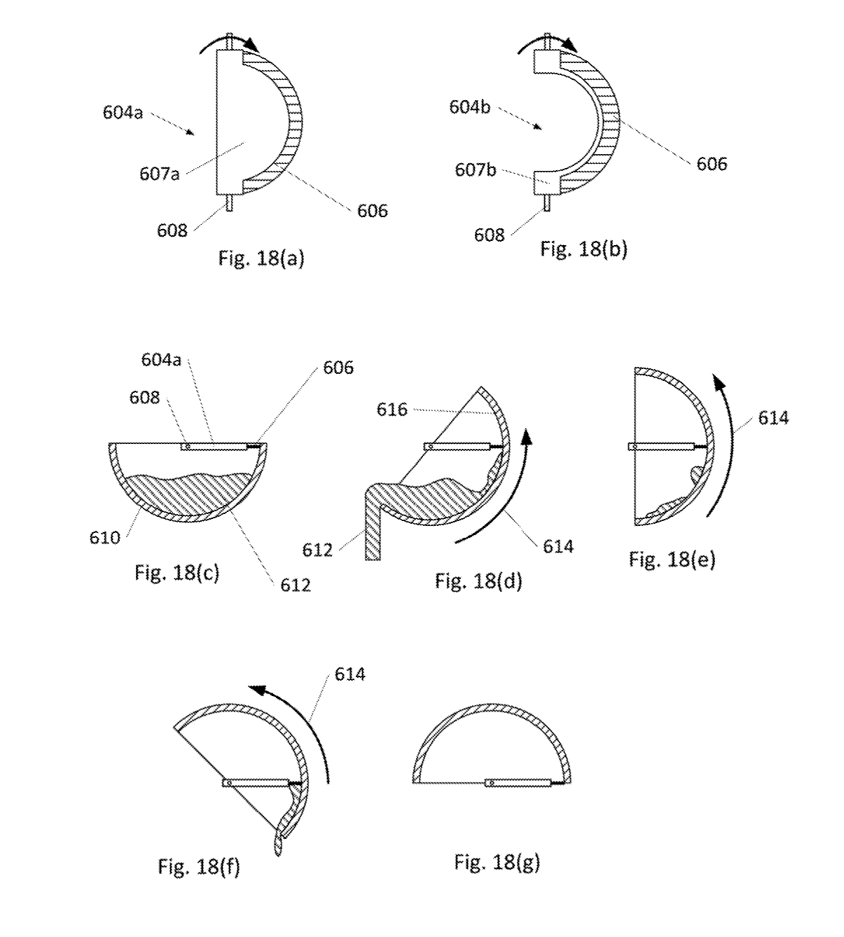

Cooking, mixing and blending of ingredients, and a variety of other operations may be carried out in vessels of various kinds and shapes. The bases and liners of FIGS. 10-13 can be used for other operations than heating or cooling food, such as mixing ingredients within a disposable liner. Whether or not vessels include liners, it can be challenging to remove all the ingredients within simply by tilting or inverting the vessel, due to the tendency for many ingredients (particularly if moist/wet) to cling to the vessel's inner surface. This leads to ingredient waste, the possibility of incorrect recipes due to ingredients remaining behind in the vessel, increased difficulty in cleaning the vessel (if unlined), etc. Therefore it is useful to employ efficient methods for removing all ingredients from a vessel. In some embodiments the vessel can be struck (e.g., with a soft mallet or equivalent), vibrated, spun, or otherwise moved with the goal of dislodging ingredients from the surface. In some embodiments, a fluid jet (e.g., air) can be used to push ingredients out of the vessel. In some embodiments, an approach in which the vessel interior surface is mechanically wiped (e.g., a self-emptying bowl) may also be used. This approach is illustrated in FIGS. 18(a)-(g). FIGS. 18(a)-(b) depict plan views of paddles 604a and 604b, respectively, suitable for a vessel shaped internally according to a section of a sphere (e.g., a spherical cap, a hemisphere as shown in the cross-sectional elevation views of FIGS. 18(c)-(g)). Paddle 604a has a “D”-shaped body 607a, while paddle 604b has a “U”-shaped body 607b; other shapes are also possible. The “U” shape allows ingredients to be processed (e.g., stirred) within the vessel while paddle 604b is within the vessel, however, body 607a should be wide enough to prevent ingredients from “hopping” or sloshing over it during vessel cleaning. Paddles 604a and 604b may be equipped with an elastomer edge 606, and provided in some embodiments with a shaft 608 (or a hole) allowing the vessel to pivot about an axis coincident with shaft 608 or the hole.

FIGS. 18(c)-(h) depict steps in a sequence in which a vessel 610 is used to hold ingredients 612, and ingredients 612 are then efficiently transferred elsewhere by a process of emptying and scraping. Vessel 610 may contain a liner, not shown, and if it does, complete transfer of ingredients 612 may be less critical. Paddle 604a has been integrated with a hemispherical vessel in FIGS. 18(c)-(h) or may be a separate element allowing paddle 604a to be used with multiple vessels; however, vessel 610 can pivot around shaft 608. In all the steps, paddle 604a remains in its original (in this case, horizontal) position, while vessel 610 rotates around it.

In FIG. 18(c), vessel 610 is upright, filled with ingredients 612, while in FIG. 18(d), vessel 610 has started to rotate in the direction of arrow 614, such that ingredients 612 are pouring and/or tumbling out. At this step, edge 606 of paddle 604a, in contact or near-contact with the inside surface 616 of vessel 610, prevents ingredients adhering to the inner surface from rising along with rotating vessel 610, instead keeping them at or below paddle 604a through a squeegee-like action. In FIGS. 18(e)-(f), most of ingredients 612 have left the vessel however paddle 604a continues to function. Finally, in FIG. 18(g), vessel 612 has reached a position in which all ingredients 612 have been transferred out of the vessel, and vessel 612 can be cleaned if desired. Since vessel 612 is internally hemispherical, a full rotation of 180 degrees between FIGS. 18(c) and (g) may be used to achieve complete emptying and scraping, whereas for a vessel representing a smaller portion of a sphere, a smaller rotation angle may be used. The axis of rotation may not be at the center of the sphere for a vessel interior spherically shaped, and may be located elsewhere. Rotationally symmetric shapes other than spherical may be used for vessels, such as ellipsoidal and cylindrical. If it is impractical to rotate the vessel or rotate it as much (e.g., if it is connected to the system through wires or vacuum lines, or for other reasons, the paddle can be rotated. For example, the vessel may rotate counterclockwise to the position shown in FIG. 18(d), and the paddle can rotate clockwise to push the remaining ingredients out while the vessel remains in this orientation. In some embodiments two paddles (e.g., shaped like paddle 604b) can be provided on opposite sides of a vessel; these can be used to push ingredients toward the center of the vessel as needed (e.g., during a cooking and/or mixing/stirring process).

### First System

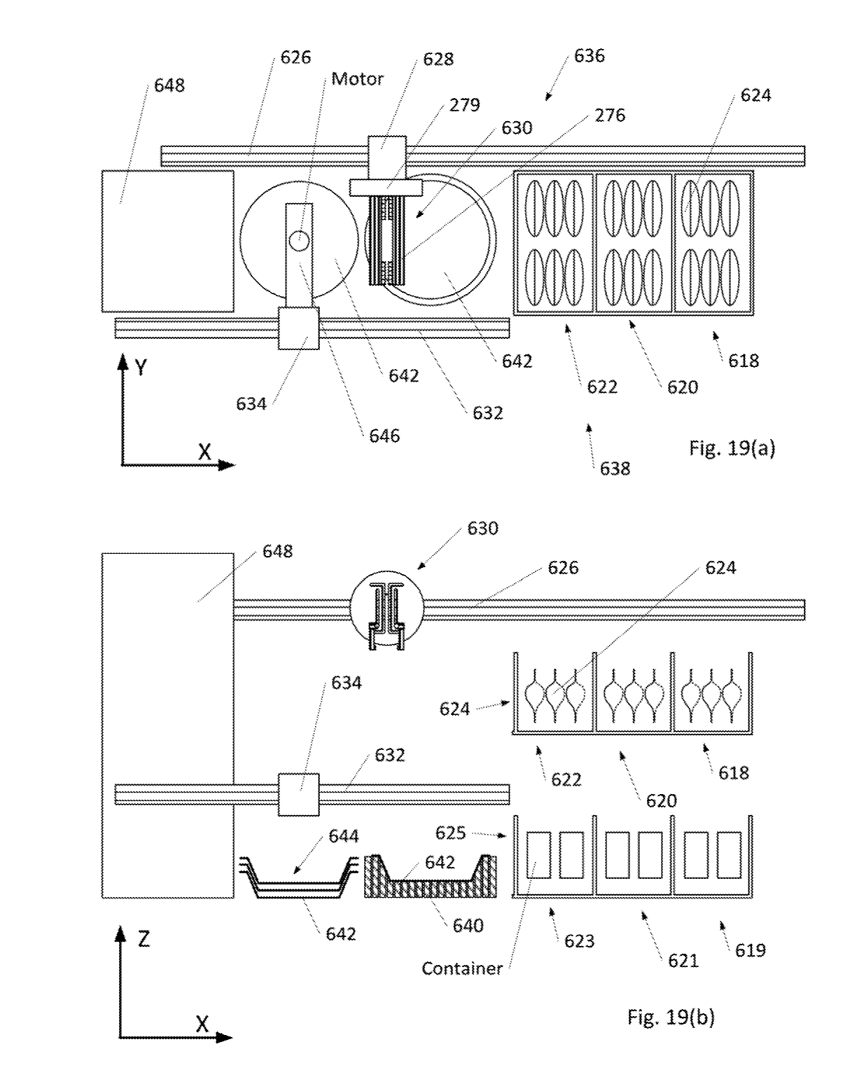

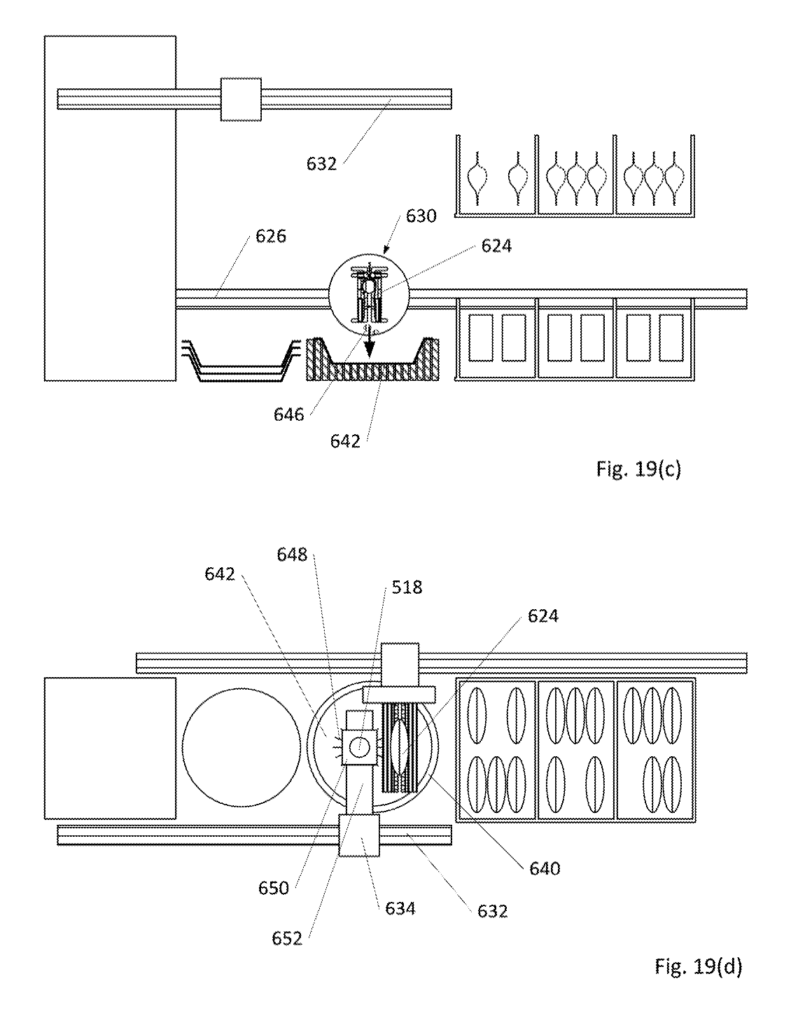

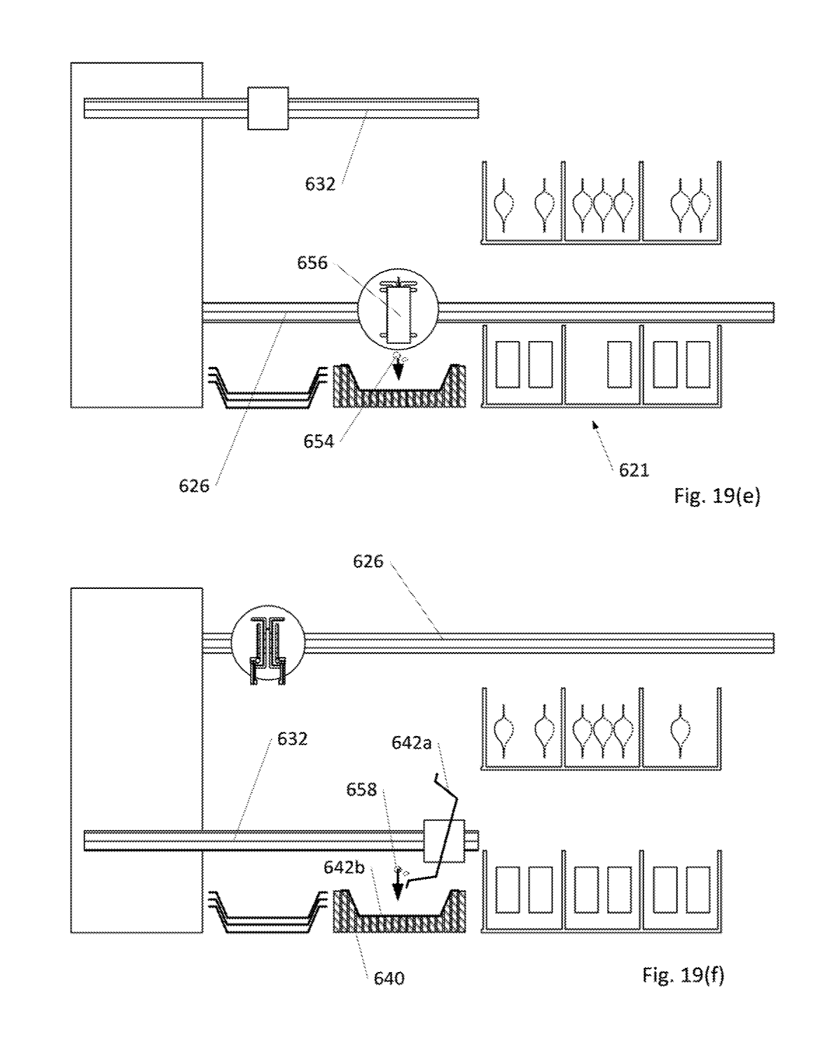

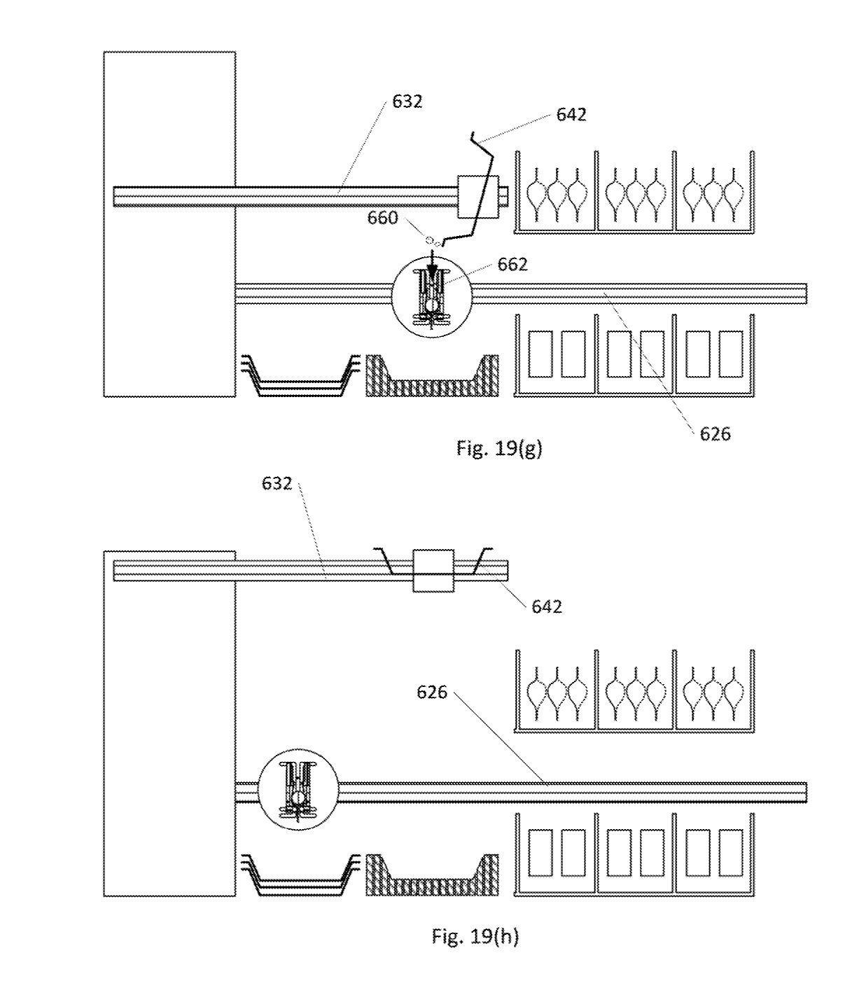

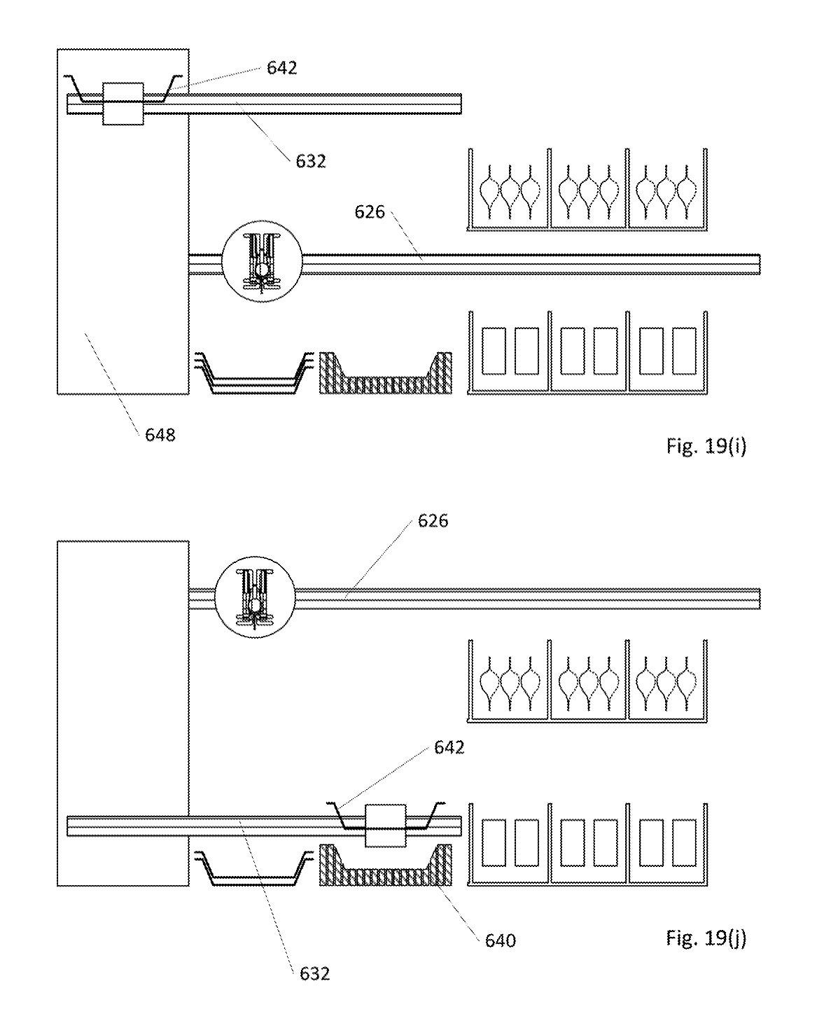

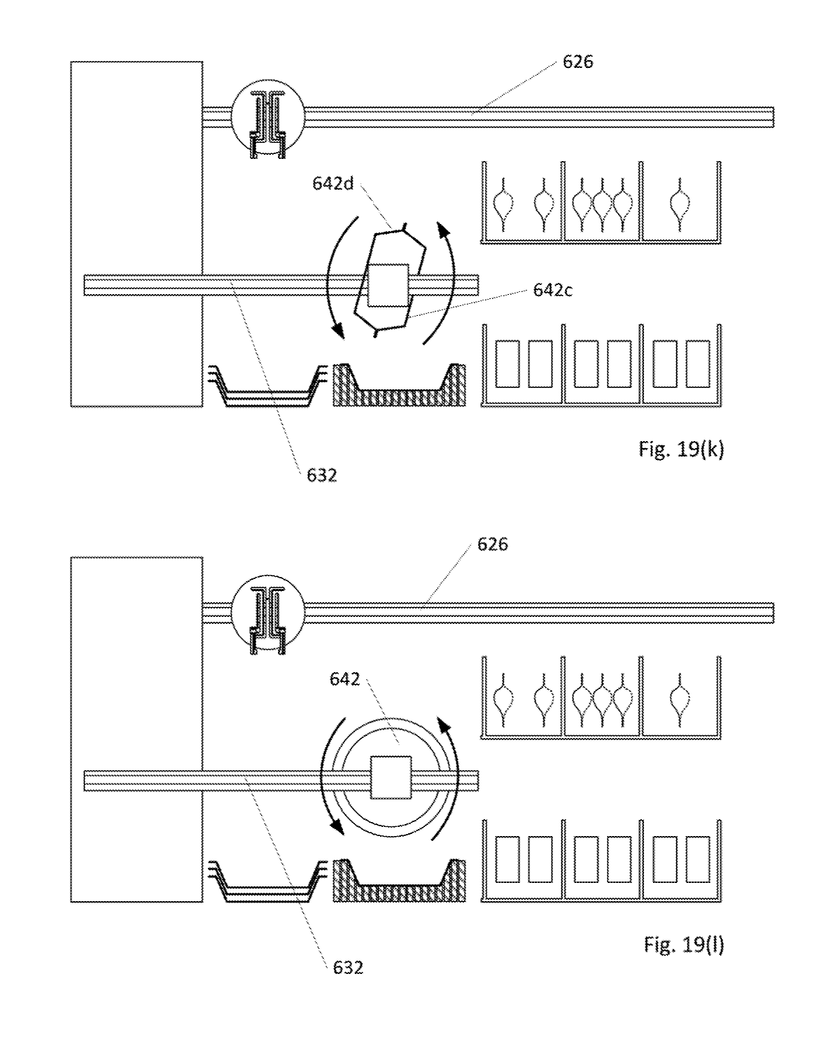

FIG. 19 depicts a “first system” used in some embodiments for automated food preparation. FIG. 19(a) is a plan view of the system, while FIG. 19(b) is an elevation view of the system.

The system may comprise any or all of the following elements in some embodiments:

1) Storage chambers (e.g., frozen 618, refrigerated 620, and room temperature 622) for pouches 624, which may be insulated. These may normally be for ingredients which are recipe-specific or which can be more general-purpose. These may be located toward the top of the system for maximum accessibility. These may have rails 218 on which pouches can be suspended from supports 216 or tabs 222, or may be in the form of cubbies, rotating wheels, shelves, drawers, etc.

2) Storage areas (e.g., frozen 619, refrigerated 621, and room temperature 623) for containers 625 (syringes, tubes, capsules, boxes, etc.) which may be insulated. These may normally be for ingredients which are more general- purpose and with extended shelf lives, or which can be recipe-specific. These may be located below the pouch storage areas as they may be less often accessed.

3) A first transport comprising X stage 626 as well as Y and Z stages, and carriage 628 able to move along the X, Y, and Z axes and equipped with pouch manipulator 630 such as that of FIGS. 4-6 comprising grippers 276, and disk 279. The stages are shown at the rear of the system 636, where they can be secured to the machine frame.

4) A second transport comprising X stage 632 as well as Y and Z stages, and carriage 634 able to move along the X, Y, and Z axes and rotate (e.g., around the Z axis) and equipped with end effectors (e.g., vacuum pickup) able to grasp liners and couple to caps and tools, as well as drive tools, e.g., through a motor. The stages are shown at the front of the system 638, where they can be secured to the frame. The second transport may be shorter along X than the first transport as shown in some embodiments.

5) A container manipulator—adjacent to or combined with the pouch manipulator (not shown, but in some embodiments comprising a mechanical interface such a gripper, magnets, or electromagnets). In some embodiments this may interface with containers such as shown in FIG. 9, and may be equipped with grippers or another interface to the containers. It may be rotatable in some embodiments.

6) One or more vessels comprising heated and/or cooled bases 640 and liners 642. However, some machines may not use liners and bases, and instead use reusable, cleanable vessels. More complex machines can have multiple vessels (e.g., arranged along Y axis) and/or dishes (plates, bowls, etc.), serving dishes and platters, etc.

7) A supply 644 (e.g., a stack) of vessel liners 642.

8) A liner manipulator 646 able to pick up liners from stack 644.

9) A convection oven, broiler, microwave and/or RF oven 648, and/or other cooking chamber (stacked vertically as shown or arranged otherwise).

Storage areas may in some embodiments be arranged along another axis than shown, or may be located underneath or above the vessels and liners, etc. In some embodiments pouches and containers may share storage areas. In some embodiments the system has a low aspect ratio (height: width) as shown in FIG. 19, while in other embodiments the system may have a high aspect ratio (e.g., similar to a vending machine or refrigerator). Each transport (e.g., gantry style, comprising an X-axis stage, two Z-axis stages (one at either end), and a Y-axis stage) is secured to either front or back of machine frame or housing, allowing each to move independently. However, since the payloads of each transport can overlap in space, the system controller should employ algorithms to ensure there is also no overlap in time to avoid collisions. In some embodiments other (e.g., non-Cartesian) transports may be used, such as cylindrical, spherical/polar, articulated (with rotary joints), or SCARA.

A number of components—many of them conventional—may be included in the system in some embodiments and are not shown in FIG. 19 such as: a controller and other electronics; Z-axis stages comprising portions of the gantry for the first and second transport stages; motors and actuators as needed to produce the required motions; temperature-controlled defrosting tank; sous vide cooking tank; vessel caps; tools and tool storage area; cleaning station(s); pumps such as cleaning solution and vacuum pumps; pouch manipulator rollers; other food preparation stations such as a grill (with possible smoke collector), a chopping/cutting station, etc.; other modules used for various food preparation processes; frame and panels. All motions and operations described as follows are implemented by the controller, based on following a program (e.g., including a recipe in suitable form and appropriate algorithms), and may involve directing the motion of various actuators, receiving and processing the input of various sensors, tracking time via a clock, etc. The elevation view of FIG. 19(c) depicts the system in the process of dispensing ingredient(s) 646 from pouch 624 into a vessel comprising liner 642. To accomplish this, the first transport X stage 626 moves pouch manipulator 630 over the appropriate pouch 624 in pouch storage area 622 (in this case), grasps pouch 624, transports it over the vessel, and opens it (possibly inverting it as well). Rollers on pouch manipulator 630 can be used to expel the ingredient(s). In the plan view of FIG. 19(d), pouch 624 is delivering ingredient(s) into the vessel, and simultaneously a tool such as the whisk/whip tool 648 of FIG. 16(h)—which has already been coupled to the second transport Y axis carriage 650 carried on second transport Y stage 652—is located over liner 642 and is actuated with motor 518 so as to process the ingredient(s) in liner 642 held in base 640.

FIGS. 19(e)-(l) depict elevation views of the system engaged in different processes. In FIG. 19(e), the system is in the process of dispensing ingredient(s) 654 from container 656 into liner 642. To accomplish this, first transport X stage 626 moves container manipulator 656 over the appropriate container 656 in container storage area 621 (this requires Z-axis motion given that these storage areas are below the pouch storage areas in the example shown), grasps container 656, transports it over liner 642, inverts it if required, and dispenses from it. Dispensing may involve vibrating or rotating it or components thereof (e.g., to dispense salt and ground pepper, spices, and milled flour through small openings), grinding or otherwise subdividing it (e.g., for peppercorns or nuts), compressing it to squeeze out ingredients (e.g., oil, milk) through a hole or nozzle, etc.

In FIG. 19(f), the second transport (with X stage 632) has lifted liner 642a out of a base similar to base 640 (e.g., the liner may extend past the base and be lifted by a ring, for example) and is shown transferring (e.g., pouring) ingredient(s) 658 from liner 642a (or another container) into liner 642b beneath it. This involves securely grasping or coupling to liner 642a—in a way that does not contact the ingredient(s) within—and rotating liner 642a.

In FIG. 19(g), liner 642 (or other container) is also rotated, however in this process liner 642 has been moved by the second transport so it is above pouch 662, and ingredients 660 are being transferred from liner 642 into pouch 662 (the system can include a supply of empty pouches). In some embodiments one pouch may transfer its contents into another pouch similarly. While pouch 662 is held open (e.g., by vacuum grippers) while it is loaded, in some embodiments, a liner or other container may be placed under the pouch to catch any ingredient which misses pouch 662. The pouch manipulator grippers may include impulse heaters and in some cases, vacuum sealing apparatus known to the art, such that when pouch 662 is filled (e.g., by the system as in FIG. 19(g), or manually by the operator), the pouch can be sealed within the machine. This allows for longer-term storage and facilitates in-pouch manipulations such as tumbling, tossing, crushing, sous-vide cooking, etc. While pouches which are filled outside the system may use a code (e.g., a QR code, bar code, NFC code, RFID code) for identification, this may be less useful for pouches filled internal to and by the system, since the system can track the contents and location of such pouches.

FIG. 19(h) depicts the second transport stage of the system supporting liner 642 (or dish) toward the top of the system or in an alternate position which allows the user of the system to access liner 642 to remove a prepared meal from the system so it can be served and consumed. FIG. 19(i) depicts liner 642 being delivered into chamber 648 or another subsystem by the second transport. Each subsystem can be accessed at different heights of the transport, if they are stacked vertically, and in some embodiments there may be multiple subsystems at a single height, arranged side-by-side. FIG. 19(j) shows the second transport stage, which has removed liner 642 from stack 644 (e.g., using a vacuum pickup) preparing to place liner 642 into base 640.

FIGS. 19(k) depicts lower liner 642c and upper liner 642d which are held or joined together and are being rotated around an axis perpendicular to the symmetry axis of the liners as in FIG. 12(g), while FIG. 19(l) shows liners 642c and 642d being rotated as in FIG. 12(f): around the symmetry axis of the liners. Not shown are rings such as 434 or other apparatus provided to hold liners together in some embodiments.

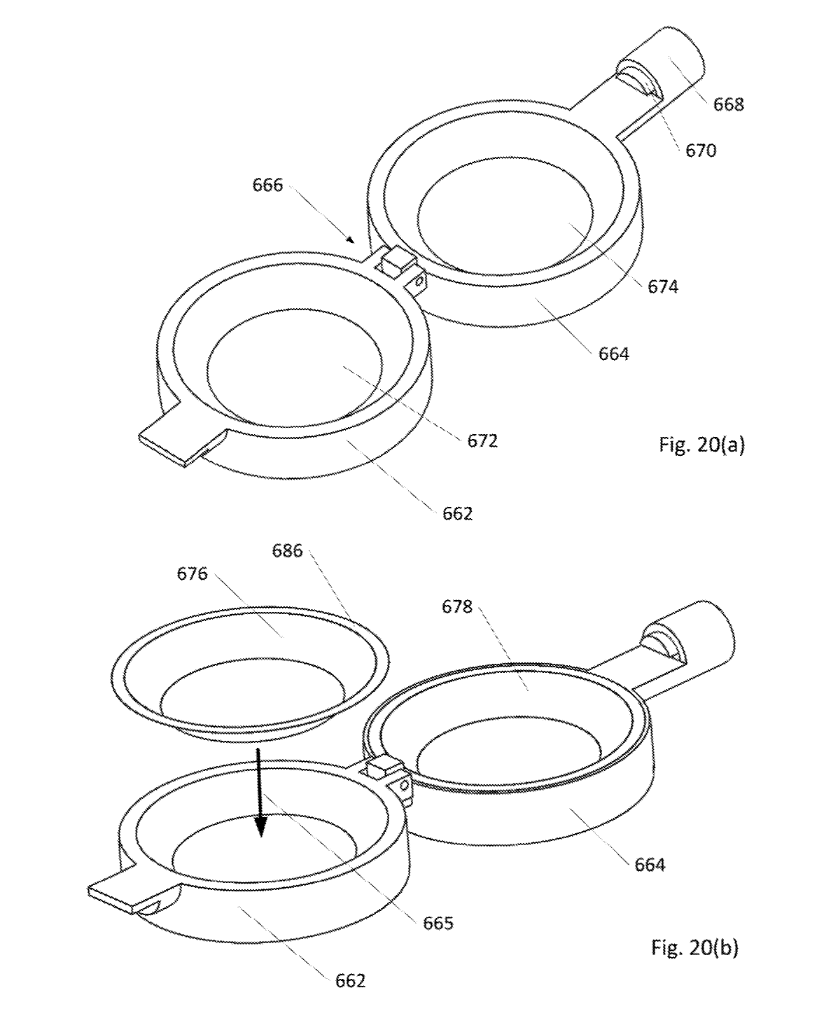

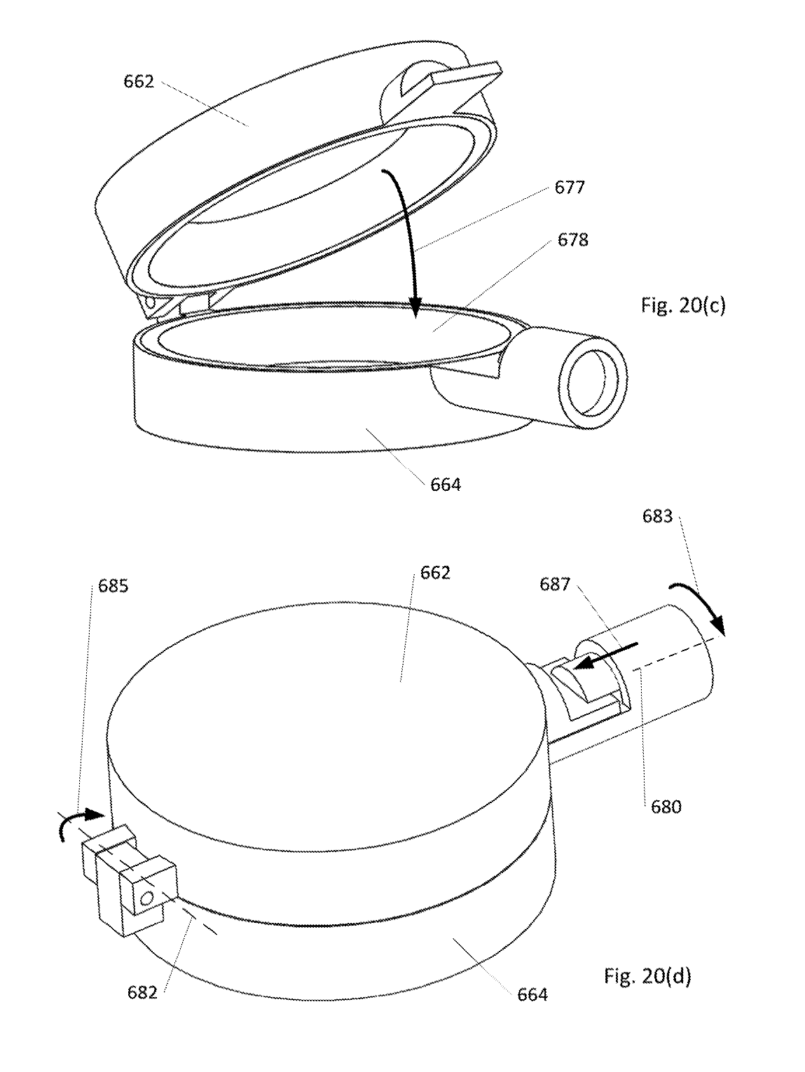

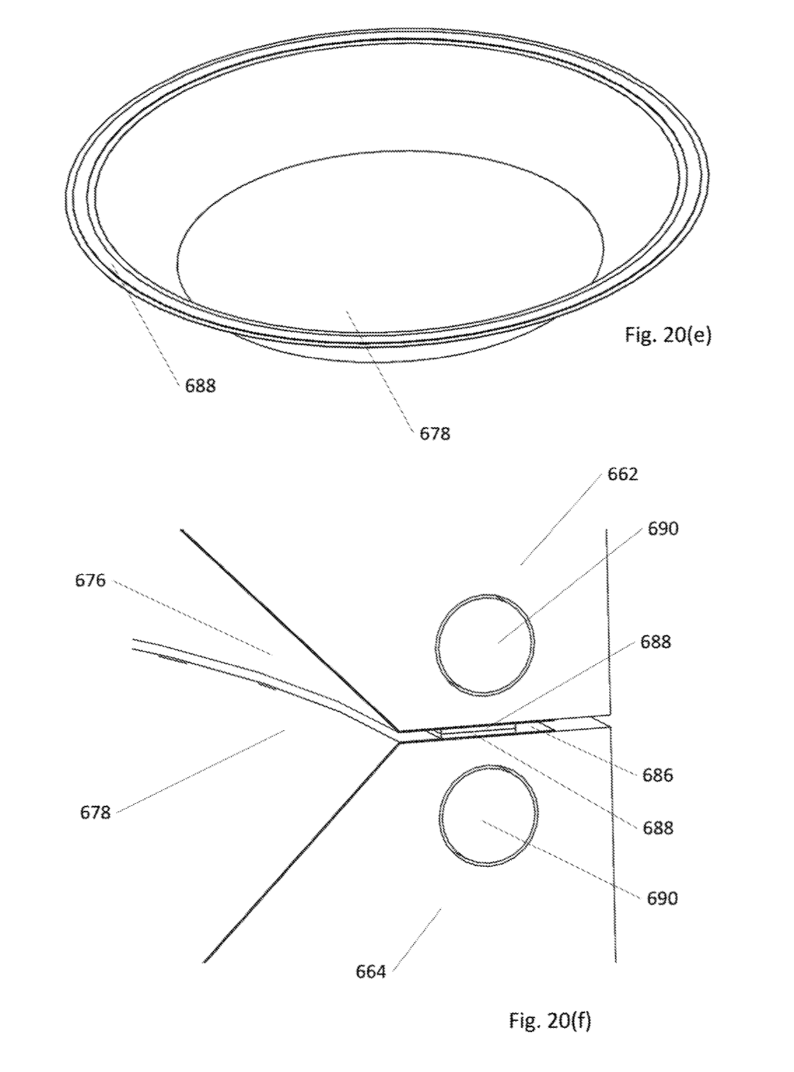

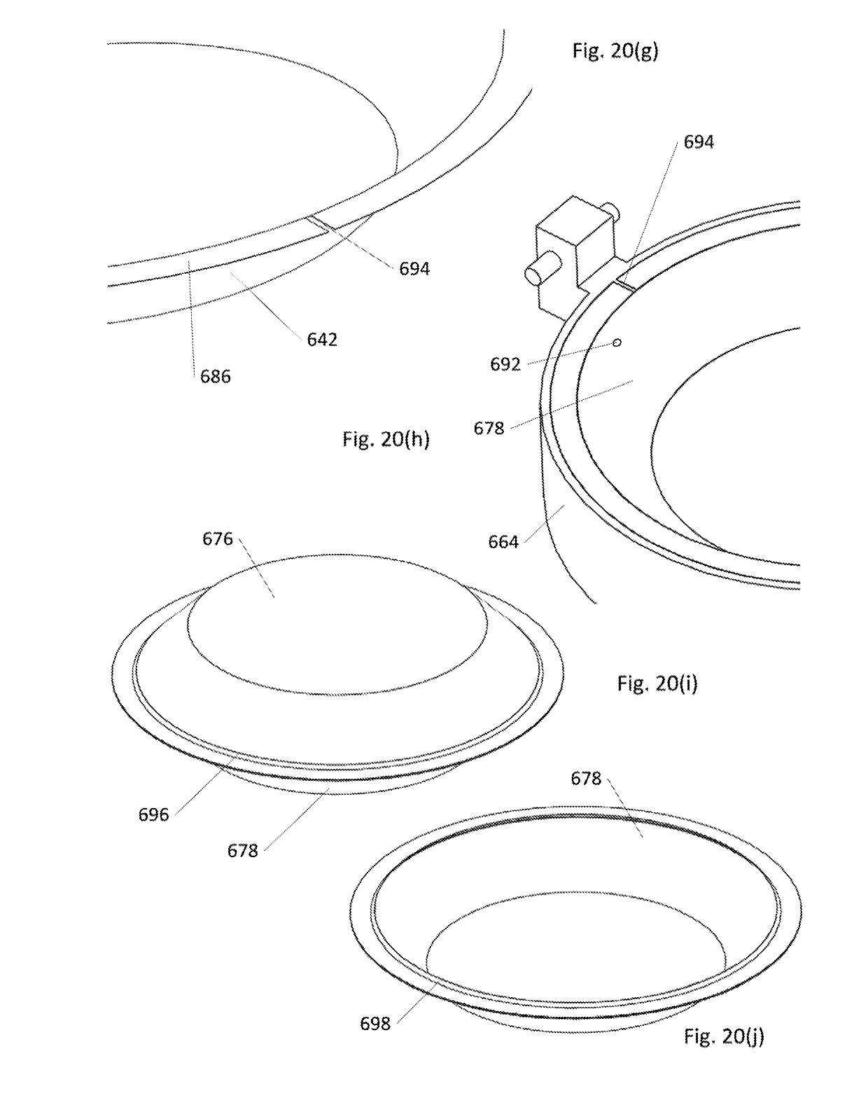

FIGS. 20(a)-(f) shows 3D and 3D cross-sectional views of a system (or subsystem, e.g., a subsystem of the First System described above) of bases and, in some embodiments, liners allowing for ingredients to be tumbled, tossed, mixed, stirred, etc. as part of a food preparation process (e.g., to achieve uniform cooking while inside a heated vessel equipped with a vessel-like lid). In some embodiments the system comprises liners which are vented to allow the escape of steam or other products produced during cooking. In some embodiments the subsystem comprises liners which can be sealed to one another. In some embodiments at least some liners are scored or otherwise made easy to open, allowing access to prepared food within.

In FIG. 20(a), a “clamshell”-like arrangement of vessels (assuming each comprises a base and liner) is shown, in which upper base 662 and lower base 664 of similar shape are attached to one another through hinge 666, and motorized shaft 668 attached to one base (lower base 664 as shown) capable of rotating bases 662 and 664 is also provided, along with sliding latch 670 or other mechanism to keep the clamshell closed while rotating. In other embodiments, the vessels may separate while remaining in their normal orientations (vs. having one rotate, which facilitates the introduction of liners and ingredients. As depicted, bases 662 and 664 are thick enough to incorporate heaters (or cooling channels) within them. If rotation is to be continuous in one direction for multiple turns, and if electric (e.g., resistive) heaters are used, then current can be provided to lower base 664 through conventional slip rings (not shown) or similar, and flexible wiring/cable (allowing upper base 662 to open and close) can be used to connect upper base 662 with the rotating lower base 664. If oscillatory/reciprocating rotation is used, then cabling from a non-rotating portion of the system (e.g., arranged in a helical coil whose axis is approximately parallel to the rotation axis) can be connected to lower base 664, and if desired, similar cabling can also be connected to the upper base 662. Bases 662 and 664 may also be heated or cooled using circulating fluids of suitable temperature.

If liners are used, they may be loaded into recesses 672 and 674 in bases 662 and 664, respectively (e.g., by a vacuum pickup attached to a transport such as the second transport of FIG. 19) in FIG. 20(b) while upper base 662 is pivoted so it is no longer blocking access to lower base 664. When both bases are oriented similarly as in FIG. 20(b), insertion of liners can be facilitated. Upper liner 676 is not necessarily the same size or shape as lower liner 678. At least one base may incorporate one or more vacuum ports/channels; if so, then its liner can be drawn against recess 672 or 674, allowing for efficient heat transfer to/from the ingredients if the base is heated/cooled. The vacuum can also serve to retain the liner (e.g., upper liner 676 while upper base 662 rotates away from an orientation such as that of FIGS. 20(a)-(b) in which the liner is retained by gravity. Standard vacuum connections (e.g., tubing, channels within the hinge), as well as electrical cabling and possible cooling/heating fluid channels, are not shown in the figures.

FIG. 20(a)-(d) depict initial steps in a covered cooking (e.g., frying, braising, boiling) process according to some embodiments. In FIG. 20(a), the “clamshell” has been opened (e.g., using a suitable actuator) to receive both liners 676 and 678 and ingredients. In FIG. 20(b), upper liner 676 and lower liner 678 (which may be identical or different) are being inserted as shown by arrow 665 into upper base 662 and lower base 664, respectively. As a next step (not shown), ingredients are added to lower liner 678 and vacuum is applied (at least to upper liner 676). Following that, an actuator rotates upper base 662 with liner 676 as shown by arrow 677 in FIG. 20(c) until it is inverted over lower base 664 and is latched in that position (FIG. 20(d)) by sliding latch 670 as shown by arrow 687, or other mechanism. The two bases/liners may then be tumbled/spun around axis 680 shown in FIG. 20(d) in the direction of arrow 683 or an alternative tumbling axis such as axis 682 in the direction of arrow 685 (e.g., in which case the shaft might be rotated 90 degrees from the orientation shown, so that it is parallel to the pivot axis of hinge 666), or another axis (e.g., parallel to and offset from the axes shown). Other motions are possible such as shaking.

As ingredients tumble within the two surfaces of the liners, they are randomly re-oriented and contact one another, the liner surfaces (presumed to be heated in this example) and/or any liquid within, heating them uniformly while mixing them (e.g., coating pieces of chicken with a sauce). It may be desirable—especially for ingredients which comprise liquids—that while the two vessels (i.e., bases and liners) are rotating, that there is little or no leaking of ingredients between the two liners. If the liners are designed with rim 686 such as that shown in FIG. 20(b) and the surfaces of the bases are suitably designed (e.g., flat, or with corresponding protrusions and recesses), and the liners are smooth and/or soft (e.g., aluminum foil, or with a compliant coating (e.g., on the mating surfaces, or elsewhere on the liner) such as an elastic polymer (e.g., silicone rubber)), then in some embodiments the clamping pressure of the two bases when latched is sufficient to prevent leakage. To obtain better sealing based on clamping pressure alone, there may be a protrusion on upper base 662 that fits within lower base 664, forcing the liners to bend around it and increasing the local pressure.

In other embodiments, crimping of one liner with respect to the other (e.g., as in FIG. 11) may be used to seal liners to each other (the lids discussed in that figure are effectively a type of liner). In other embodiments, a heat seal or pressure-sensitive adhesive material may be used on the mating surfaces of the upper and lower liners to form a seal. FIG. 20(e) depicts a liner 678 with seal material in the form of a ring 688 on the mating surface of the liner (e.g., rim 686). In the cross-sectional 3D view of FIG. 20(f), upper and lower liners 676 and 678 are pressed together between upper and lower bases 662 and 664, with seal rings 668 in contact. In some embodiments, only one liner has seal ring 668, while in other embodiments, both have it as shown (facilitating use of identical liners for both upper and lower base, and possibly reducing leakage).

If the seal ring is a heat seal material such as a foil heat seal (e.g., from All Foils, Strongsville, Ohio) that can be coated onto a foil and which then can soften to form a seal, then the required heating can be provided several ways. In some embodiments the heating of the base(s) by itself, if used to cook ingredients within, can seal the liners to one another. In such embodiments, a delay sufficient to allowing sealing may be implemented after the clamshell closes and before rotation begins, to avoid leakage. The heating may be adequate to seal the liners quickly to one another and not sufficiently intense (e.g., at a high enough temperature) to degrade the heat seal material. In other embodiments, the bases may be designed (e.g., with thin sections in the vicinity of the seals and/or low thermal conductivity materials) to isolate the seals from the normal heating of the base (this is especially useful if the sealing is to be a final step, after multiple openings of the clamshell to allow other ingredients to be added), and local heaters 690 are specifically provided to seal the liners together. FIG. 20(f) shows such heaters in the form of toroidal resistive heaters adjacent to the seals; not shown is the multi-material structure of the base (e.g., aluminum and steel or ceramic) used in some embodiments that can help isolate the seal area from heat sources closer to the center of the liners. In the case of a pressure-sensitive seal material, there may be a coating which can be removed before the two liners are brought together.

In some embodiments, two lined vessels which form a completely closed volume may be used for pressure cooking of ingredients at an elevated temperature; in such cases, rotation my not be required and may be used if desired. Pressure can be regulated for example by flap-like self-closing (elastically deformed) valves or weighted valves that are incorporated into the liner, or by more conventional pressure regulators, and pressure can be measured by measuring the bulging of the liner into a recess or hole provided in the base. Once cooking has completed, turning off the heat source will allow a slow release of pressure, while quick release can be implemented for example by piercing the liner (and ideally diverting steam through where it can be harmlessly dissipated), peeling apart the liners where they are sealed, or if the seal is based entirely on pressure provided by the clamshell itself, by slightly and slowly opening the clamshell in a controlled fashion.

In many cases, however, it is not desirable to have a completely sealed volume, and some venting is desired to allow the escape of steam, etc.; this can be provided by a venting feature. In some embodiments, a gap in seal ring 688 (if used) can provide a small aperture, as can hole 692 near the axis of rotation (FIG. 20(h)) which communicates with a groove in or passage through the base. In some embodiments, a notch 694 (FIGS. 20(g)-(h)) or indented/embossed area is provided in liner 642, and in some embodiments the base may also be notched to provide a larger aperture. Both upper and lower liners, or just one, can have venting features. Venting features may be located near the axis of rotation such that if the level of ingredients (or at least, flowable ingredients) is below the venting feature for all orientations of the rotating vessels, ingredients will not leak out; however, exact positioning of venting features may not be needed. To help orient liners so as to correctly position venting features, liner shapes may be not entirely rotationally symmetric as shown. More than one venting feature can be provided (e.g., two features diametrically opposite one another near the axis of rotation).

FIG. 20(i) depicts upper liner 676 and lower liner 678 in which ingredients have been processed. With liner 676 still coupled to liner 678, food can be kept hot (or cold) for extended periods, and some liners may incorporate insulating layers, or may be placed into insulating packages. Assuming the contents are ready to be consumed, the liners can be separated. If crimped as in FIG. 11(e), or if simply pressed together, this can be easily done by the consumer. Similarly, if the seal material is designed to be peelable, the liners can be separated by peeling. In some embodiments, the seal is robust, and to access the food within, the liner itself might need to be breached. While a thin (e.g., foil) liner can be cut or torn open, in some embodiments a peel-off strip or drawstring may be used, or the liner may be scored as shown in FIG. 20(i) such that it can be easily broken or torn along score line 696 (e.g., circumferential to allow most of the upper liner to be removed, leaving only a residual portion 698 behind). If all liners are so scored or equipped with peel-off strips, then only one type need be included in the system.

It may be desired to cook some ingredients while tumbling using apparatus such as that shown in FIGS. 20(a)-(d), add more ingredients, and then resume cooking and tumbling. In such cases, the clamshell can be opened at least partially to allow ingredients to be added. This may be done after rapidly decelerating the vessels (i.e., bases and liners) so as to dislodge any ingredients from the upper vessel into the lower vessel, such that nothing drops down or drips from the upper vessel when it is opened. To minimize such a risk, the upper vessel and/or its liner can have a smaller interior (e.g., smaller diameter) than the lower vessel and/or its liner, so that liquid running down the former's inner surface (e.g., and crossing the edge where the rim meets the concave portion) is likely to fall into the lower vessel when the vessel is opened by a small angle (e.g., 45 degrees). A ridge incorporated into the upper vessel (e.g., in the liner) can achieve a similar effect. In some embodiments, liners which are shaped similar to the letter “D” or have other shapes with at least one straight side (e.g. rectangular) may be used, and the upper and lower liners can be connected along the straight side, near the hinge. When the upper liner is lifted, falling/dripping ingredients will likely fall on the region where the liners are connected, rather than elsewhere where they might cause contamination.

### Second System

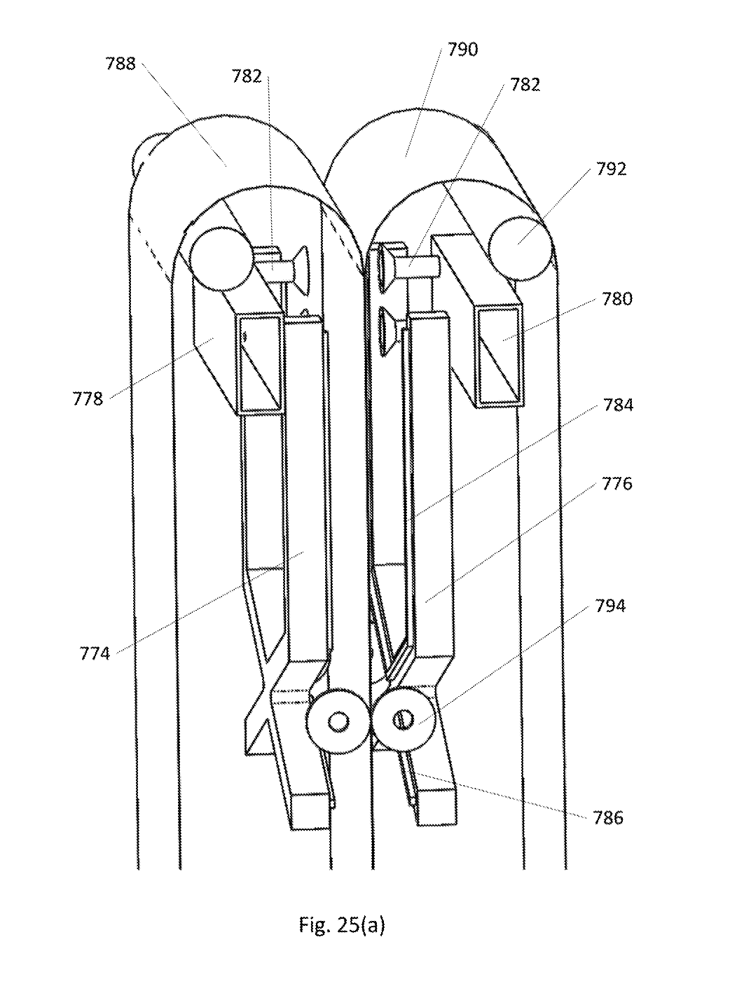

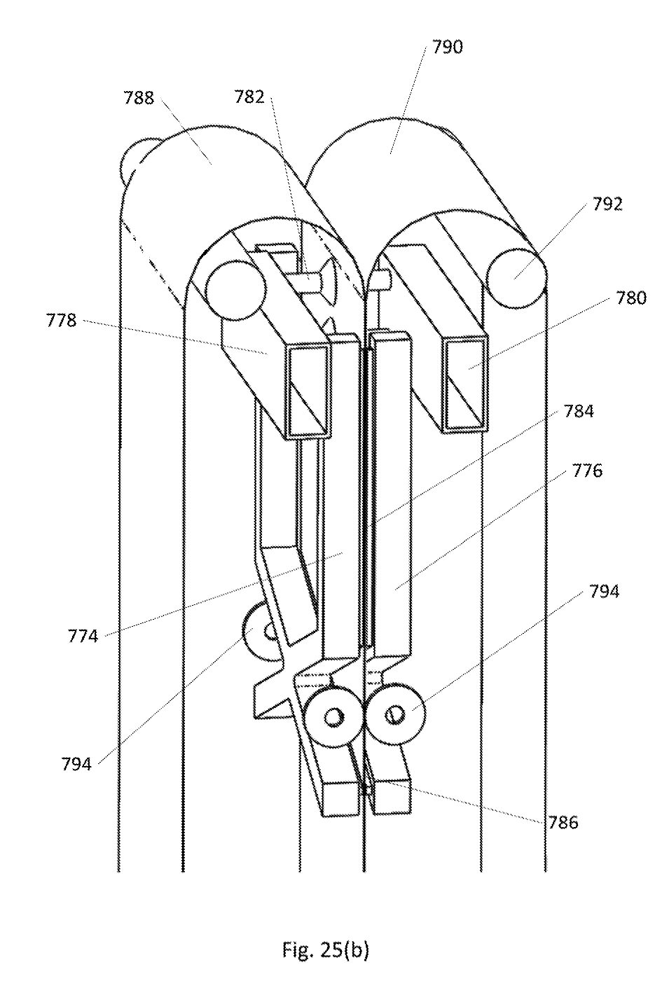

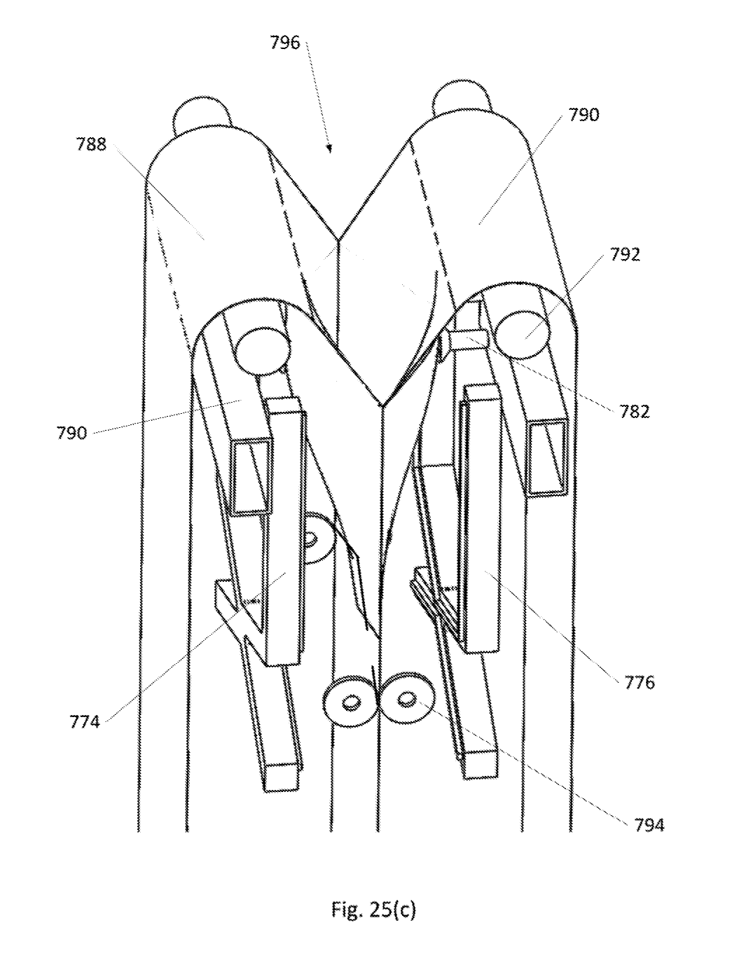

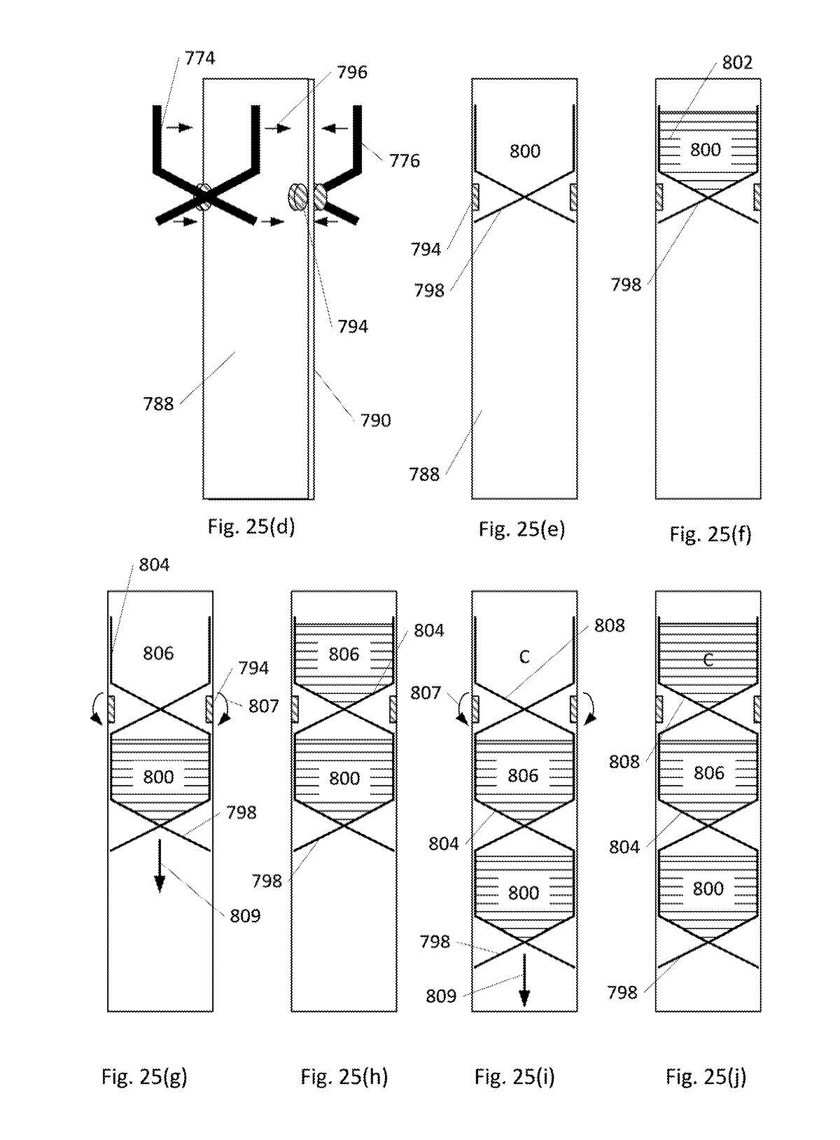

In some embodiments, the food preparation system comprises the ability to produce food products using a 3D printing (additive manufacturing) approach in which ingredients are deposited (e.g., in a layer-by-layer manner by extruding one or more ingredients from a nozzle) to build up the product. 2D printing (e.g., for cake decorating, spreading pizza sauce) on either a flat or curved surface is also a possibility. For example, given a multi-axis transport such as the first transport of FIG. 19, a printhead which can support and manipulate pouches (including loading and unloading pouches), and a pouch equipped with a suitable nozzle, the system can perform 3D printing of food products in their entirety, use 3D printing methods to produce portions of a food product, and/or facilitate certain food preparation processes which are normally performed by conventional methods (e.g., those requiring human labor). However, the specifics of embodiments related to FIG. 25 which follow are not necessarily limited to a system intended for 3D printing, and may apply more generally to automated food preparation.

An example of a food product that might be 3D printed using the methods and apparatus described herein is an energy bar (e.g., similar to a Larabar (Small Planet Foods, Minneapolis, Minnesota), with variation in bar size, bar ingredients, and bar ingredient ratios to provide personalization. However, the fabrication principles involved are applicable to a very wide range of food products.

Methods and apparatus described herein allow 3D printing of liquid/solids/paste as well as certain solid ingredients. This expands the range of possible food products, enables the use of ingredients closer to their natural states, provides a wider range of mouthfeels, etc. Moreover, solid ingredients, even if fairly finely divided, can provide a structural role, increasing the handling strength of printed foods, decreasing extrudate slump during printing (much like concrete includes both a flowable phase (cement and water) and a solid phase (aggregate)), allowing use of lower viscosity pastes, liquids, and gels which on their own are not readily printable. The use of solid ingredients also allows more diverse and appealing mouthfeels. However, the addition of solids can increase the risk of nozzle clogging, so the ability to unclog the nozzle becomes especially significant when implementing a reliable system.

In the case of energy bars, ingredients commonly include dates as both a sweetener and a binder. Date-based paste can be produced by using a conventional food processor to process dates with or without water; other ingredients may be blended in as well (e.g., protein powders, coconut flour, nut meal). It is possible to formulate pastes which either on their own or when mixed with solid ingredients will be viscous or thixotropic enough to resist slumping; slumping is undesirable since it can introduce inaccuracies in the fabricated product. Problems with nozzle clogging and fouling can be addressed by using pouches with built-in nozzles that are replaced whenever a new pouch is loaded into the printhead, and automated nozzle unclogging (e.g., with clogging detected by force sensing, and unclogging achieved by nozzle deformation).

Prior art problems with accurate and controlled ingredient delivery can be addressed through the use of a peristaltic ingredient pumping/metering approach that is closed-loop and may be based on mass measurement, such as weighing the pouch and its contents and/or the food product being formed during the printing process. Ingredient handling, packaging, and storage can be addressed by packaging ingredients in pouches, which have numerous advantages in ease of handling, transportation, storage, and minimizing food and packaging waste. Printer cleanliness, food safety, and intercontamination can be addressed through the use of sealed pouches not only as ingredient packages, but also as ingredient metering and delivery devices. As will be described, ingredients can be kept fresher for longer, and substantially all contact between food and printer can be avoided (e.g., with food touching only single-use materials).

Problems with system reliability can be addressed in large part merely by minimizing food/printer contact, as this reduces fouling/contamination/crusting of the printhead nozzle. Additionally, recovery from clogs, etc. can significantly boost reliability.

A pouch with an extendable nozzle suitable for 2D/3D printing is shown in FIG. 3. FIG. 21 shows a 3D view of pouch 700 having a different integrated nozzle designed to extrude a flowable ingredient such as a liquid or paste (e.g., fruit pastes, vegetable-based pastes (e.g., polenta), purees, gels, and doughs, fish and meat pastes). Pouch 700 in combination with other elements, serves as a liquid/paste extruder printhead. Pouch 700 may be used in other systems described herein and other pouches may be used in the second system in some embodiments. Pouch 700 may be tapered into a funnel shape 702 as shown at its bottom, forming nozzle 704 that is generally (though not necessarily) narrower than the pouch overall width. In some embodiments, below funnel 702 is a constant width region of the nozzle; this allows for less precise cutting that nonetheless provides a nozzle of the same width, and also allows for re-sealing and re-cutting the pouch. Permanent/strong seals 706 along the sides of the pouch (including the edges of funnel 702) define the interior funnel shape; the exterior shape of pouch 700 need not necessarily be tapered as shown (e.g., it can be rectangular). At the bottom of pouch 700 in some embodiments is permanent seal 708 (though in some embodiments this can be a temporary (e.g., peelable) seal); this can be cut off by cutting along cut line 710 above the seal. Above cut line 710 is temporary seal 712 which can be a zipper (e.g., a ZIPLOC®-type zipper (e.g., from ITW MaxiGrip); a weak heat or ultrasonic seal; a peelable seal; a seal that can be weakened/broken by external heating or radiation, by crushing through the pouch; etc. The purpose of temporary seal 712 is to prevent pouch ingredients from reaching the area of cut line 710 and potentially contaminating the cutter. If a zipper or peelable seal is used, pressurizing pouch 700 (e.g., by a roller used to expel the ingredients) can force open seal 712 (e.g., in normal use), whereas for seals which are weakened/broken by outside force, etc., this can be done to prepare the pouch for use. The space between seal 712 and seal 708 may be evacuated so that air isn't introduced into the ingredients as they enter the nozzle.

In some embodiments, pouches are stored inverted or at other orientations such that ingredients migrate away from cut line 710 and temporary seal 712 may not be needed. Or, if the contents are sufficiently viscous, then pressure (e.g. using an upwards-moving roller) can be applied from the outside to push ingredients away from cut line 710 before cutting.

At the top of the pouch are holes used in some embodiments to hang the pouch from pouch hangers in a storage area of the system and/or from the printhead. Holes may be in a reinforced region 715 of the pouch as shown. If the pouch is to be suspended both from hangers and within the printhead, then in some embodiments two separate sets of holes are provided as shown, e.g., outer holes 714 to receive printhead pins and inner holes 716 to receive hanger pins); this allows both sets of pins to support the pouch simultaneously, allowing the pouch to be reliably loaded from hanger onto the printhead or unloaded from printhead onto hanger without pins interfering with one another during the transfer operation.

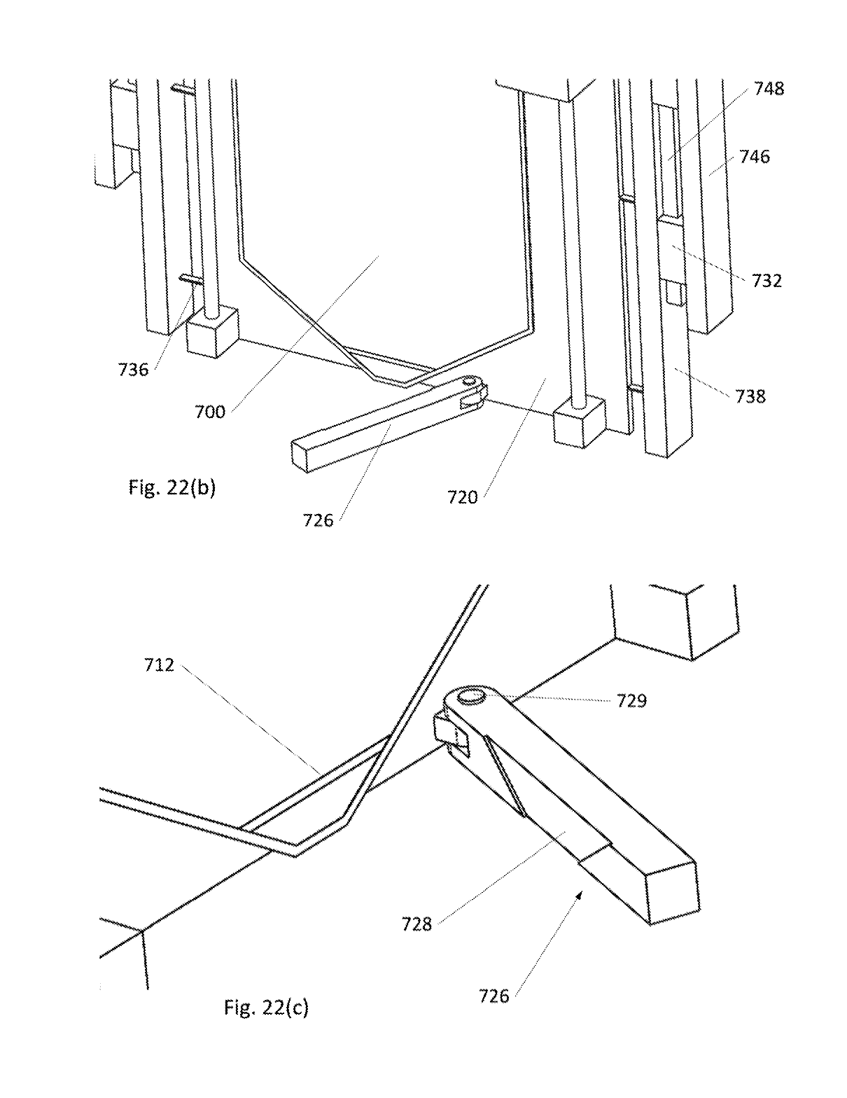

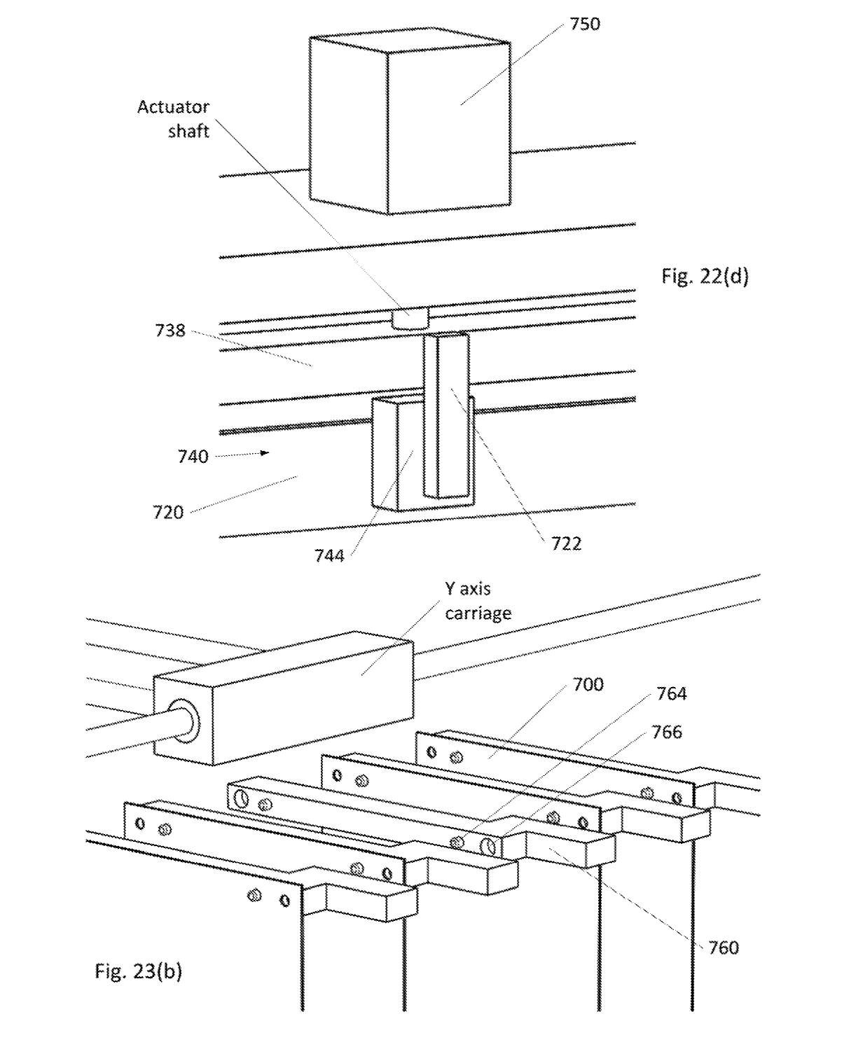

FIGS. 22(a)-(d) depict 3D views of printhead 718 comprising apparatus to dispense ingredients from pouch 700 when loaded into printhead 718 and to stabilize nozzle 704, apparatus to measure the weight of pouch 700 (to determine and control mass flow rate, amount remaining, etc.). Printhead 718 is a type of dispenser for a flexible package which may be used in conjunction with other systems than the second system in some embodiments and may not be moved in the same way if printing is not required. In FIG. 22(a), the various components of the printhead are depicted. Pouch 700 is suspended from plate 720 by pins 722 which may be retracted (e.g., with chamfered or radiused ends) so as to release the pouch when it is empty, and to allow roller 724 to pass. Pouch 700 may also be held against plate 720 by vacuum plumbed to the plate. A removable (e.g., hinged) nozzle casing 726 (detailed in FIGS. 22(b)-(c)) with hinge 729, along with plate 720, surrounds the pouch nozzle 704 to prevent it from moving excessively during printing, to give nozzle 704 a well-defined shape and determine its maximum opening size (recess 728 in the casing defines this), and to stabilize pouch 700 while it is cut open. In some embodiments casing 726 includes a sharp blade that cuts open pouch 700 along line 710 as casing 726 closes around the bottom of pouch 700.

In some embodiments, casing 726 can also serve to unclog nozzle 704 by either expanding or reducing the cross-sectional area of recess 728 (FIG. 22(c)). This may require that casing 726 be elastomeric at least in part, and require an actuator). If nozzle 704 is clogged by a hard particle that is not easy to crush, casing recess 728 may expand (e.g., while nozzle 704 is over a waste bin) so as to allow the particle to pass. If nozzle 704 is clogged by a crushable particle, recess 728 may contract so as to crush the particle and allow it to pass through the normal cross-sectional area of the nozzle. This capability can also be used to pinch off flow (e.g., while another printhead is depositing ingredients) in the case of a nozzle which is oozing. The shape of nozzle 704 may be established by the pressure of the extruded ingredient pushing the walls of the pouch against recess 728 and plate 720, or recess 728 and/or plate 720 may include vacuum ports/channels which draw the pouch walls against them. Recess 728 can be of different shapes (e.g., rectangular, round) and widths: a round recess requires a two-part casing (or shaped plate), e.g., with a semi-circular cavity on each side, and a round nozzle shape may be used for omnidirectional printing. The lower edges of nozzle 704 may extend below the bottom of casing 726 so the latter does not come into contact with ingredients. In some embodiments the nozzle region of the pouch may be made thicker (e.g., by laminating it to thicker material) to increase its stiffness, which can aid in stabilizing its position and assist cutting.

Roller 724 (e.g., hard rubber) supported on rotary bearings 725 is provided on printhead 718, though in some embodiments a squeegee or other element may be used instead. Roller 724 can move along two rods 730 to traverse pouch 700 from top to bottom (when extruding the ingredient through nozzle 704 while squeezing the pouch between the roller 724 and plate 720) or bottom to top (e.g., to allow the pouch 700 to be released from the printhead (e.g., for exchange), with linear bearings and rods near either end of the roller guiding the motion. The motion may be achieved in some embodiments with the apparatus shown, involving a motor and possible gearing 734 that rotates roller 724, causing it to roll on pouch 700. In some embodiments, especially when the roller might slip on the (possibly moist) pouch surface, or to achieve more force or higher resolution motion, motion may be achieved by actively translating the rod (e.g., replacing rods 730 with lead screws which are rotated by a motor, and providing nuts which move with the rod). In such embodiments roller 724 can then roll passively as it moves. Roller 724 can also be forced to rotate by use of a rack and pinion mechanism, etc. Roller 724 may be coupled to the motion system through strain gauges which allow the force applied to the roller while it advances to be measured; this can be used as a non-contact approach to measuring pressure within pouch 700 (e.g., verifying that seal 712 is broken, detecting clogs before they lead to possible pouch rupture). In some embodiments pouch internal pressure may also be determined by providing an aperture (e.g., round, with smooth edges, near the lower/nozzle end of the pouch) in a surface such as plate 720 through which pouch 700 can herniate, and measuring the distance by which it protrudes.

As shown, plate 720 is suspended from thin flexures 736 which allow it to move vertically within frame 738. If needed to reduce settling time, viscous damping can be provided (e.g., using a dashpot). Flexures 736 serve as an element of a weight-measuring system used in some embodiments, which allows the weight of pouch 700 and its contents, along with that of components such as plate 720 and roller 724 to be measured. The weight of all such elements other than the pouch contents can be subtracted from the measured weight, allowing real-time non-contact measurement of the pouch contents weight. Such a measurement is useful both to determine the amount of remaining ingredient, and also as part of a closed loop mass flow control system. The mass flow rate from nozzle 704 may not be linear with roller position (though it should vary smoothly with position) since the cross-sectional area of pouch 700 may vary from top to bottom when containing an ingredient. In some embodiments this effect, if repeatable, can be compensated for, and open loop extrusion from pouch 700 may be adequate. However, in some embodiments closed loop control of mass flow is beneficial. In a closed loop system, the actual mass loss of the pouch can be measured regularly (e.g., once per layer) and after performing any required filtering (e.g., averaging) of the data, the travel of roller 724 that will be used to dispense the ingredient for the next layer can be adjusted.

The position of plate 720 relative to frame 738 will vary with weight of the pouch contents. This position may be measured by linear encoder 740 shown in figures (e.g., 22(d)), whose scale 742 may be attached to frame 738 and whose read head 744 may be attached to plate 720. As pouch 700 is emptied, its reduced weight allows it to rise relative to frame 738. After displacement vs. weight has been measured/calibrated, the reading of encoder 740 can be interpreted as the weight of the printhead/pouch assembly. As it may be difficult to obtain an accurate weight while extruding, measurements may be made while extrusion is stopped.

Carriage 746, which moves to position printhead 718 in the X/Y (horizontal) plane, and may also perform Z positioning in some embodiments, is provided. A single carriage may support multiple printheads (including frames, plates, etc.), for example, arranged back-to-back or on the sides of a polygon with three or more sides, allowing rapid switching between ingredients. Multiple carriages, all moved by the same gantry and working in parallel to produce a larger volume of food, are also possible. Frame 738 is attached to carriage 746 through two linear bearings 732 riding on rails 748 or rods, allowing linear actuator 750 at the top of carriage 746 to move the assembly comprising frame 738 and attached components vertically. This adjustment may be done dynamically, in order to keep a constant gap between the nozzle and the printed layer (based on the encoder reading) regardless of the weight of the pouch. Moreover, when a printhead is not in use and remains over the printed food product (e.g., to allow another printhead to function), it can be raised a short distance on the frame using actuator 750, so its nozzle does not contact the printed layer, which might cause mutual contamination of ingredients, nozzle fouling, product damage, etc. While the printhead linear actuator may obviate the need for a stage to raise and lower the platform in some embodiments, in other embodiments the actuators are optimized for rapid movements (e.g., raising and lowering the printhead when switching ingredients) over short distances and a platform stage is optimized for range (printing tall food products) and its movements can be slow.

FIG. 23(a) depicts a 3D view of a system for 3D printing using extrusion from pouches, or a system which may use 3D printing at least in part for food preparation. In the figure, various elements of the system are identified, such as printhead 718, pouch 700, an X/Y gantry with X axis 752 and Y axis 754 able to move carriage 746, platform 756 (e.g., equipped with vacuum ports/channels to secure build surfaces, and moveable vertically on a conventional motion stage (e.g., allowing vertical motion, not shown) on which food products can be printed, a stack of build surfaces 758 (which alternatively can be dispensed from a roll and cut) which can be placed onto platform 756, frame 755, and a set of pouch hangers 760 (five are shown) in a storage area which support pouches such as pouch 762 when not in use (e.g., using pins 764 inserted into pouch holes 716). Other elements not shown include a conventional controller (e.g., microcontroller, PLC) that controls all operations and processes implemented by the system, refrigeration components, power supplies, etc. Hangars 760 may be shaped as in FIG. 23(b) to allow them to access pouches by fitting in between the rods/lead screws of the printhead 718 when the latter enters the spaces between hanging pouches. Printhead 718 in some embodiments can wedge itself between tightly-packed pouches if pouch hangers 760 are supported on a rod separated by compression springs, for example. This allows, for example, a feature (e.g., tapered) on printhead 718 to wedge apart the pouches to gain access to a pouch such as pouch 762, while compressing springs on either side of the accessed pouch. Hangers 760 may be provided in some embodiments with vacuum ports/channels so that pouches are unable to slide off pins 764 while the vacuum is active; alternative pin shapes may also help prevent this issue. Pouches may be loaded manually onto hangers, or automatically. Especially if loaded manually, the printhead, carriage, etc. may include a reader for an NFC or RFID tag, bar code, etc., to recognize the required pouch (assuming the pouches are equipped with tags or codes).

The gantry may have multiple functions: It can move the carriage with attached printhead(s) in X/Y above the platform when printing, can move the printhead(s) to the storage area to load or unload pouches, can move to a waste bin to dispose of empty pouches, and using standard vacuum pickups or other graspers (not shown) on or near the printhead, can transfer build surfaces (e.g., coated cardboard sheets such as cake sheets) to the vacuum-equipped platform 756. The gantry can also transfer build surfaces with food products on them toward the front of the machine when delivering printed food products. Not shown in FIG. 23(a) are the waste bin (e.g., a simple box), and standard internal components such as a power supply, vacuum pump, etc.

In operation, under direction from the controller, the casing 726 can open and roller 724 can rise (after pins 722 are retracted) to allow pouch loading, and the gantry can move carriage 746 over to the storage area such that printhead 718 presses against a selected pouch suspended from a hanger; at this time pins 764 on the hangers (FIG. 23(b)) and pins 722 on the plate can both be inserted into corresponding pouch holes, since counterbores in the plate (not shown) provide clearance for hanger pins, and counterbores 766 in the hangers provide clearance for plate pins (assuming these are not retracted). If vacuum is provided to the hanger, this can be deactivated while vacuum to the printhead plate can be activated. Then, when the gantry pulls away from the hangar, it can bring with it a pouch. Lastly, with the printhead now away from the storage area, casing 726 can close around the lower portion of pouch 700, completing the pouch loading process. The gantry can then move printhead 718 to a position in which a cutter (not shown) such as a conventional knife blade, cuts open the pouch along cut line 710; since pouch 700 is moved by the gantry, the cutter can be a fixed blade (e.g., straight and perpendicular, straight and angled, “V”-shaped, serrated, can comprise multiple blades and cut by shearing (e.g., like scissors), etc. The cutter may be located near a waste bin (alternatively, cut pieces may be retrieved by vacuum, etc.) or can be in some embodiments integrated into the printhead. In some embodiments, pouch 700 is only partially cut, allowing the cut portion to remain attached; casing 726 may be designed to hold the cut portion out of the way. Depending on the height of the cut, the nozzle width can be varied. Then, the gantry moves to stack 758 of build surfaces and fetches a surface with the vacuum pickup(s) and transfers it to platform 756, which retains it using vacuum. Roller 724 can then descend to extrude the ingredient from pouch 700 while the gantry moves the printhead in X and or Y. Assuming a 3D printed food product built in layers, the platform can then be lowered (or the printhead raised by actuator 750) and the printhead can continue to extrude and move to deposit additional layers.

At the end of printing each extrudate (whose cross-sectional shape may be, in the case of an energy bar, the entire width of the layer, requiring only one, single-axis movement per bar layer, rather than X/Y (and possibly Z) motion of the gantry), roller 724 may simply stop. However, if oozing of the ingredient occurs to a significant extent, roller 724 may also reverse direction, rising. Then if pouch 700 springs open naturally or can be induced to do so—e.g., it may have one or more plastic or metal spring strips embedded or attached to its walls, e.g., aligned vertically), or is pulled open by the roller(s) (which may be plumbed for vacuum or be coated with an adhesive material) or by a lower external pressure in the system, or by vacuum “shoes” or cups or adhesive pads attached to the sides of the pouch, or (if the pouch is rigid enough) by pushing inwards on the edges of the pouch, etc.—the reduction in internal pouch pressure may be used to stop the oozing. Another method which may be used is to allow the pouch to herniate/protrude into a volume (e.g., through a hole in the plate) from which it is normally excluded when extruding, which again can reduce internal pressure. A nozzle wiping station (not shown, but consisting for example of a replaceable absorbent pad) may be included if it is determined that nozzle 704 requires occasional cleaning. In some embodiments ingredients can be thermally set, stabilized, and/or cooked as they are deposited or shortly thereafter, using conductive, convective, or radiative heat transfer including heated surfaces, hot air jet(s), and IR sources including lasers.

Other printheads within the printer may also be used to deposit other ingredients: either on the same layer or in different layers. An energy bar may comprise two or more ingredients (e.g., one per layer) such as processed dates or a date mixture and a granular ingredient (e.g., nuts). Since energy bars (and many other food products) are normally eaten using a biting motion that transects the product from top to bottom, bars need not have multiple ingredients in a layer in order to vary the ratio of ingredients. Rather, “in-product mixing” can be used in which the number of single-ingredient layers for each type of ingredient can be varied. The ratio between layers can vary (e.g., 1:1, 1:3). The effect is similar to biting an Oreo cookie; the flavors of the filling and outer wafers become mixed, since separate but closely-spaced ingredients cannot easily be resolved in the mouth. Placing granules on exterior layers can reduce the potential stickiness when handling the sandwich-like structure. Dehydration can also be used in some embodiments to partially dehydrate the outer surfaces of printed products.

Once a pouch is not needed (at least for the time being) for printing, it can be unloaded from printhead 718. This can be accomplished by raising roller 724 until it clears the top of pouch 700, opening the casing 726, moving carriage 746 to the storage area and transferring pouch 700 back to hangar 760. To keep the pouch contents fresh, an external clip may be applied in some embodiments to pinch the pouch closed, or the pouch may have a resealable seal at/near its bottom . If a pouch is completely empty, it can be disposed of by raising roller 724 until it clears the top of the pouch, opening casing 726, moving carriage 746 over a waste bin, and retracting pins 722 so that pouch 700 drops into the bin. Once a food product 768 is printed, the platform vacuum can be switched off and the build surface with printed product(s) thereupon can be grasped by the vacuum pickup(s) and moved by the gantry to a delivery area (e.g., at the front of the system).

Molten ingredients (e.g., chocolate and cheese) can be useful to print, and highly localized dispensing of granular solid ingredients are of interest for a variety of 3D printed food products such as energy bars. A printhead for dispensing granular solids which are non-adherent can deliver ingredients such as chopped nuts and chocolate chips, for example. Approaches to granule dispensing include 1) vibratory sieving (a sieve may be built into a pouch as in FIG. 2(b) or be external to it: vibrating it over a suitable range of frequencies and/or amplitudes can control mass flow rate. Such an approach may be best suited to smaller granules/powders); 2) point-of-use subdivision (a mechanism external to the pouch may be used to subdivide (e.g., chop) larger granules into smaller granules as needed, retaining any whole granules while allowing subdivided ones to be dispensed, thus serving a metering function: pepper mills are an example of this approach. Mass flow rate can be controlled by adjusting mechanism speed, etc.); 3) an oscillating/rotating feeder: A mechanism external to the pouch can feed granules (possibly pre-sieved to ensure consistent size) several at time using a rotating drum with holes sized to accept the granules, or a plate oscillating within a block with offset holes. The drum speed or plate frequency can then regulate mass flow rate. With the latter two approaches, the pouch serves primarily as a hopper, its bottom edge cut open to deliver granules to the mechanism. While these approaches require contact between ingredients and the system, dry, solid granules minimally contaminate and the mechanism may be easy to clean when switching ingredients (or each ingredient can have its own dedicated printhead). In some embodiments after dispensing granules onto a paste layer, the layer is compressed (e.g., with a plate or roller, which may be covered with a disposable sheet such as wax paper) to push granules into the paste, effectively mixing the ingredients in place. The disposable sheet may be left in place after the food product is completed, to protect it. This approach provides a medium granule:paste ratio. In some embodiments paste can be pre-mixed with granules to coat them, providing a high granule:paste ratio.

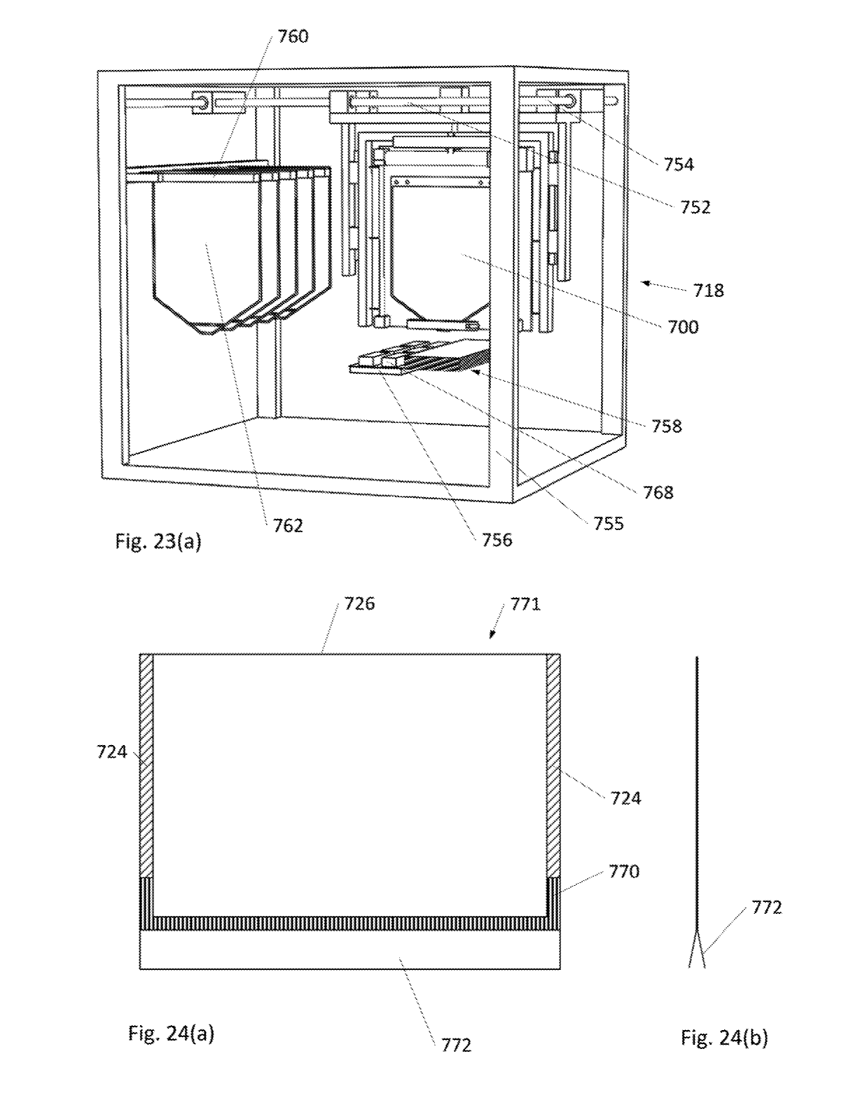

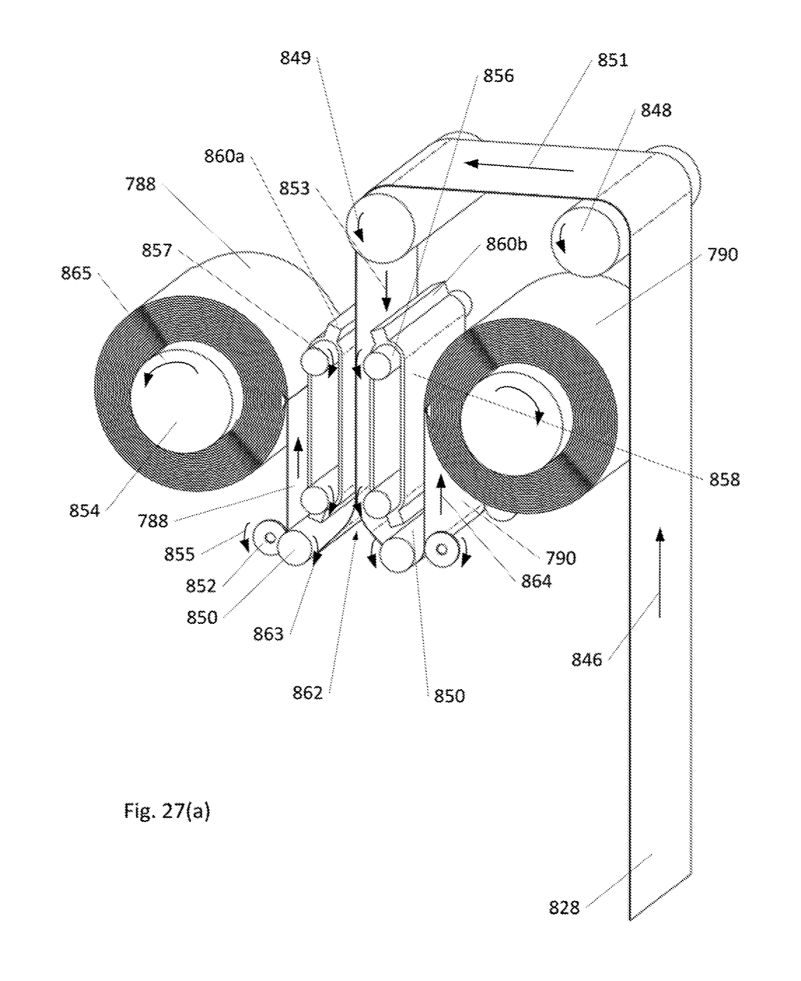

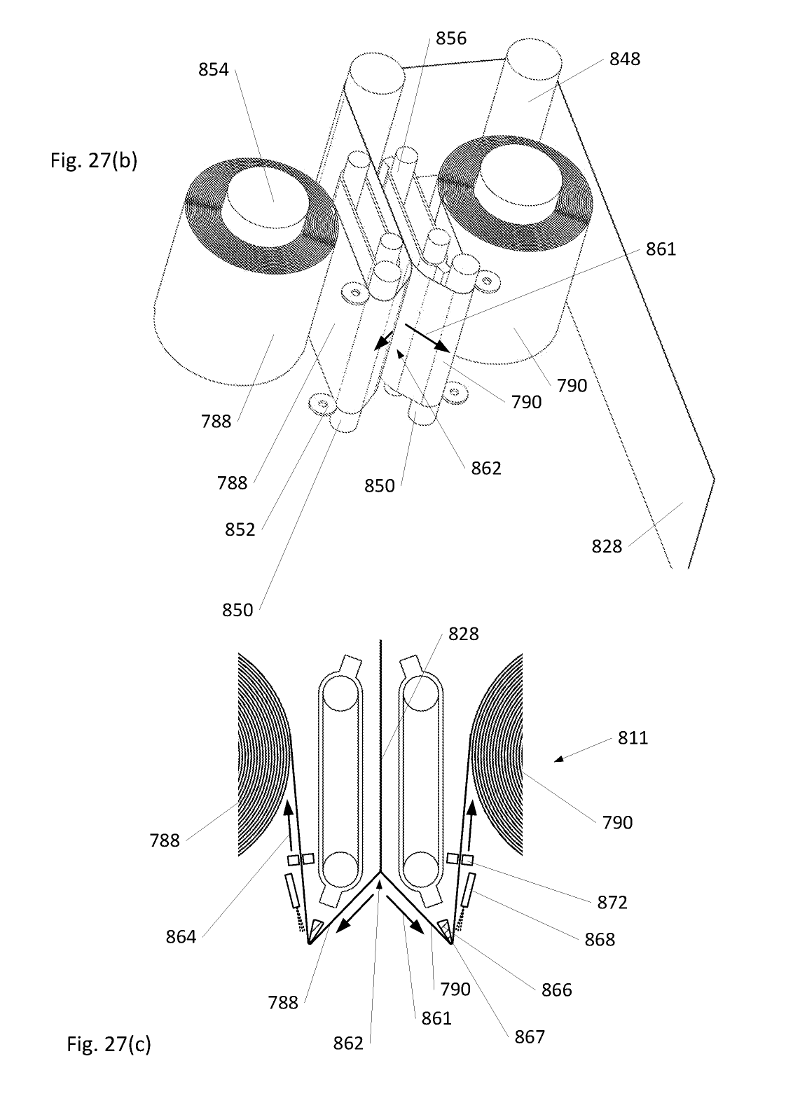

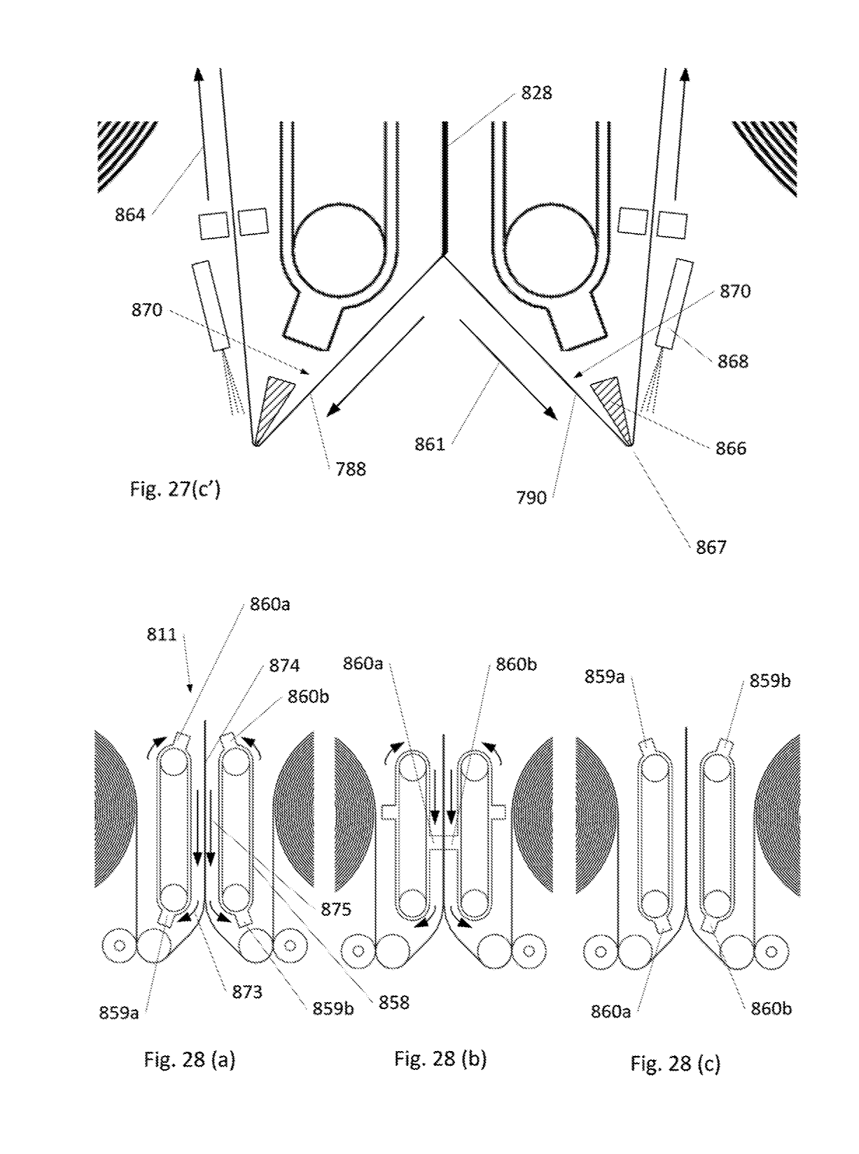

In some embodiments, for a system or implementation (including first and second systems discussed) which employs pouches that are individual/independent, cutting of the pouch can be avoided by using at least one temporary seal as shown in FIGS. 24(a)-(b), which depicts a pouch from the front (FIG. 24(a)) and side (FIG. 24(b)). Peelable seal 770 at the bottom (or at the bottom and partially at the sides) of pouch 771 join the films comprising the pouch. Peelable seal 770 can be opened in some embodiments by mechanically grasping lower edges/flaps 772 extending below the seal and pulling them apart—e.g. in a way that does not expose the grasping mechanism to ingredient(s) within the pouch—or by applying vacuum to the flaps and separating them. Non-peelable or peelable seals 724 on the pouch sides are also shown: if seal 724 is peelable, the sides of the pouch may also be peeled apart to a significant extent (e.g., while passing around the peeling rollers or blades of FIG. 27). Top edge 726 may have a non-peelable or a peelable seal; if pouch 771 is part of a continuous chain or web, the seal for top edge 726 may be made peelable, for example.

### Third System

A variety of “vending machines” (e.g., multiple customer, multiple meal, typically publicly-accessible machines) based on the method and apparatus described herein are possible. For example, a vending machine having a controller (e.g., microcontroller, programmable logic ontroller (PLC)) which prepares meals such as chicken cacciatore over noodles may in some embodiments function according to the following steps (which assumes some ingredients are stored in a frozen state, but which can be modified if that is not the case). All steps are as-commanded by the controller, based on a stored program implementing various algorithms which may include a recipe, sensor input, etc.: 1) sliced chicken breasts are fully- or mostly-cooked (e.g., sous vide, within a vacuum-packed pouch), then frozen; these are placed in a freezer compartment (e.g., freezer chamber, or a salt bath below freezing temperature) within the machine, along with pouches of pre-cooked and frozen noodles; 2) as needed, chicken pouches are withdrawn from the freezer section and defrosted by immersion in cold water, using a microwave/RF oven, etc.; 3) defrosted chicken pieces are dispensed from the pouches into a lower vessel comprising a base to which a liner has been added (the liner may have been coated with oil if the chicken was not packed with some oil) and then browned using a relatively high temperature setting; 4) a pouch with a prepared, fully- or mostly-cooked sauce (and in some embodiments, vegetables) has its contents introduced into the vessel and the heat is then lowered; additional ingredients such as spices and salt can also be added; 5) an upper vessel, comprising upper base and upper liner is placed against the lower vessel and the two are then tumbled as in FIG. 20(d), mixing the sauce and chicken and allowing the two to partially cook together; while steps 1-5 are occurring, a noodle pouch may be defrosted and heated; 6) the tumbling is stopped and in some embodiments, the vessels are rapidly accelerated so as to drive the contents from the upper liner to the lower liner; then, the upper vessel is opened; 7) the noodle pouch, now open, is now emptied on top of the chicken and sauce; the upper vessel is then mated with the lower vessel again; 8) the vessels rapidly rotate 180 degrees in some embodiments so the noodles are now on the bottom; 9) in some embodiments, the upper and lower liners are then joined to seal them to one another: for example, heaters near the edges of the liners may be activated to seal the upper and lower liners together as in FIG. 20(f), or they may be crimped; 10) the bases separate and the liners are removed from the vessels and delivered to the customer. A vending machine may stock a variety of meats and fish (not only chicken), as well as a variety of sauces and starches (e.g., rice, quinoa, pasta), all packaged in flexible packaging, and able to quickly produce a large number of meal permutations.

### Fourth System

A popular format for meals is that of bowls (i.e., the food is delivered in a bowl to a customer) such as burrito bowls, which contain all the ingredients typically in a burrito, yet without a tortilla; poke bowls which have ingredients similar to sushi; quinoa bowls in which various vegetables and/or meats and fish are served over a bed of cooked quinoa, pasta dishes, salads, cereals or yogurt with fruit and nuts, etc. According to some embodiments of the methods and apparatus processes described herein, a machine—referred to herein as a “bowlbot”, though it can operate with dishes other than bowls, such as plates—can prepare a variety of custom meals for a large number of customers by dispensing selected multiple ingredients into a bowl or other receptacle. As part of such a meal assembly process, some ingredients may be heated before delivery. While the system shown may lack the capability to cook or otherwise process ingredients, vessels such as those of FIG. 20, tools such as those of FIG. 16, or other apparatus can be integrated, allowing for a more capable system. In some embodiments the bowlbot is provided with ingredients in the form of continuous “pouch chains”: pouches which are attached to one another end-to-end, or equivalently, comprise individual compartments formed between two or more continuous strips of suitable packaging material which have been sealed together in selected locations. Pouch chains allow dispensing of ingredients from multiple pouches in rapid sequence, and just as with individual pouches, ingredients in pouch chains remain uncontaminated and fresh, and may be packaged under vacuum or in a modified atmosphere if desired. Pouch chain (and individual pouch) materials may include thermoplastic polyethylene films, multi- layer films such as polyethylene/nylon, films containing a polymer and a metal foil, films containing a polymer and a sealing material, polyethylene terephthalate (PET) films, etc. A properly configured bowlbot can manipulate the pouch chains and dispense the ingredients therein as required into bowls, using a conveyor/assembly line or alternative approach.

A given pouch chain may be homogenous, i.e., all pouches within the chain contain the same ingredient(s), or heterogeneous, i.e., different pouches contain different ingredients, and systems may be configured either way. Heterogeneous pouch chains, on the other hand, allow for a smaller system. The formation of a pouch chain requires a process for forming, loading, and sealing pouches, though in some embodiments empty pouches may be preformed so only loading and sealing is needed. In some embodiments, methods and apparatus for forming, loading, and sealing pouch chains are as described in FIGS. 25(a)-(c), wherein the pouches are formed from continuous strips using sealing methods and apparatus, and wherein the seals may be entirely peelable (e.g., able to be peeled into two distinct strips by apparatus within the bowlbot, so as to dispense ingredients). Peeling apart the pouch chain to form two or more strips (e.g., separating the two strips used initially to form the chain) allows ingredients to be easily and efficiently dispensed.

Peelable seals may be produced in films commonly used for fabricating pouches and bags that are unsealed manually by the end-user, through the application of a suitable heat seal coating/heat seal resin (e.g., Appeel® from Dupont, Wilmington, Del., or Toplex (Plastopil USA, Maywood, N.J.), which may be co-extruded with the pouch material or otherwise applied, and several vendors sell packaging films with a peelable heat seal layer provided. Other approaches include hot melt adhesives (e.g., those made by Bostik, Wauwatosa, Wis.), heat or ultrasonic sealing standard polymer film materials such as polyethylene using well-controlled process parameters, screen-printable adhesives, etc. Heat and ultrasonic sealing have the benefits of speed, compatibility with food (since no additional material is introduced), and low cost. FIGS. 25(a)-(c) thus assume thermal methods are used to produce peelable seals, though alternative methods are anticipated.

As can be seen in FIG. 25(g), a pouch in the shape of an irregular hexagon is assumed, with chevron-shaped seals at the top and bottom, and other shapes are contemplated as well, such as diagonal seals. A chevron-shaped seal is easily peelable (e.g., compared with a horizontal seal) if the peeling is performed parallel to the long axis of the pouch chain, since when the seal is angled with respect to the peeling direction, only a small region of the seal is peeled at one time. Moreover, a chevron forms a funnel (as does a diagonal seal) whose width can be controlled, allowing more localized dispensing of a flowable ingredient while controlling the flow rate. In some embodiments rather than a single chevron at the bottom (and optionally, top) of the pouch, a linear zigzag “chain” of smaller chevrons is used, which reduces the overall height compared with a single chevron having the same angles.

FIG. 25(a) depicts a 3D view of apparatus comprising two seal bars 774 and 776 and two vacuum manifolds 778 and 780 each equipped with at least one vacuum cup 782 or other means of separating the strips of material forming the walls of the pouch to widely open the pouch, enabling the easy and rapid loading of an ingredient. Such means may include Setex™ dry adhesives (nanoGriptech, Pittsburgh, Pa.), pressure sensitive adhesives, and others. Seal bars 774 and 776 each may have upper and lower heating elements, or dies 784 and 786, respectively, which may be protruding from the seal bars, though in some embodiments only one seal bar has such elements and the other one has a surface (e.g., made from a compliant and temperature resistant material such as silicone). Upper elements 784, roughly “U”-shaped with a chevron-shaped bottom, are used to form the bottom and side seals of a pouch, while lower chevron-shaped elements 786 (which in some embodiment variations may be straight and horizontal, for example) are used to form the top seal of the pouch after it is loaded with an ingredient. Elements 784 and 786 may be separated by a gap, or join to form single element shaped with an“X” shape near its bottom . The pouch capacity can be varied, e.g., by varying the length of the sides of elements 784. The seal bar may be manufactured, for example, by machining a material (e.g., aluminum) into the shape shown, or in part via molding, e.g., with a high-temperature elastomer such as silicone, which may have fillers (e.g., filled silicones from Silicone Solutions, Cuyahoga Falls, Ohio) for increased thermal conductivity. Heaters are provided to heat the bar and via conduction, the heated elements. The heated elements may themselves be made of a resistive material such as nickel-chromium and heated slowly or very rapidly, as with an impulse heater; in the latter case, the heated elements may be thermally isolated to some extent from the bar, which primarily provides support to the elements. The protruding heated elements may be coated with a material such as PTFE, or a conventional heat seal separator film (e.g., PTFE-coated fiberglass, not shown) may be used between the heated element and the strip. In some embodiments in lieu of conventional heating elements ultrasonic or RF dielectric heating elements may be used.

Continuous strips (i.e., webs) of packaging film 788 and 790 are led from supply rolls below into the space between bars 774 and 776 and cups 782, passing over support rollers 792. Strips 788 and 790 may be pulled using feed rollers 794 which impinge on the strips. Paired elements 784 and 786 face one another, as do the vacuum cups 782 of the vacuum manifold. The cups 782, or similar elements, placed adjacent to strips 788 and 790, serve to widely separate the two strips after the first seal is made so as to allow an ingredient to be loaded into the pouch easily. In some embodiments the edges of the strips are perforated somewhat like motion picture film and the strips may be moved by use of sprockets or other mechanisms which engage the holes. In FIG. 25(a) elements 784 and 786 are not in contact with strips 788 and 790, and may not yet be heated. Vacuum cups 782 may also not yet be in contact with the strips, and so vacuum may not yet be applied to manifolds 778 and 780. However, in the 3D view of FIG. 25(b), the bars 774 and 776 have been pressed together, e.g., using a controlled and uniform pressure, trapping strips 788 and 790 between them. At this time, the elements 784 and 786 are rapidly heated to a desired temperature (if not already at temperature) and after a time bars 774 and 776 are separated. The result is that the element784 forms the bottom and sides of a new pouch via heat sealing. Parameters such as material, time, temperature, and pressure are adjusted to produce a hermetic, easily-peeled seal (use of heat-sealable films intended to produce peelable seals can allow a wider process window). Simultaneously, the element 786 forms a chevon-shaped top seal for the previous pouch, if any. In the 3D view of FIG. 25(c), vacuum has been applied to cups 782 and the vacuum manifolds 778 and 780 have been pulled apart, thus pulling apart strips 788 and 790 so as to open the pouch widely as shown by arrow 796 and allow it to be filled with an ingredient. In some embodiments the cups may be of different shape (e.g., elliptical, rectangular), may be articulating or arch-shaped (such that they form the pouch wall into the desired shape as they pull on it), may have independently-moving elements, etc. The last step in the processing of forming, filling and sealing the pouch comprises feeding strips 788 and 790 downwards such that the upper chevron-shaped heat seal produced by element 786 slightly overlaps or perfectly butts up against the bottom/side seal already produced by element 784.

FIG. 25(d) shows an elevation view rotated about a vertical axis of strips 788 and 790 surrounded by seal bars 774 and 776 which are converging on the strips as shown by arrows 796. Also shown are feed rollers 794 on either side of the strips; in some embodiments these may be located elsewhere such as above the seal bars. FIGS. 25(e)-(j) depict elevation views of a sequence for forming, filling, and sealing two pouches, and forming and filling a third pouch; seal bar 774 is omitted for clarity. In FIG. 25(e), the two heated elements 784 and 786 of the seal bars 784 and 786 have converged on strips 788 and 790 and are heated (if not already heated), yielding first seal 798 that joins the two strips and forms the lower part of a first pouch 800. Seal bars 774 and 776 then separate and pouch 800 is opened, e.g., by standard vacuum cups 782 or cups with flat surfaces well suited to holding onto stiff films such as PET (not shown) for pouch loading/filling. In FIG. 25(f), pouch 800 has been loaded with ingredient 802 (the actual fill level may be higher or lower than shown). In FIG. 25(g), feed rollers have rotated in the direction shown by arrows 807 and lowered strips 788 and 790 in the direction shown by arrow 809, and seal bars 774 and 776 have produced second seal 804. The second seal forms the bottom and sides of pouch 806, and also seals pouch 800 by means of lower heated element 786. In FIG. 25(h), pouch 806 has been filled. In FIG. 25(i), the feed rollers have lowered the strips further and the seal bars have formed third seal 808, forming the bottom and sides of pouch 810 while sealing pouch 806. The last step in the repeated cycle of forming, filling, and sealing (along with transporting the strips) is depicted in FIG. 25(j), in which pouch 810 has been filled: the cycle can continue until the entire pouch chain has been produced. As pouches are formed and the strips descend, it can be collected in a folded form (with horizontal or vertical folds) within a supply case or other form of temporary storage that will go into the bowlbot system, rolled upon on a spool within a supply case, etc. If individual pouches are required in lieu of a pouch chain, they can be cut after formation.

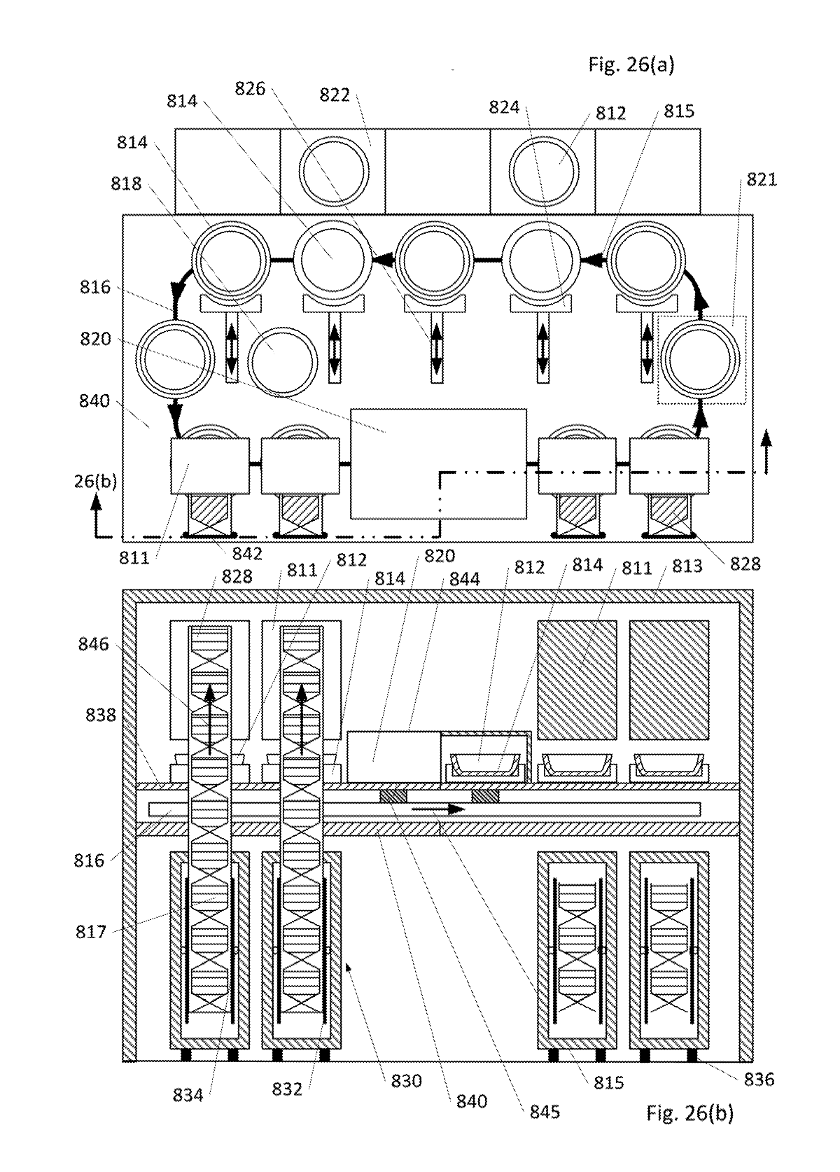

A bowlbot may use pouch chairs or individual pouches. In some embodiments using pouch chains, the general layout of a basic, simplified bowlbot is as shown in FIGS. 26(a)-(b). The bowlbot allows for an assembly line approach to filling multiple bowls in parallel (e.g., as one bowl receives its third ingredient, the bowl “upstream” (behind it) receives its second ingredient, and the next one upstream receives its first ingredient, etc.) Depending on a customer's specific order, certain ingredients may be skipped entirely. FIG. 26(a) is a plan view, looking down on the system with the optional top of enclosure 813 removed, while FIG. 26(b) is a cross-sectional elevation view according to the multi-segment profile of FIG. 26(a). A number of elements are shown simplified for clarity (e.g., no internal components of dispensers 811 are shown). Bowls 812 are transported in a loop on carriers 814 which in some embodiments are equally spaced, and which are moved counterclockwise (as shown by arrows 815, or clockwise) by belt 816, in a conveyor-like arrangement. The loop may be more complex than that shown, for example allowing bowls to move under multiple rows of dispensers, so as to allow many ingredients to be dispensed in a system not excessively long. Motion can be continuous or intermittent/variable speed, e.g., with each bowl slowing or stopping beneath each dispenser according to the movement of the belt. In some embodiments provision may be made to allow dispensing ingredients from more than one pouch 817 in succession at a given dispenser, though this may require imposing short delays on the progression of other bowls being process at the same time. For example, a customer may specify a double quantity of shredded beef, which may involve dispensing the contents of two pouches into his or her bowl, not one as usual.

New, clean bowls are added to carriers from stack 818 by a loading mechanism (e.g., a conventional manipulator equipped with standard vacuum cups, not shown). Bowls travel around the loop, passing under several dispensers, then in some embodiments entering oven 820 to heat already-dispensed ingredients, then passing under additional dispensers to receive ingredients not needing heating, then moving to a lidding station 821 in some embodiments where lids (not shown) are placed on/affixed to the bowls, and then moving to the other side of the bowlbot where filled bowls are transferred from carriers to delivery boxes 822 by offloaders 824 which can move in the direction shown by arrows 826, allowing customers to access their meals at their preferred times. Delivery boxes may be warmed to allow for customers not arriving shortly after the bowl is ready, and enough delivery boxes to satisfy peak demand must be provided. Empty carriers then return to receive more new bowls for additional customers. For example, in the case of a bowlbot assembling a burrito bowl, refrigerated ingredients such as rice, beans, chicken, and fajita vegetables may be dispensed into the bowl prior to entering the oven, and then ingredients such as sour cream, salsa, lettuce, and guacamole may be dispensed after the bowl has left the oven, before delivery to the customer. Not shown is a standard controller which may comprise an embedded computer, microcontroller, PLC, etc. which may control all bowlbot actuators and may receive input from all bowlbot sensors.

In some embodiments pouch chains 828 are stored in supply cases 830 rolled up on spools 832 rotating on shafts 834 as shown, or may be folded. In other embodiments pouch chains are directly loaded into the bowlbot without supply cases. In some embodiments supply cases are insulated to keep the contents at a desired temperature (e.g., cold, room temperature, or in some embodiments, hot) and roll on wheels or casters 836, as shown, allowing them to be easily transported and then loaded into the bowlbot with little or no lifting, as cases may be heavy. Supply cases may be sealed so that no leakage can occur should a pouch burst. The bowlbot is in some embodiments divided into upper and lower regions by a solid plate 838 and by a bulkhead 840, both provided with slots 842 (e.g., equipped with brushes to partially seal them but allow pouches to pass) through which pouch chains pass from the lower to the upper region. The lower region may be refrigerated, thus keeping all the ingredients in the supply cases cool and in some embodiments frozen or nearly frozen to preserve them longer. In some embodiments the upper region is also refrigerated, though optionally with a higher temperature. The space between plate and bulkhead can be used as a thermal buffer between upper and lower regions, or can be heated, for example, to pre-heat ingredients passing through it, etc. In some embodiments supply cases may contain their own refrigeration units, obtaining electric power from the delivery vehicle in which they are transported, from internal batteries, etc. In such embodiments, the lower region of the bowlbot need not be refrigerated and may simply electrically connect to the supply case to provide it with power while it is installed in the bowlbot. A potential benefit of individually-refrigerated cases is that different cases can be cooled to different temperatures (including not being cooled at all, and serving as a freezer during long distance shipping of a case). If the cases are rectangular and if the chains are on a spool, there will be sufficient space at the corners for refrigeration equipment and potentially, batteries.

In some embodiments each dispenser is provided with its own supply case, while in other embodiments multiple dispensers may share one case, or multiple cases may supply one dispenser. In the case of an ingredient that is used in high volume (e.g., rice in a burrito bowl), two or more dispensers, either consecutive or separated with respect to the filling sequence and belt motion, can be provided with the same ingredient. The pouch chains holding this ingredient may be supplied from the same or different supply cases. In some embodiments similar ingredients may be provided in a single machine, such as multiple versions of shredded beef, differing in sodium level or the amount of spice, allowing for more customization by the customer.

In some embodiments ingredients, particularly those commonly used and with long shelf lives, may be housed within the bowlbot semi-permanently, and be dispensed from canisters, hoppers, shakers, vats, tubes, tanks, boxes, and other holding and dispensing devices known to the art. For example, salt, pepper, and other dried spices might be dispensed into bowls according to customer preferences using a vibrating shaker or a motorized mill that grinds and releases the ingredient when it is activated. If the ingredient can be refrigerated (e.g., if the upper region is refrigerated), then common ingredients such as milk, salad dressings can also be distributed (e.g., from tanks equipped with valves).

The oven walls, floor, and top may be insulating to minimize heating the lower region, or the upper region exterior to the oven. The oven can heat food through any or a combination of halogen bulbs, conventional heating elements, microwave, RF (e.g., using devices from NXP Semiconductors, Eindhoven, Netherlands), steam, air impingement, and other heating methods. In some embodiments the oven may be replaced by a refrigerated chamber, e.g., to chill ingredients for a cold, multi-ingredient dessert. The inlet and outlet of the oven may be closed at least partially by doors (not shown) which are closed and opened by an actuator, or other means to minimize heat transfer (and in the case of microwave/RF heating, radiation) to the surroundings. Doors can be actuated in synchronization with carrier motion so that they open briefly to allow bowls to enter or leave the oven, and are otherwise closed. Since the amount of time required for heating ingredients may exceed the time required for the belt to move the distance between bowls, the oven can be made long enough that bowls remain in it for an extended time as they progress. In FIG. 26(b), two bowls are shown within the oven, though many more may be provided on elongated paths. For example, the belt can follow a serpentine path within the oven, or the belt (or a specialized track interfacing with the carriers) can follow a helical or multi-helical path, in which case bowls may leave the oven at a different height than they enter it. In some embodiments rather than or in addition to an oven, ingredients may be heated while still inside pouches, e.g., while a pouch is en route to the dispenser. Such heater may be done by air, by microwave or RF energy, by light (e.g., halogen sources), by passage of the pouch chain through a hot water bath, etc. In the case of microwave or RF energy heating (in bowl or in-pouch), provisions should be made to keep electromagnetic energy within a chamber; this may include spring-loaded doors, actuated doors synchronized with the microwave/RF source turning on and off, metallic brushes, etc., such that no aperture is large enough to allow energy to escape. Also in some embodiments, bowls may be heated directly such as through the use of heating elements incorporated into the carriers.

In some embodiments carriers are connected to the drive belt directly or through couplers 844, such as magnetic couplers 845 used in some embodiment variations. Magnetic ouplers are advantageous in that no slot is required in the plate to allow direct mechanical connections between the belt and carriers, allowing for better thermal control and easier cleaning. Rather, the carrier and/or elements attached to the belt can comprise one or more strong magnets (e.g., NdFeB) and/or ferromagnetic materials on or near opposite sides of the plate, such that movement of the elements by the belt causes the carriers to follow the path of the belt, especially if the bottom surfaces of the carriers (and possibly also the top surface of the plate) are made from a low-friction material or are supported by balls or rollers, etc.

In some embodiments bowls are maintained on the carriers by a hollow depression in the carrier, or one or more walls which may surround the bowl completely as in FIGS. 26(a)-b) or partially. If otherwise surrounding the bowl, carriers may have one or more doors that open, allowing the bowl to slide off when near the delivery box. In other embodiments bowls are retained by shallow, radiused or chamfered recesses in the top surface of the carriers. In either case, bowls may then be offloaded from carriers 814 and into delivery boxes 822 by pushing on their sides or upper rims, for example. Offloaders 824 may comprise a reciprocating linear slide (e.g., belt driven) and an end effector which engages the bowl. Sensors (e.g., optical, weight) within each delivery box can be used to verify that a box has been properly loaded with a bowl, and to detect when the bowl has been removed by a customer, thus freeing up the box for another bowl. The bowlbot controller can make decisions based on sensor data to determine for example which delivery box (e.g., the first empty box available) should be used when offloading the next bowl. To accomplish this and other functions, the controller may keep track of each bowl, including which bowls belong to which customer and which bowls receive which ingredients.

When a bowl has been filled, the controller may notify (e.g., through an SMS text message, automated phone call, mobile app, email, Web site, loudspeaker announcement, etc.) the customer directly or indirectly that her order is completed, provide an access code, and note that the bowl will be placed in a particular delivery box (which can be identified by a number). When the customer enters the code on a keypad (or in some embodiments, places a phone with NFC capability near an antenna, etc.), the box door can unlock and/or automatically open, allowing access to the customer, while avoiding theft or accidentally taking another customer's order versus one's own. Delivery boxes may be equipped with air curtains to prevent the ingress of insects, and possibly with means of immobilizing any insects which do enter.

In some embodiments pouch chains are pulled upwards in the direction shown by arrows 846 from the supply cases by mechanisms in the dispensers which apply tension to the chain. In some embodiments the pouch chains moreover are peeled apart one pouch at a time by the dispensers in the process of emptying their contents, and the strips which comprise them are spooled up. In some embodiments relatively flowable pouch contents may be thoroughly discharged prior to peeling the pouch using squeegees, rollers, etc. which compress the pouches. FIGS. 27(a)-(b) depict 3D views of a dispenser used in some embodiments. The function of the dispenser is to dispense ingredients from pouches efficiently, i.e., to eject as much of the pouch contents as possible, do so quickly (e.g., in 2-3 seconds), and do so with hardware that is as simple and inexpensive as possible. Moreover, the subsystem should be able to dispense an ingredient without physically contacting it, such that the ingredient only contacts the inner surface of the pouch/strip and does not contaminate any portion of the machine, thus obviating the need for cleaning (whether in-situ or after removal) or replacement. Unless the inner surface of a pouch is specially treated (e.g., superhydrophobic, e.g., with a coating from LiquiGlide (Cambridge, Mass.), most ingredients will simply not fall out of a pouch once it is unsealed at it bottom. Rather, unless novel apparatus and methods are employed as described herein to efficiently dispense ingredients stored in pouches, flowable ingredients will normally tend to adhere to the pouch walls, as will ingredients or portions thereof that are moist or have high surface area to volume or weight ratios. Such ingredients constitute a very large fraction of all ingredients.

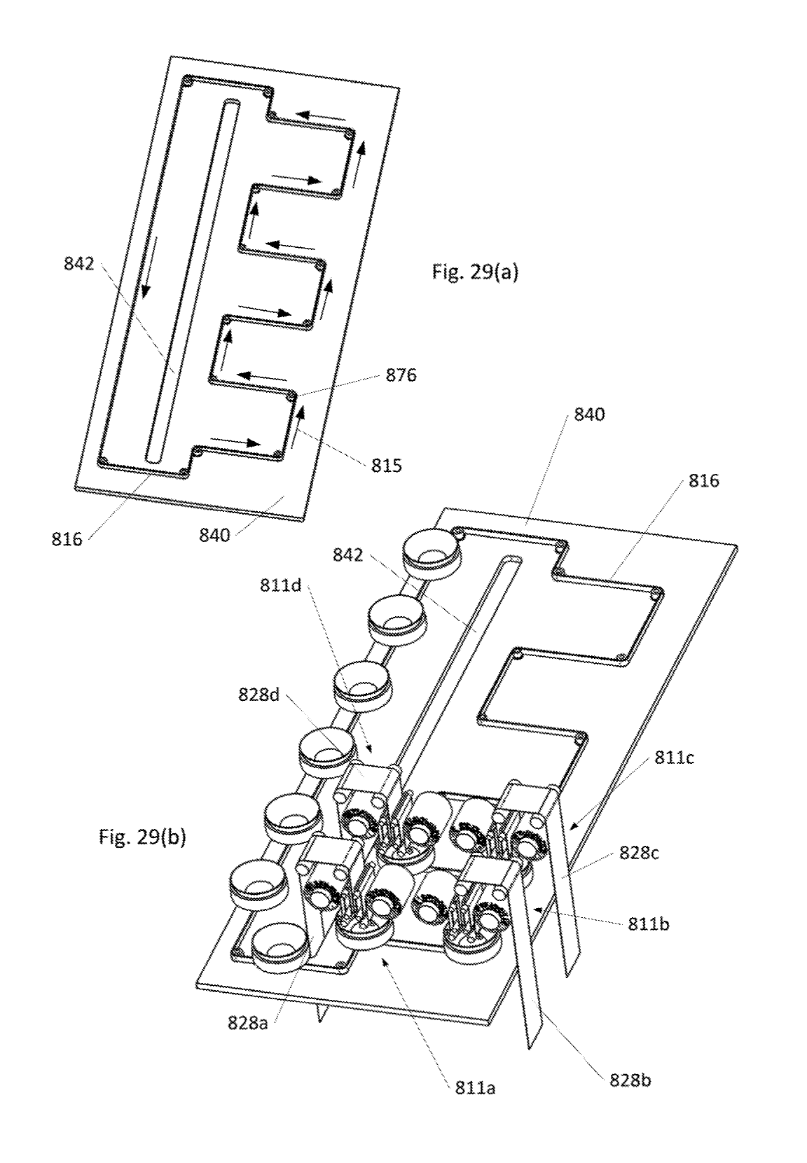

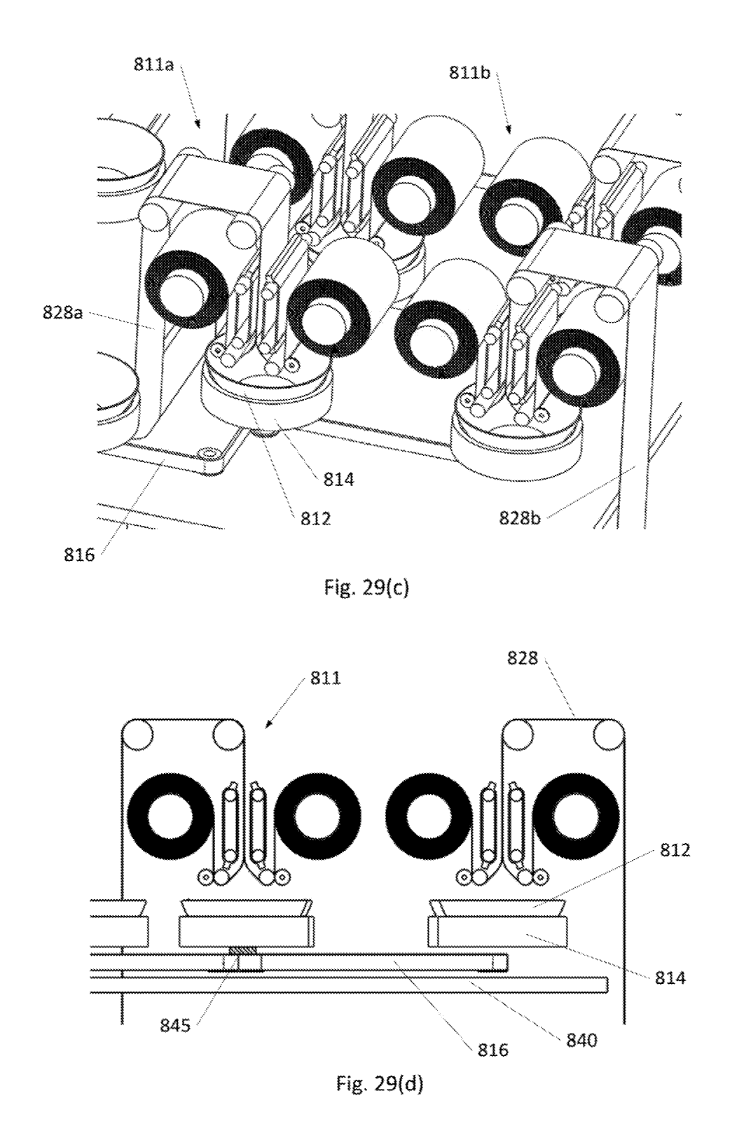

As is shown in the downwards-looking FIG. 27(a) and the upwards-looking FIG. 27(b), the dispenser in some embodiments such as in the bowl of FIG. 29 may comprise at least one supports 848 (two as shown) supporting the pouch chain and which may rotate in the direction shown by arrows 849, peeling rollers 850, optional narrow rollers 852 which may rotate as shown by arrows 855, take-up rollers 854 with rotate as shown by arrows 865, and a pouch squeezing subsystem using squeegees (or rollers) which may comprise for example, drive rollers 856 rotating as shown by arrow 857 and belts 858 with attached first set of squeegees 860a and 860b and optional second set of squeegees 859a and 859b, or other means for moving the squeegees. The supports, used when the pouch chain is below the dispenser as in FIG. 26, serve to redirect the chain as shown by arrows 851 and 853 so it is in the region of arrow 853 from above. The supports can comprise rollers, which may be arranged at a similar height, or arranged at different heights (e.g., to form a curved roller-based conveyor), etc. In some embodiments, the rollers are narrow so as to contact the chain primarily along its edges and allow the bulging section of the chain (where ingredients fill the pouch) to pass between them. In some embodiments the rollers can be very soft and compliant (e.g., brushes) to better accommodate the bulging portions of the pouches (note: the pouches shown in the figures do not appear to bulge and appear flat, for simplicity of the figure). In some embodiments secondary narrow rollers may be provided on the opposite side of the chain such that one or both sets of narrow rollers may be driven so as to feed the chain. Guides (not shown) such as simple U-channels may be provided to keep the chain properly positioned on the rollers. In some embodiments, the incoming chain is not parallel to the axis of the rollers (e.g., take-up rollers) as shown, but the chain is twisted through an angle (e.g., 90 degrees), for example, between the supply case and the support so that the plane of the pouch is perpendicular to the direction of bowl motion rather than parallel to it, for example. In other embodiments the chain can be shaped as an inverted “U” with the two vertical legs displaced laterally from one another so that the lower leg can reach the supply case underneath while the upper leg can access a dispenser below.

The pouch chain is peeled apart by tension (e.g., carefully regulated) on the strips as the strips pass around peeling rollers (which may rotate as shown by arrows 863 or be fixed), the strips having already separated at a “peel front” 862 (the location where the two strips comprising the pouch become distinct and move apart) and moved in the direction of arrows 861 (FIG. 27(b)) before contacting the peeling rollers which redirects them through a large change of angle, after which they continue in the direction of arrows 864 toward the take-up rollers. The peeling rollers (or blades) are spaced apart so as to allow the strips comprising the pouch to separate widely and ingredients in the pouch enough room to fall out (e.g., from the area of the peel front) when the pouch is peeled open. The peeling rollers serve to peel the pouch and by redirecting the films while only contacting them on their outer, pristine surfaces, allow the pouches to be peeled open while moving the film in an available direction (e.g., upwards, diagonally upwards, horizontally) rather than downwards, toward the bowl. Without peeling rollers or their equivalent, there might not be adequate room for large take- up rollers. In some embodiments, the peeling rollers are narrow so as to contact the chain primarily along its edges, and in conjunction with narrow rollers, can move toward the center of the pouch, allowing the pouch walls (strips 788 and 790) to separate and facilitating/accelerating pouch emptying. Conversely, the peeling and narrow rollers may move away from the center of the pouch, tensioning it laterally so as to help retain ingredients which might otherwise exit the pouch too rapidly.

In some embodiments in which the upper region of the bowlbot is not as cold as the lower region, the pouch chain en route from the supply case to the dispenser (and even within the dispenser) may be enclosed within a temperature- controlled (e.g., refrigerated) tube or duct so as to preserve ingredients as long as possible. This can be more energy efficient than refrigerating the entire upper region, and can be helpful especially when the bowlbot is being used only occasionally (e.g., generally idle at night and between mealtimes) since otherwise, ingredients in pouches within the upper region are no longer refrigerated for extended times. In some embodiments, the normal direction in which the pouch chain is fed can be reversed so that pouches can be returned to a temperature-controlled environment when the machine is idle or expected to be idle for an extended period. For example, if chains are stored on spools as in FIG. 26(b), the spool can be rotated by a motor to retract the chain and the already-peeled strips until all pouches with ingredients inside are returned to the supply case or at least below the plate or bulkhead. In some embodiments the entire chain/strips does not retract; rather, the strips are cut (or are split along pre-scored/perforated lines) so that only the edges of the strips retract. Both the center and edges of the strips are then wound up on the take-up spools when the chain advances in the normal direction. In other embodiments, as the strips are retracted, then are peelably sealed (e.g., by narrow heated rollers or belts) along their edges, trapping any ingredient residues inside a closed tube. Either approach prevents already-opened pouches from retracting through the system, which may risk exposing bowlbot components to contamination by ingredient residues.

The take-up rollers serve in some embodiments to collect (e.g., on rollers, as shown, or on spools) the strips resulting from peeling apart the pouch chain. Take-up rollers in some embodiments include a slotted hub which may include a clamping mechanism that can securely grasp the end of the strip. In some embodiments, the leading end of the pouch chain is pre-separated into strips over a distance to facilitate loading, and in some embodiment variations the strips are pre-attached to take-up rollers or spools so that loading the machine with a new pouch chain only requires mounting the rollers/spools and threading the chain/strips through the required path. In some embodiments, the peeling rollers serve to peel apart the two strips forming the chain, and also, in conjunction with the narrow rollers which pinch the strip between themselves and the peeling rollers, feed the pouch chain. The narrow rollers may be narrow enough so as to not come into contact with ingredient residues on the surfaces of the strips that had been the interior surfaces of the pouches. In such embodiments, the take-up rollers may be powered by one or more motors whenever needed to minimize slack in the strips/chain (e.g., using a sensor to sense the loss of tension) or can be rotated by motor(s) continuously, through a slip clutch so as to keep constant tension on the strip.

In other embodiments, the peeling rollers may only serve to redirect the strips to the take-up rollers while under tension, and the take-up rollers are the primary drivers that feed the chain forward. In such embodiments; the narrow rollers may not be used. However, the peeling roller/narrow roller set may still be used in some embodiments to measure (e.g., through an encoder) the position of the strips/chain as they are rotated by the strips/chain under non-slip conditions.

In some embodiments as shown in the elevation view of FIG. 27(c) and in the enlarged detail elevation view of FIG. 27(c′), blades 866 that have thin lower edges 867 with small (e.g., 0.05-0.5 mm) lower edge radii—though other radii may also be suitable—may be used to bend and redirect the strips in lieu of rollers, such that the strips wrapping around the blades (with their pristine, outer surfaces 870 in contact with the blades) not only rotate through a large angle (e.g., over 120 degrees) relative to the incoming strip as with rollers, but are also bent sharply (with a small radius), as long as the packaging film is reasonably thin and proper tension is maintained on it so it conforms closely to the blade lower edge. Since the bend is the lowest point of the strip within the dispenser, food residues may tend to slide down the strip and drip/fall off the strip at the bend. Moreover, when using blades with small radii (or small diameter peeling rollers), ingredients (e.g., moist, high surface/volume ratio, low density) that may normally tend to cling to the inner surfaces of the pouch typically cannot negotiate the sharp turn as the strip passes from one side of the roller/blade to the other, especially if the angular change is large, and thus will fall off into the bowl, cooking vessel, or other receptacle as desired. Tests with blades approximately 1.4 mm thick at their bottom edges and with an edge radius of approximately 0.7 mm have shown that at least 99.5% of ingredients on average, as measured by weight over a variety of ingredients, can be dispensed using blades and complete peeling of the pouch (or using, where applicable for flowable ingredients, a squeegee such as that in FIGS. 27-28, to expel the ingredient from the pouch). Blades such as those in FIGS. 27(c) and 27c′) can be used when peeling apart and dispensing from individual pouches such as that shown in FIG. 24 as well as peeling apart and dispensing from pouch chains. A number of plastic packaging films (e.g., PET) will tolerate being wrapped around even a fairly sharp edge.

In some embodiments ingredients tending to cling to the strip may be dislodged by an air knife or water jet 868 (e.g., with heated air that evaporates moisture causing ingredient particles to cling) as shown in FIGS. 27(c) and 27(c′), by vibration (e.g., vibrating the edge, tapping on the strips between the peel front and the blade lower edge, by sudden acceleration moving upwards or deceleration moving downwards of the dispenser or a component thereof, by stretching the strip (e.g., rapidly), by forcing the strip to conform to a finely textured/rippled surface (e.g., with slots or holes) using vacuum or tension, etc. Such methods may also be used with peeling rollers. Removing ingredients from the film as much as possible is useful both to minimize waste and also to minimize the likelihood of ingredients falling off later and contaminating another bowl, etc. If residues cannot be entirely removed by such methods, then scrapers may be used which rub against the inner surfaces of the strips; however, such scrapers may need to be cleaned or replaced. They may also shed ingredient residues if there is sufficient buildup on them, thus automated cleaning/replenishment of the scrapers (e.g., scrapers in the form of continuous strips which gradually translate) may be implemented in some embodiments.

In some embodiments, pouch chains/strips may develop a static harge as a result of moving through the bowlbot and/or being peeled, and such a charge can be detrimental to the bowlbot and contribute to ingredient retention on the strip. Conductive brushes and ion sources known to the art may be used to neutralize this charge.

The strips within the dispenser can be sized so that the widest pouch (or funnel/bottom chevron seal, if pouches are only peeled partially to discharge ingredients) is smaller than the bowl internal width. The lowest portion of the strips within the dispenser may be close to the top of the bowl (or to the highest ingredient that will be added to the bowl) so that ingredients don't dispense excessively (e.g., fall outside the bowl) while falling or if blown off the strips by an air knife.

In embodiments using blades, the strips may be pulled by the take-up rollers or by supplementary feed/pinch rollers downstream (i.e., closer to the take-up rollers). Especially if no supplementary rollers are used, one or more sensors 872 may be employed to measure strip motion. For example, an optical sensor may be used to sense, by reflected or transmitted light, a portion of the seal, since even after peeling the optical properties of the seal may be different than the surrounding strip. Alternatively, such sensors may be located near the chain prior to peeling. With sensing thus provided, a feedback loop may be established in which the motor(s) driving the take-up rollers (or those driving the pinch rollers) are stopped when the strip/chain have advanced far enough that the pouch should be completely emptied. The process then repeats for the next pouch once a bowl intended to receive the contents of the next pouch is positioned below the dispenser.

FIGS. 28(a)-(c) depict the operation of the pouch squeezing subsystem used in some embodiments to discharge relatively flowable ingredients from the pouch prior to peeling it. For ingredients which tend to adhere to the inner surfaces of the pouch, squeezing out the pouch before peeling it apart can more completely transfer the ingredients to the bowl than peeling alone. Thus a dispensing cycle can comprise three steps: 1) while the bowl is beneath the dispenser, partially peel the pouch to open it by advancing the pouch chain relative to the peeling rollers, blades, etc. Assuming a chevron-shape pouch bottom, the extent of the partial peel can vary depending on the viscosity of the ingredient and the desired flow rate, etc.; 2) activate the pouch squeezing subsystem to squeeze out the contents; 3) peel the pouch while advancing the pouch chain so that the next pouch is properly positioned for the next cycle (this last step may not be used in the case of an individual pouch). Step 3 may be performed while bowls are moving between dispensers to save time. In some embodiments rather than peel the pouch initially as in step 1, simply start to squeeze the pouch using the squeegees, forcing the bottom seal to burst open (this may require making this seal weaker than other pouch seals).

The squeezing subsystem is designed such that one or more motors rotate at least one roller for each belt in the directions shown by arrows 873, causing the squeegees attached to the belt (or integral with it) to advance from the top to the bottom as shown by arrows 875. As already noted, the pouch chain is depicted without bulging pouches but in practice pouches bulge to some extent to accommodate their contents. Prior to activation, squeegees 860a and 860b of each belt 858 are widely separately as in FIG. 28(a), and so don't interfere with the bulging pouch 874, allowing it to descend between the belts as in step 3. In FIG. 28(b), the belts are in motion, causing squeegees 860a and 860b (which may be elastomeric) to impinge on the pouch and then move downwards, squeezing out the contents through the pouch bottom. Simultaneously, squeegees 859a and 859b, which had been near the bottom of the belts prior to activation, move upwards. In some embodiments a low-friction plate or set of rollers may serve as backing for the portion of the belt adjacent to the pouch chain, preventing it from deflecting and allowing more force to be applied to the pouch by the squeegees. In FIG. 28(c), the belts have stopped moving, the pouch contents have been fully discharged, and squeegees A1 and B1 have exchanged positions with squeegees A2 and B2, respectively, in preparation for the next cycle. In some embodiments blades or rollers may be used in lieu of squeegees. While the subsystem shown has the benefit of requiring only one or two rotary motors for operation, other mechanisms for manipulating squeegees, blades, rollers, etc. known to the art may alternatively be used. In some embodiments, only one set of squeegees is used, along with a rigid plate on the opposite side of the pouch, as in the second system.

FIG. 29(a) depicts a 3D view of a bowlbot bulkhead 840 as well as a belt 816 and associated pulleys 876 (at least one of which is a driven pulley, with others as idlers). In some embodiments the belt is a timing belt and the pulleys are timing belt pulleys. Compared with FIGS. 26(a)-(b), this configuration of the bowlbot is designed for two rows of dispensers, not one, and thus the belt has a serpentine shape on one side, allowing bowls to be transported to 12 dispensers in this example. In some embodiments, three or more rows of dispensers may be used, and in some embodiments the arrangement of dispensers may be staggered from one row with respect to another (e.g., dispensers centered at the centers of an array of tessellated hexagons). Slot 842 is provided so that pouch chains for the left set of dispensers (e.g., 811a and 811d) can reach the dispensers directly from the supply cases below. In the example shown, slots are not provided for pouch chains associated with the right set of dispensers (e.g., 811b and 811c); rather, these pass alongside the plate and bulkhead, but slots may be provided for these in some embodiments. Other elements of the bowlbot layout of FIG. 26(a)-(b) are also not shown in FIG. 29(a), such as the couplers, carriers, plate, offloaders, oven (if used), bowl stack and bowl loading subsystem, lidding station, and delivery boxes. Couplers can be connected to the belt by pins (e.g., several per coupler, e.g., at the location of timing belt teeth). To allow pins to extend to couplers, pulleys may be singly flanged at their bottoms or rotate adjacent to a surface such as the bulkhead, preventing the belt from sliding down off the pulleys. In some embodiments multiple belts are used, following a similar path, each with pins to provide support for the couplers.

FIG. 29(b) depicts a 3D view similar to that of FIG. 29(a), but with the addition of dispensers, pouch chains, carriers, and bowls. Due to the path of the bowl carriers, the first dispenser visited 811a is at one end of the plate, with the second dispenser 811b adjacent to it, and so on (the next two dispensers according to the direction of bowl movement are 811c and 811d). The orientation of even and odd-numbered dispensers alternates by 180 degrees in the example shown, though other angles are possible. While the dispensers in FIG. 29(b) are located close to the pulleys which direct the belt, in some embodiments dispensers are located along the belt but not near a pulley. In some embodiments pulleys and/or dispensers are located such that the carriers (which normally remain tangential to the belt) and bowls change orientation while progressing from one dispenser to another; this can help distribute ingredients throughout the bowl, rather than letting them pile up in one place. In some embodiments carriers (or bowls) can be actively rotated (e.g., by gear teeth, friction wheels, or other features on the carrier engaging rack teeth or other features on the plate or bulkhead, or using motors) to control ingredient distribution. Rotation of carriers/bowls while in the oven can improve heating uniformity, especially if microwave heating is used.

FIG. 29(c) is a close-up 3D view showing bowl 812 and carrier 814 positioned below dispenser 811a dispensing from chain 828a, while FIG. 29(d) is an elevation view showing two dispensers such as 811a and 811b, each in a different row, with bowls below. In some embodiments, the strip is reoriented by other rollers en route to the take-up roller (e.g., so that its inner, potentially contaminated surface is not facing down) and in some embodiments shields are provided below the strips which can catch any ingredient residues which may fall off the strip. When shields are used, then the strips may be advanced after peeling open a pouch completely, if there is enough space between pouches, so that contaminated portions of the strips are entirely above shields or other elements so that residues cannot fall into a bowl or elsewhere. In some embodiments the take-up rollers/spools are enclosed within cartridges which surround them in such a way as to minimize the possibility that ingredient residues can fall from the dispenser.

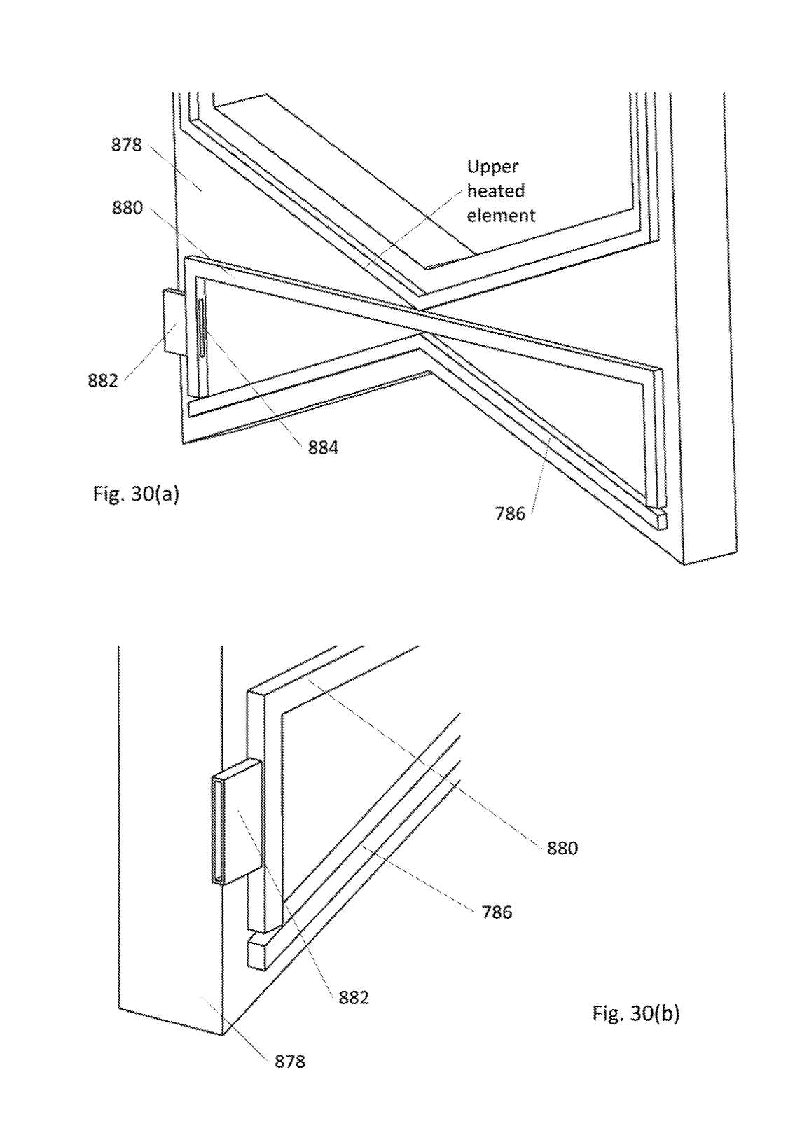

The freshness of certain ingredients, such as cut apples, may be prolonged if they are substantially isolated from oxygen. FIGS. 30(a)-(b) depict 3D views of a modified seal bar 878 similar to that of FIG. 25 but with the addition of a compliant seal 880 shaped like an inverted “U” or similar, having a plenum 882 with a port 884 that connects both sides of the seal, and with the lower seal intermittently heated (e.g., as with an impulse sealer) in some embodiments, though it can also be continuously heated as with the seal bar of FIG. 25. Such a seal bar may be used in some embodiments to extract air from a pouch before sealing it, and/or introduce a gas such as an inert gas (e.g., nitrogen) that helps to preserve the ingredient. The compliant seal is taller than the lower seal such that it forms a seal with the pouch before the lower seal elements have fully converged on the pouch, pinching off flow. After the first seal has been made as in FIG. 25(e), the pouch has been filled as in FIG. 25(f), and the strips have moved downwards as in FIG. 25(g), two seal bars like those in FIGS. 30(a)-(b) impinge on and clamp the pouch chain from opposite sides such that sides of the first seal are overlapped by the compliant seal, thus fully sealing the pouch due to the clamping force. At this time, air in the pouch may be withdrawn through the use of a vacuum pump plumbed to the plenum. If desired, once at least some of the air has been extracted, a gas such as nitrogen may be introduced into the pouch. Once this is complete, the seal bars can further approach one another, allowing the lower heating elements to clamp the pouch and then be briefly heated, sealing the top of the pouch as in FIG. 25. The chain can then advance downward and the cycle comprising 1) forming the first seal, 2) contacting the pouch with the compliant seal; 3) extracting air and optionally introducing a gas, 4) pressing the lower heated elements against the pouch and forming the second seal, and 5) indexing the chain, can then repeat.

### Fifth System

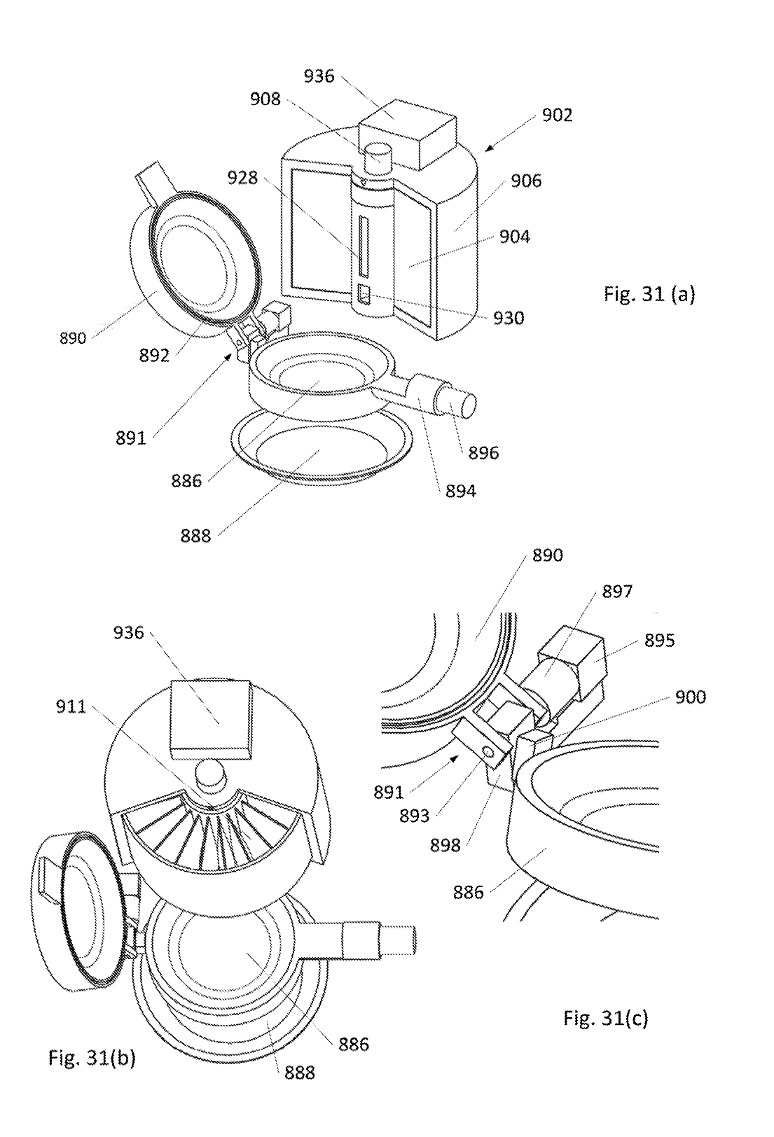

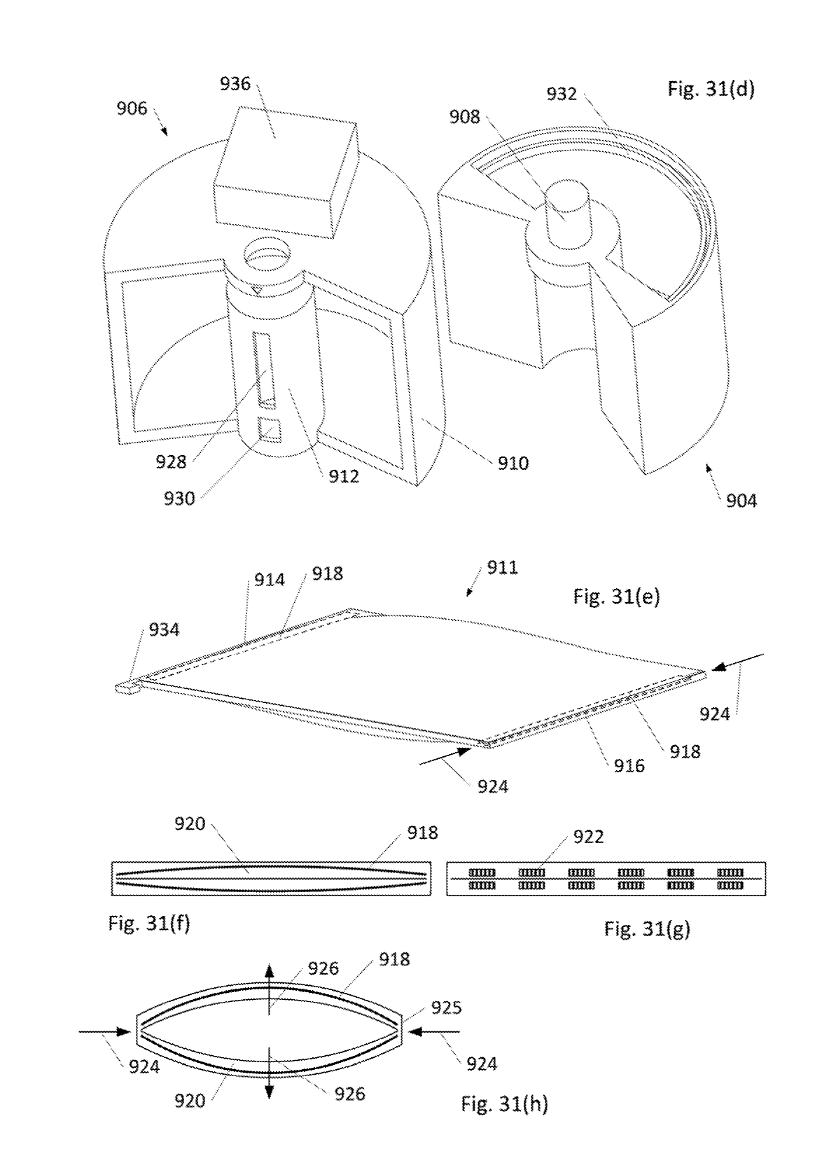

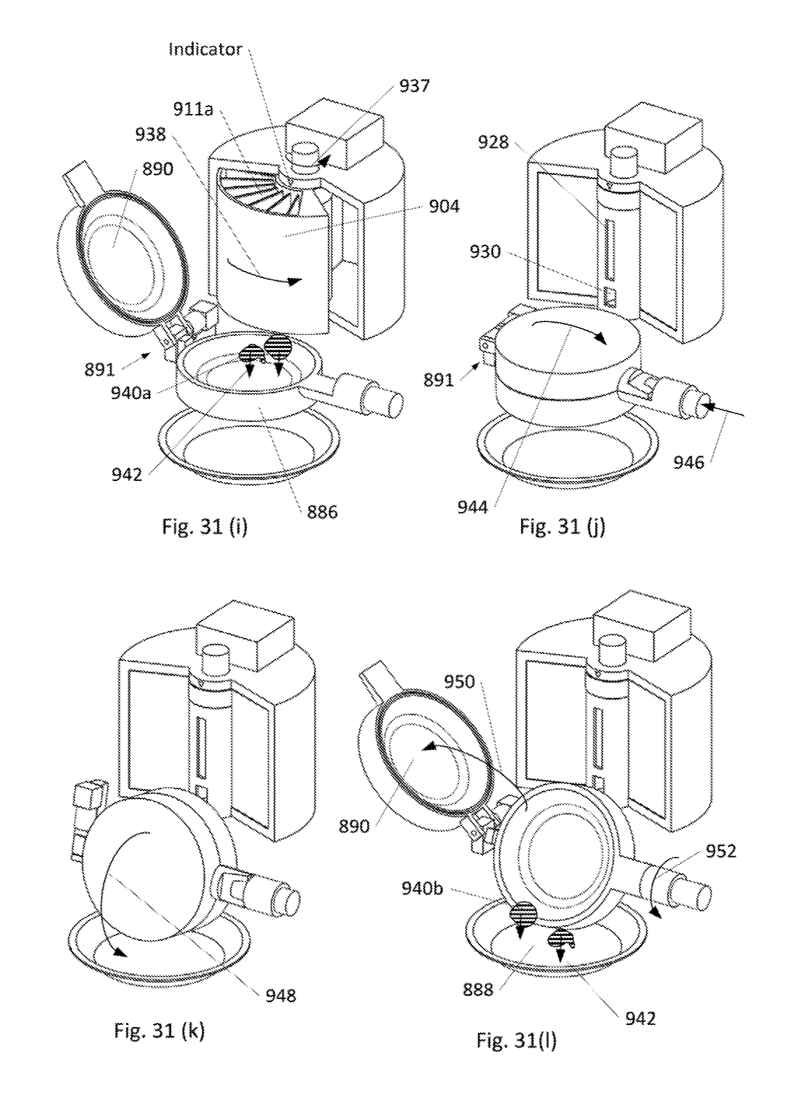

FIGS. 31(a)-(c) depict a compact automated appliance (e.g., for the home) according to some embodiments which is able to automatically cook foods comprising multiple ingredients. The 3D views of FIGS. 31(a)-(d) depict various components of the system. Not shown for clarity are housings and supports for various elements, nor electronics such as a controller and user interface (e.g., touchscreen). All functions are implemented by the controller (microcontroller, PLC, etc.) running programs in a suitable language to control actuators and process the data from sensors such as thermocouples. A heated (and/or cooled) vessel 886 is provided, which may be equipped with a liner (not shown) as discussed herein. The vessel may be heated by buried resistive elements known to the art. Below the vessel room is provided for dish 888 to receive the cooked food, as shown. Lid 890, optionally heated (and/or cooled) is also provided; it too may be furnished with a liner (not shown). The lid may include 0-ring 892 or similar to seal against the vessel when the lid is closed, and may be provided with an actuated lid pivot subassembly 891 (unlike the simple pivot of FIG. 20(a)) which may comprise motor 895 and gearbox 897 or another actuator that rotates the lid around a first pivot 893 to open or close it. The vessel (and when desired, lid) may be driven to rotate by a conventional actuator such as a motor (not shown) through an attached vessel shaft 894 supported by a standard bearing (not shown). The lid in some embodiments comprises an actuated latch 896 (e.g., a sliding wedge) to hold the lid tightly closed. The actuator and lid may be supported by a bracket 898 (FIG. 31(c)) which is articulated to the vessel through second pivot 900 (e.g., perpendicular to the first pivot), thus allowing the vessel to rotate without forcing the lid to rotate as well when the lid is open (e.g., FIG. 31(l)). An actuated extendible finger (e.g., from a conventional solenoid plunger, not shown) may be provided in some embodiments to stabilize the lid and lid pivot subassembly when the vessel is rotated, preventing it from rotating around pivot 900 due to friction. Electrical connections to the vessel (and lid, if applicable) heaters and lid actuator may be made through slip rings or other standard methods such as helical cable loops (e.g., if only several rotations are made in each direction). Near the vessel and lid is ingredient carousel 902 comprising rotor 904 and stator 906. The rotor is fixed to shaft 908 driven by an actuator such as a motor , (not shown) to spin the rotor. The stator comprises outer shell 910 as well as central core 912 (FIG. 31(d)), the latter, with its compact internal mechanisms, comprising at least a portion of a pouch dispenser.

The system comprises pouches 911 as shown in FIG. 31(d) which may be reusable or single-use, the latter similar to pouches described elsewhere herein. Reusable pouches may comprise two walls joined at their side (i.e., vertical) edges, and may have multiple compartments. Such pouches may also be loaded and unloaded through a single opening (e.g., outside the system), and thus not have an opening at their top. Pouches may incorporate zippers at or near their top edge 914 edge or bottom edge 916, or if the pouch or mating surfaces thereof is made from an elastomer (e.g., silicone), the pouch can remain sealed when top and bottom edges are tightly pressed together, i.e., by application of a force, which may be applied continuously when the pouch is not in use.

FIG. 31(e) depicts a 3D view of a pouch having internal springs 918 (e.g., insert molded leaf springs) within pouch wall 920 at the top and bottom of the pouch which are slightly curved as in the bottom (or top) view of FIG. 31(f) and pre-stressed so as to tend to straighten, providing a continuous force that presses the two walls together to form a seal. In some embodiments, magnets 922 as shown in the bottom/top view of FIG. 31(g) may also be used to press the walls together. When the pouch is subject to a compressive force shown by arrows 924 at its edges 925, then due to the curvature of the springs, the springs expand laterally as shown by arrows 926 in the bottom (or possibly equivalent top) view of FIG. 31(h), opening the pouch. When the top is opened, ingredients can be added (this may be done outside the machine), and when the bottom is opened (e.g., within the machine), they can be dispensed. In some embodiments the walls of the pouch are also peeled apart (e.g., by rolling them up and keeping them rolled until removal, to minimize contamination) to aid dispensing; reusable pouches can thus have elements such as zippers and magnets along the sides to allow these separate.

Core 912 of carousel stator 910 may be hollow and comprises in some embodiments upper slot 928 and lower slot 930 through which mechanisms (not shown) located within the core and used for ingredient dispensing (and optionally, loading) are deployed. In some embodiments the upper and lower slots are combined in a single slot. For example, a solenoid plunger may protrude through the lower slot to push on an edge 925 of the bottom of a pouch adjacent to the slot, forcing the opposite edge against the inside surface of the rotor and causing the pouch to open and dispense its contents. A pair of “squeezers” (e.g., small diameter rollers, blades, squeegees) to squeeze out flowable ingredients can be deployed through the upper slot to engage the pouch. For example, squeezers may deploy by rotating about a horizontal pivot near the top of the slot, press against the sides of the pouch, and then translate downwards, etc.; such motions may be implemented by separate actuators, cams and linkages, or combinations thereof. Or, squeezers may be located within the rotor at some (or all) pouch locations, or can be manually fit onto the tops of pouches needing squeezing. For squeezers located in the rotor, they may be oriented with their long axes horizontal near the top of the pouch (to insert or remove the pouch, they can be removed or pivoted temporarily). The spacing between squeezers is set to the thickness of the pouch when empty, ensuring the pouch can be completely squeezed. When a pouch is in position to be dispensed by squeezing (due to the pressure created, it may not need to also be pushed at its bottom to open it), a member may be actuated that extends through the upper slot and couples to the squeezers nearby; if the member is attached to an actuated linear stage, the squeezers can be made to descend and squeeze the pouch. Squeezers can also transferred from location to location automatically (including from a “dock”) by raising them above pouch level and rotating the rotor.

The rotor may include for example an L-shaped internal ridge 932 from which pouches can be hung by the user using an L-shaped hook 934 on the pouch. The controller may instruct the user to load pouches with known ingredients in particular positions. The ridge can include notches or detents to help position the pouches azimuthally in the desired location and prevent them from sliding along the ridge. If pouches are inserted with angles that vary from one to the other, as the rotor rotates the pouch positions may be detected such that the controller can record their angular positions and later position the rotor appropriately. The stator may include a cooling unit 936 such as a Peltier-effect device with fans and heat sinks to cool the interior of the carousel and keep ingredients in the pouches from spoiling during extended storage. The stator and rotor are designed to span less than 360 degrees (e.g., 220 degrees as shown) so that they form a closed temperature-controlled chamber and don't interfere with the vessel or lid when the rotor is oriented as in FIG. 31(a). As shown, the carousel can store the number of pouches needed to make one or more of a large variety of dishes, depending on carousel diameter. In some embodiments, other shapes (e.g., racetrack-shaped belts) may be used to expand the number of possible pouches. In some embodiments, in additional to pouches, the carousel can house tools in the stator such as contact and IR thermometers, and mixing and blending tools. In some embodiments, the vessel interior (or liner) can be actuated to rotate to allow ingredients to be dispensed and/or distributed in different regions.

The 3D views of FIGS. 31(i)-(l) depict steps in the preparation of a typical cooked food. In FIG. 31(i), the controller acting on a program which may comprise a recipe, has activated the lid actuator to open the lid had it been closed, and activated the carousel rotor actuator as shown by arrow 937 to rotate rotor 904 as shown by arrow 938, to a position that places a particular pouch 911a having a required ingredient adjacent to the stator slots 928 and 930 and above vessel 886, which may have a liner (not shown). The controller has also activated an actuator (e.g., extending through slot 930, to open the pouch (e.g. by pushing on edge 925), discharging (e.g., uncooked) ingredient(s) 940a which falls as shown by arrows 942 into the vessel or liner. Other required ingredients are similarly dispensed into the vessel. In FIG. 31(j), the controller has activated the rotor actuator to return the rotor to a position that reseals the carousel if desired, and which allows the lid to close. The controller then activates motor 895 of the lid pivot subassembly 891 to close the lid as shown by arrow 944. Then, an actuator (not shown, but which may comprise a solenoid, pneumatic cylinder, etc.) latches the lid tightly shut as shown by arrow 946 such that there will be no leakage between vessel and lid. In FIG. 31(k), the controller has activated the vessel shaft actuator to tumble the vessel (as described herein) as shown by arrow 948 to mix the ingredients, and if applicable has activated the vessel (and possibly lid) heater (this may have been done earlier) to cook the ingredient(s). In FIG. 31(l), the controller has stopped the vessel and lid from rotating, leaving the broad surface of the vessel substantially horizontal as in FIG. 31(i) and has also operated the latch actuator to release the lid, operate lid actuator motor 895 to open the lid as shown by arrow 950, and activate the vessel shaft actuator to tilt vessel 886 as shown by arrow 952, releasing now-cooked food 940b into dish 888 below as shown by arrow 942. While the vessel rotates, lid 890 remains in its normal position, prevented from rotating in some embodiments by the extendible finger. To finish the cycle, the controller activates the vessel shaft actuator to return the vessel to its initial position as in FIG. 31(i) (not shown).

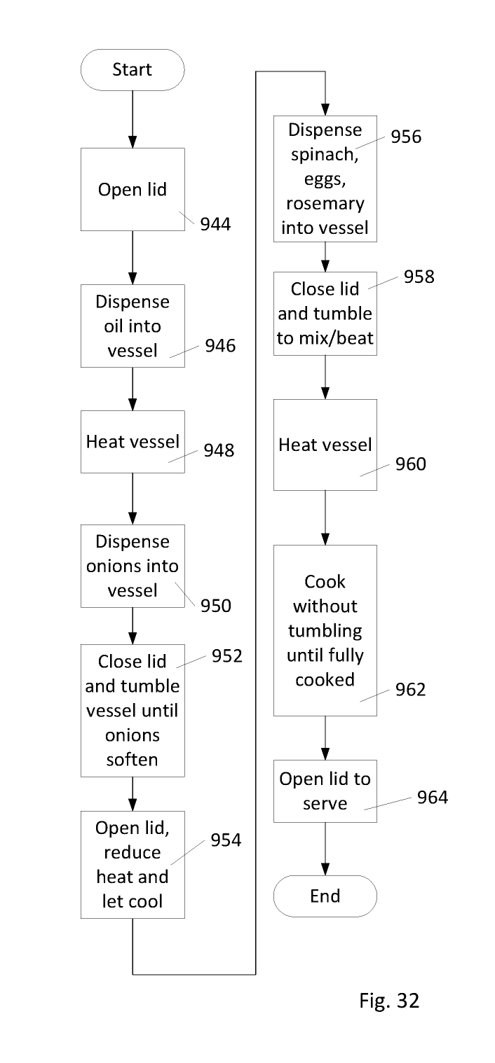

Examples of the many recipes that may be prepared by the fifth system include those involving eggs such as frittatas, sunny side up, and over easy/hard eggs; pancakes; soups and stews; dips; chili; stir fries; and recipes with meat, fish, poultry, and/or vegetables over noodles, rice, quinoa, etc. In the case of ingredients such as rice requiring the addition of water, this can be dispensed directly by the carousel using an external water line or reservoir, and if any excess water remains after cooking (as with pasta), it can be dumped by tilting the vessel into a bowl placed below by the user. The user can be sent a notification (e.g., via a mobile app) once the bowl is full, so it can be replaced with a dish that will receive the final meal. In some embodiments the dish may be automatically substituted for the bowl, or the vessel can tilt in the opposite direction than that shown in FIG. 32(l) to discharge water (or any excess liquids) into a receptacle adjacent to dish 888.

A flowchart describing the process for producing a spinach and olive frittata, for example, is shown in FIG. 32. All machine processes are governed by the controller according to one or more programs and associated algorithms, and implemented with the aid of sensors and actuators. After starting the process (which may involve add liners to vessel and lid), lid 890 is opened (Step 944) and a controlled volume of oil is dispensed into vessel 886 (Step 946) from a pouch (e.g., 911) or reservoir in the carousel after rotating rotor 904 to the correct position. The vessel (and optionally, lid 890) is then heated (Step 948) to a precise temperature (e.g., as determined by a thermocouple); the vessel may be tilted back and forth to help distribute the oil. In Step 950, a pre-measured quantity of onions (e.g., the full pouch, with onions diced to a particular average size and weighed) is dispensed into the vessel from a pouch. If there is a risk of excessive spattering of oil, the vessel can be heated to a lower initial temperature (or not at all) prior to adding the onions and closing the lid. In Step 952, lid 890 is closed and the vessel is tumbled in one direction, or bidirectionally, long enough to soften and optionally, caramelize the onions. The temperature of the vessel may be varied through this cooking step if desired. In Step 954, the lid is then opened and the vessel is allowed to cool until its temperature has decreased to a temperature lower than that which will denature/solidify egg protein. In this way, the eggs will not prematurely congeal and prevent mixing of all ingredients in step 958. In Step 956, spinach, eggs, and rosemary are dispensed into the vessel from pouches or (in the case of rosemary) optionally from a motorized spice grinder or shaker which may be incorporated into rotor 904. The eggs may be pre-beaten, or if tumbling step 958 is sufficiently vigorous, may become beaten during tumbling. In Step 958, the lid is closed and the vessel is tumbled to mix the ingredients and optionally, beat the eggs. The last step in “tumble-mixing” may comprise tilting the vessel from side to side over a small angle and/or rapidly oscillating it around shaft 894 to help distribute the ingredients uniformly throughout the vessel. In Step 960, the vessel is heated to a relatively low temperature suitable for cooking and browning a frittata without burning it, and cooking proceeds. Since all ingredients are already mixed and the eggs will shortly congeal, the vessel is not tumbled, though it may be tilted from side to side over a small angle. If desired, after the frittata has congealed at least partially, and if lid 890 is hot enough to help cook the ingredients, the vessel and lid may be inverted. Once the eggs and other ingredients have fully cooked as in Step 962, the heater is turned off if the meal will be served immediately, or set to a low, keep-warm temperature. In Step 964, when it is time to serve the meal, the lid is opened. The vessel or its liner can then be removed from the machine, or the frittata can be served while the vessel is still in the machine.

### Ramifications

Ingredients can be dispensed not only into dishes but also into vessels, pouches, or other receptacles in which further processing such as heating is then performed. Ingredients can also be dispensed onto ingredients already in a receptacle (e.g., such as cheese dispensed onto a slice of bread).

To control the location of a dispensed ingredient the pouch may be unsealed so as to limit the size of the opening produced, and the receptacle may be positioned underneath in at least one particular location, or moved in a manner which is coordinated with the action of the dispenser.

The pouch manipulator of FIGS. 4(a)-(n) need not necessarily dispense entirely on its own: it's primary functions may be to grasp and transport the pouch, and a dispenser may separately be provided which performs at least a portion of the function of dispensing.

In some embodiments the food preparation system can be refrigerated (including the portion of the system where processing is done and/or storage areas).

Vessels (e.g., liners) may be equipped with porous inserts such as colanders, steam baskets, trivets, etc. in order to drain cooking liquid, steam ingredients, etc.

Pouch peeling as is described in conjunction with FIGS. 24 and 27 may be implemented in any of the systems described herein, in other systems representing combinations thereof, etc.

Pouches in some cases may be made from permeable materials (e.g. to release gases such as ethylene produced by ripening fruit) or made from less permeable materials that have been perforated (e.g., by laser).

In some embodiments, pouches can be shaped in the form of high aspect ratio, elongated belts or webs that are divided transversely and/or longitudinally by seams or barriers. Ingredients can be released from such belts along one or both exposed edges by peeling, cutting, unzipping one or more zippers, etc., preserving the belt format, or each compartment can be cut or torn off (e.g., if perforated) off before or after dispensing its contents. Belt-like pouches can be stored on reels if desired.

Pouches may be opened or partially opened (or their walls perforated or cut) over waste bins or similar so as to allow liquid contained within them, which may be used for packing and preservation, to be drained. Examples of ingredients which may require draining before use are tuna in broth, water, or oil; beans, olives, meats, and fish. Ingredients within pouches may be squeezed by external pressure applied to the pouch, or tensioning of the walls, to retain solids while discharging excess liquid.

Pouches even without peelable seals, internal zippers, temporary seals, etc. do not necessarily have to be inverted. For example, an ingredient may be totally dry and non-adherent so it can't contaminate the cutting tool.

Cooking inside vessels can involve the use of moist heat, dry heat, or both, with or without fat.

In some embodiments, ingredients within a pouch can be pre-cooled or pre-heated before dispensing. For example, oil may be semi-solid if kept in a refrigerated chamber/tank when not in use, and warming it can reduce its viscosity and facilitate spraying (onto an ingredient, into a vessel used for cooking, etc.) Such temperature changes may be provided by moving the pouch into a chamber or liquid-filled tank set to the appropriate temperature, by directly heating or cooling the pouch (e.g., an infrared light shining on the pouch, or electric heating elements surrounding the pouch while it is held in a pouch manipulator) or similar, etc.

In some embodiments the food preparation system may include subsystems which grow food, for example, hydroponic or other methods with suitable illumination to grow vegetables and fruit, bioreactors to grow animal-based protein, etc.

In some embodiments customers using vending machines as described herein may use a mobile app or Web site in which nutritional goals, dietary preferences, type of cuisine, etc. can be entered, and/or which recommends nearby vending machines based on GPS data, then allowing orders to be entered for pickup or delivery.

In some embodiments vending machines as described herein may be built into restaurants and accessible from the outside when the restaurant is closed or busy, much like an automated teller machine allows certain banking transactions. Restaurants can of course easily keep such local machines supplied with ingredients.

In some embodiments the entire interior of a food preparation system (and supply cases if used) can contain an inert gas/modified atmosphere, allowing less costly, more readily recyclable and thinner pouches, since isolation from oxygen is not necessary.

In some embodiments vending machines as described herein may be deployed as outdoor, weatherproof kiosks, including drive-up kiosks, allowing orders to be placed (or just picked up) in a “drive through” manner.

In some embodiments of the bowlbot, pouches are not in the form of a chain and are individual, or are in the form of a chain but are then, using suitable mechanisms, separated from the chain as needed, transported above the bowl and opened (and also inverted if needed), then disposed of.

The system may provide notifications (e.g., via the Internet) when foods are ready, when it runs out of ingredient, of any problems encountered, of a need for maintenance, etc.

In-pouch mixing, blending, separating, etc. can be achieved by tumbling the pouch, by accelerating/centrifuging it, by introducing sonic/ultrasonic energy, by rolling over it multiple times with an interrupted roller (one with gaps or two different diameters that alternate along its length). Such a roller can also translate axially between each rolling operation or rotate about an axis perpendicular to the pouch major surface to changes its angle .

To promote mixing pouches may include baffles, screens, etc. which behavior similarly to static mixers; these cause the contents to mix when they are forced past them.

Juices, etc. can be extracted from ingredients in pouches by subjecting the pouches to crushing and/or rolling forces of sufficient magnitude. Other ingredients such as nuts and corn flakes can also be crushed in-pouch.

Vessel liners drawn to bases by vacuum may allow higher temperature sautéing and frying, for example since heating can be rapidly interrupted and cycled by reintroducing air and then evacuating it again from the space between liner and base. This also provides more control over heating, and the vacuum level can be adjusted to intermediate values to provide intermediate levels of conduction, or of texture: for example, if the base has ridges, these can be imposed on the liner under higher vacuum, while conversely, if the liner has ridges, increasing vacuum level can flatten these out against a flat base surface.

The space between liner and heated (or cooled) base may be filled with a foam, woven/non-woven matt, thermally-conductive silicone, etc. such that as vacuum is applied, the filling material collapses and increases its thermal conductance.

Sensors may be used for a variety of functions in some embodiments such as 1) the edge of a sealed pouch can be detected (e.g., optically) to know where to cut it; 2) the stiffness and/or thickness of a pouch can be used to determine when it is no longer under vacuum; pouches can also have a small “blister” which indicates if vacuum is present (e.g., changing the blister from convex to concave); damaged/leaking pouches can be rejected; 3) weight measurements can be performed not just on a pouch discharging ingredients, but also on one receiving them, or on a vessel or other container discharging or receiving ingredients; 4) when using powered tools (e.g., for mixing), speed and/or torque can be sensed, as these can vary according to the state of the ingredients, to help fine-tune the processing, run it closed-loop, and determine when the process should be ended; 5) vacuum sensors can be used to ensure that grippers, platform, printhead plate, etc. have adequate vacuum; 6) temperature sensors such as thermocouples, RTDs, and thermistors can be built into vessels, impulse sealing apparatus, cold and freezer storage areas, etc. Sharp probes to measure internal temperatures can be inserted into ingredients; pressure or vacuum sensors may be used to verify sealing (e.g., of a lid crimped to a liner) e.g., before tumbling; also, a liner sealed to another liner can be deformed elastically and the time for it to recover measured (e.g., optically); if too long, it may indicate a leak; 7) pressure or force sensors may be incorporated into grippers; 8) storage areas may include humidity sensors; 9) liquid or solid (e.g., granular solid) levels (e.g., in a container or pouch) may be measured by sensors such as capacitive (e.g., with electrodes built into the container or pouch), optical methods, acoustic methods, etc.; 10) waste bins can include a sensor detecting a near full or full condition; 11) the presence of ingredients inside pouches (e.g., pouches expected to be empty) as well as the detection of incompletely stirred/blended ingredients, contamination or spoilage of an ingredient, etc. can be detected (e.g., by a camera with machine vision); 12) the cleanliness of a cleaning solution may be determined (e.g., by measuring turbidity, pH, and/or conductivity; 13) the intensity of UV used for sterilizing, or infrared used for drying, can be sensed.

With the goal of minimizing contact between apparatus and ingredients, food preparation processes that can be done in-pouch include:

1) Stirring, beating, mixing, whipping, tossing (e.g., of salad ingredients with dressing), coating (e.g., of chicken legs with breadcrumbs), and other processes implemented by accelerating, shaking, tumbling, twisting, bending, and performing other manipulations of the pouch, including using acoustic energy, or by using a stir bar, balls, etc. which cannot escape the pouch (e.g., because the opening of the pouch is smaller). A magnetic stir bar may be used or non-magnetic balls or bars may be manipulated by external vibration or other actuation to mix ingredients. Pouches can also be shaken, inverted, flipped horizontally and then vertically, folded, etc. to help process ingredients. Pouches or regions thereof can be made from elastomeric materials which allow significant distortion of the pouch during operations such as mixing without risk of pouch rupture. Planetary/dual asymmetric entrifugal mixing can also be performed, of the kind implemented by SpeedMixers (FlackTek, Landrum, S.C.).

2) If a small vent is provided (e.g., cutting the pouch corner, cutting a slit, intentionally bursting a seal or region thereof) to allow vapor to escape, then ingredients may be dehydrated or reduced inside the pouch.

3) Ingredients such as butter may be separated in-pouch, with pouch features such as internal skimmers, multiple outlets (e.g., peel-off strips, cuts or perforations) which allow components to be separately removed, or allow some components (e.g., butter fat) to be removed selectively, leaving behind other components (e.g., milk solids and buttermilk).

4) Ingredients in pouches can be heated by immersion into hot water, hot air, IR radiation, conductive heating (e.g., with polyimide or silicone heating pads on the pouch walls, or resistive wires embedded in the pouch walls). This can be useful for ingredients which can be softened or melted in order to flow properly (e.g., cheese, chocolate, butter).

Pouches may deform plastically at least in part when compressed, if for example metal is included in the pouch wall, or a polymer pouch is heated to a sufficient temperature.

Pouches may be designed to expand when processing occurs within (e.g., microwave heating of popcorn).

When used, vacuum pouches and films with smooth inner surfaces can be sealed in a vacuum chamber or using a snorkel sealer instead of a sealer requiring a textured inner surface; this can avoid waste of certain ingredients (e.g., flowable ingredients) which may be trapped within the textured surface.

The shape and aspect ratio of pouches may vary widely; for example, a pouch shaped like a toothpaste tube is an option.

Pouch contents can be expelled not only by compressing (e.g., rolling over) the pouch, but also by rolling or folding the pouch itself. For example, the pouch can be inserted into a slot in a rod that is then rotated, causing the pouch to wrap itself around the rod while squeezing out the ingredients.

A system might have more than one pouch containing the same ingredient in different forms, or with a different size or type of opening, nozzle, etc. to dispense it.

The temporary seal of a pouch containing a dry ingredient might be a seal that is perforated (e.g., sealed as a dotted or dashed—vs. continuous—line).

Systems which perform cooking may be equipped with smoke and flame detection and automatic fire suppression equipment for safety.

It may be useful if the pouch manipulator can handle several pouches with different ingredients simultaneously, since otherwise the system may need to temporarily store a pouch that it will use again later for the same recipe, adding to the overall time to prepare the meal, etc.

Pausing/slowing down cooking by introducing air between liner and base can help, however, to adjust cooking times, and can be useful in coordinating the preparation and delivery time of multiple portions of a meal.

Ingredients need not be dispensed from pouches (or other containers) as described above; rather, Archimedes screws, suction tubes and siphons, scoops, etc. can be introduced into, for example, pouches which are open at their top edges, to remove ingredients. For example, small solid ingredients such as nuts might be dispensed using a vacuum pickup: the pickup (which might have a large open surface covered by a wire mesh to prevent ingredients from entering) can pick up a monolayer of ingredients, and a repeatable amount in terms of width and length (covering all exposed areas of the wire mesh). Once positioned over the receiving area (e.g., a layer in an energy bar), the vacuum can be turned off to deposit the ingredient.

Pouches can be made with more than two walls, e.g. three or four, with the space between neighboring pairs of walls holding ingredients (either different or the same in each such space). All walls can be sealed together at the pouch edges, though in some embodiments some of the interior pouches can be smaller than other pouches.

Pouches need not be rectangular; they may be shaped as cones, cylinders, etc., as long as they can be emptied by compression (e.g., using a roller), by twisting, by pushing a sliding element (e.g., a ring, or an external, built-in squeegee) toward the pouch exit, etc.

Pouches can include internal Pachinko-like elements, diagonal (or parallel) ramps alternating from side to side, vertical walls subdividing the pouch into a set of tubes, internal sieves, internal rough textures, etc. (at least several of which can be made using impulse or ultrasonic sealing) to slow down the flow of material (solid or fluid) through viscous drag and surface tension effects, and avoid self-emptying. For example, pouches can have multiple, crushable sieves (attached to the pouch walls, or just placed inside the walls), made from a material that springs open so that fluid can pass through them. Toward the bottom of the pouch, since the pressure is higher, the holes/passageways can be smaller, more widely-spaced, etc.

Ingredients need not be in separate compartments within a pouch as in FIG. 8 in order for them to be released gradually: the pouch can be rolled or folded (e.g., pleated like an accordion) such that as it unrolls or as its pleats straighten out, ingredients are released. Or, the pouch can be wrapped around a structure or compressed by an external structure that isolates regions of the pouch, allowing isolated regions to yield their contents without the entire pouch doing so.

Pouches might not be of uniform thickness; thickness may be tapered in any direction, or modulated to create local variations and even “lumpiness”. Some of these variations can compensate for undesirable variations in flow rate, or intentionally cause variations in flow rate.

Pouches need not be opened at all if they are made from a permeable material (e.g., perforated, or made from a porous material (e.g., similar to that used in tea bags). Such pouches may contain herbs, tea, bay leaves, cinnamon sticks, etc. In some embodiments such permeable pouches may be contained within impermeable pouches to protect them and keep the ingredients fresh: the inner pouch need not necessarily be removed from the outer pouch to fulfill its role of modifying (e.g., coloring, flavoring) a liquid if the liquid is allowed to enter the outer pouch. Permeable pouches which are released into a vessel, for example, can be retrieved after they have had the desired effect.

The flow from a pouch may not be linear with roller displacement. For example, if the pouch is not horizontal, gravity causes the bottom of the pouch to bulge more than the top, so the cross-sectional area of ingredients changes with vertical position and flow per unit of roller travel is higher near the bottom. A pouch can be made more linear in flow behavior if desired by varying its stiffness (e.g., wall thickness) and/or width (e.g., as defined by an internal seam and/or its external shape) (e.g., making the pouch wider at the top than at the bottom), or variable speed dispensing can be used.

Pouches can be cut or perforated at or near the top, or a peel-off element can be removed, to vent them so that internal vacuum which may interfere with delivery of ingredients can be avoided, or to vent steam.

Pouches may be cut in a non-contact fashion by an energy beam such as a laser which ablates, melts, burns, or otherwise alters the pouch material where it is directed.

Pouches may be made tearable or pierceable by locally (or globally) incorporating thin material (e.g., plastic or foil). Pouches which include a notch, perforation, or other defect to allow a tear to start, can be opened by grasping the appropriate portion of the pouch; when tearing a pouch the nearby portion of the pouch may be restrained (e.g., clamped by an external clamp) so as to prevent motion and help provide a guide for the tear, thereby controlling its trajectory.

Pouches (especially for a high-volume food preparation system) can be in the form of a continuous belt with compartments that are cut/torn open as needed (unless permeable) to allow ingredients to exit.

Pouches can have internal ribs (e.g., vertical) or other projections or textures which facilitate draining of excess liquid and reduce surface area contact, allowing ingredients to slide out more easily.

Pouches containing soft ingredients can be boxed or inserted into another structure which protects them from crushing after packaging. For pouches that are not evacuated, the pouch can be filled with air (or modified atmosphere) such that it expands like a pillow, providing crush resistance and protection for the ingredients inside (similar to the packaging of some potato chips). Pouches with delicate ingredients which are to be vacuum sealed can use internal (or external) supports that prevent crushing or distortion of the ingredients during the sealing process. Such ingredients might also instead be packaged with a modified atmosphere in lieu of with vacuum.

Pouches need not be flat and in use (e.g., while dispensing ingredients) may be curved into cylindrical or other shapes. Pouches need not be entirely made of compliant and flexible material but may be made at least in part of more rigid materials.

Some ingredients might be packed in pouches in a way that facilitates their dispensing. For example, sliced mushrooms which are to be distributed around a pizza might be packaged in a single layer in a pouch which is not allowed to expand beyond the thickness that accommodates a single layer (it may be vacuum packed, or constrained within exterior packaging, e.g., cardboard) so that slices cannot move to overlap other slices. Then, if the pouch is opened (e.g., on its edge), and the pouch is suitably constrained from expanding (since once open, vacuum will no longer constrain it), the slices can be pushed out in a controlled way (sliding sideways along the pouch walls).

In some embodiments, tools such as those in FIG. 16 may be used inside pouches. Such tools may be equipped with guards, or the pouch may be kept (e.g., by vacuum) away from the tool as it moves. Thus in-pouch whisking, blending, etc. may be performed.

The system may monitor the age and condition of ingredients and suggest recipes (or prioritize recipes, if these are being cooked automatically on a random/revolving basis) which use up ingredients which are going to spoil sooner, minimizing food waste.

Blades/tools for blending, mixing, whipping, etc. can be collapsible/flattenable, and expand centrifugally, using springs, or by direct manipulation. If tools can collapse more or less flat, then one can more easily clean them and with less material waste, e.g., by rolling a soft rubber roller over them, for example just after they are withdrawn from the processed ingredients and while they are still within the pouch. If designed to spring open, then once they are removed from the pouch, they can be cleaned by spraying, immersion, etc. Prior to this, the action of the roller running over them can help to clean them. Alternatively, if the pouch or vessel is tall enough, then running the tool at very high speed once it is withdrawn from the ingredients (and still within the pouch or vessel) will at least partially clean it, and return ingredients which were on it to the pouch or vessel.

Pouches can be everted (turned inside out) to release ingredients.

In some embodiments rather than collect the strips comprising pouch chains onto rollers or spools in the dispensers, they are returned to the supply cases below, or collected above the dispensers. Sealing together strips that had been peeled may be done in some embodiments in order to reduce potential messiness if needed.

In-line cleaning methods may be used before strips are collected onto rollers or spools, such as water rinses, vacuum pickups, dryers, and others. Such methods may help preclude residues falling off of strips and entering a bowl.

Due to the isolation of ingredients in pouches/pouch chains, a given vending system may serve customers with and without certain dietary requirements such as allergies and religious dietary laws. For example, a single system might be able to serve a bowl containing kosher chicken in a peanut sauce as well as a bowl containing pork to a customer with a nut allergy.

Bowlbots and other systems can be viewed as a “restaurant in a box”, and can change the recipes and even types of cuisine they supply by simply receiving another set of recipe instructions and if needed, different ingredients. Such changes can be made on a frequent (e.g., daily) basis.

Pouches can be within other pouches. The outer pouch can be pressurized to dispense inner pouch contents (e.g., through a hole, an extrusion nozzle, or a spray nozzle).

Peelable seals may be made wide to reduce the risk of bursting during handling or due to the weight of other pouches on top of them (e.g., if pouch chains are folded in the supply case). Peelable seals may also be made multiply- redundant (e.g., two seals, one outside the other) such that if one bursts prematurely, the other will continue to seal the pouch, especially if the internal pouch volume has been enlarged by failure of the inner seal. Since a burst side seal is usually more problematic then a burst top or bottom seal, the side seals can be made stronger (e.g., wider, double) than the top and bottom seals, since a burst top or bottom only allows the contents of adjacent pouches to intermix and doesn't cause a leak outside the chain. Since side seals are perpendicular to the peeling direction, they are relatively easy to peel and making them stronger may be acceptable. In some embodiments in addition to and external to the peelable side seals, strong non-peelable seals may be formed. Then, once the chain has exited the supply case and before the strips are to be peeled apart within the dispenser, these extra seals can be cut off (e.g., by sliding the chain past two knife blades); this can be done as a continuous process, and since the inner peelable seal retains the ingredients, the cutting tool remains uncontaminated.

Pouch chains may be marked with graphical elements and identified by human-read codes, barcodes, QR codes, NFC or RFID devices, etc. Identification can be at the level of the entire chain, or at the level of individual pouches, and include such data as ingredient, date packaged, “best before” date, lot number, packaging equipment used, etc. Identifying data can be read by the bowlbot using appropriate sensors in order to determine whether the correct chain is loaded in the correct dispenser, whether the ingredient has expired, etc. Sensors may also be provided to determine whether a vacuum packed pouch has become perforated and is no longer vacuum packed, or there has been a leak of moisture from pouches that are not vacuum packed. This assessment may be performed while loading the chain into a supply case, but it may also be performed within the bowlbot. If a pouch that should not be used is detected within the bowlbot, a standard bowl (or a specialized bowl) may be added to the belt conveyor (in a carrier), used to receive the defective ingredients, and then be disposed of; this allows the pouch chain to advance through peeling to the next pouch without consequence.

Pouches folded in a zig-zag fashion (e.g., in a supply case) should have empty space between them along the length of the chain, so all folds can lay parallel to one another. If chevron seals are used at the top of the pouches and the pouches are not overfilled, then the region of the chevron seals can provide this space. Folded pouches can be supported by shelves (e.g., within a supply case) so that the weight of the upper folds (assuming horizontal folds) does not excessively compress the lower pouches and risk bursting the peelable seals; these shelves can be spring-loaded and flip upwards and out of the way as the chain is withdrawn.

Pouches can contain oxygen absorbing materials to keep ingredients fresher; these can be retained inside the pouch or attached to the materials that comprise it, avoiding the possibility of these materials being dispensed along with the ingredients.

Pouch chains may be able to spliced to other pouch chains, allowing a chain deemed to be too short (containing too few pouches) to meet the anticipated needs before the next chain is installed in the bowlbot, to be lengthened. Splicing can be achieved using tape, heat sealing, etc., and may be performed at the “tail” end of the current chain so that pouches in the current chain are used first, rather than those of the newly-spliced chain (assuming the latter's ingredients are fresher). If chains are folded, folding can be done in a fashion that the tail end remains available. If chains are rolled on a spool, then the new chain can be spliced onto the end opposite the tail end (the tail end having the smallest radius on the spool) and then rapidly transferring the chain to another spool (e.g., in another supply case) through a winding process which leaves the tail end at the outside of the winding rather than on the inside.

In some embodiments pouch chains are not split into two strips using peelable seals. Rather, pouches comprise flaps with seals (e.g., peelable, and optionally resealable) on some (e.g., three) sides. Opening these seals allows ingredients to be discharged (at any desired position and orientation of the chain) and allows the pouch to remain attached to the chain. Re-sealable seals allow the pouch to be closed after discharging ingredients, retaining residual ingredients internally.

In some embodiments pouch chains are connected to one another only along one edge, allowing them to be opened along the opposite edge, rather than being opened by completely peeling apart two strips.

Since the density of water is a function of temperature and purity, in some embodiments pouch chains may be immersed in a refrigerated bath with various temperature zones arranged along a vertical axis, i.e., a vertical gradient can be established within a tank with the bottom being below freezing and the top being cool or even warm. For example, dense salt water at the bottom can be cooled to a temperature below freezing, while pure water above it can be at a temperature above freezing and water above that can be warmer still. To minimize mixing between these layers, structures such as brushes can be used within the vat. Viscosity increasing chemicals may also be added to the water to reduce the Reynolds number. With such a setup, it is possible to withdrawn a pouch chain from a tank slowly, and have it gradually warm up from a frozen state such that by the time it emerges from the tank, the contents are defrosted and even warm/ready to serve.

In some embodiments rather than dispense ingredients from pouches, they are dispensed from tubes (e.g., cylindrical) whose ends are facing upwards and which are equipped with pistons which raise the ingredients such that they fall out of the ends. Alternatively, tubes shaped like inverted letters “U” or “J” can be used, such that ingredients pushed upwards by the pistons are guided downwards as they fall.

In-pouch processes on closed pouches may be conducted, such as crushing ingredients to produce a juice; tumbling, shaking, centrifuging, or planetary mixing of pouches which mix, beat, or froth ingredients; coating or dredging one ingredient with another, etc. Such processes may be performed within the pouch originally containing a given ingredient, or in a pouch into which one or more ingredient has been transferred. For example, eggs may be beaten, chicken breast may be coated with breadcrumbs, and salad dressing may be made (by adding ingredients such as oil, vinegar, chopped shallots (which might already be in the pouch), salt, pepper, and mustard, to a pouch and then vigorously tumbling/shaking it), all within a pouch.

### Controller

The control of the apparatus and the implementation of the methods and steps described herein may be achieved using hardware, software, or any combination thereof, together forming a controller or control system. The term “hardware” may refer to either one or more general or special purpose computers; microcontrollers; microprocessors; programmable logic ontrollers (PLCs); programmable automation controllers (PACs); embedded controllers; or other types of processor, any of which may be provided with a memory capability such as static or dynamic RAM (random access memory); non-volatile memory such as ROM (read only memory); EPROM (erasable programmable read only memory), or flash memory; magnetic memory such as a hard drive; optical storage media such as CD (compact disc) or DVD (digital versatile disc); etc. The term may also refer to a PAL (programmable array logic) device, an ASIC (application specific integrated circuit), an FPGA (field programmable gate array), or to any device capable of processing and manipulating electronic signals.

The term “software” may refer to a program held in memory, loaded from a mass storage device, firmware, and so forth. The program may be created using a programming or scripting language such as C, C#, C++, Java, Python, PHP, JavaScript, LabVIEW, MATLAB, or any other programming or scripting language, including structured, procedural, and object oriented programming languages; assembly language; hardware description language; and machine language, some of which may be compiled or interpreted and use in conjunction with said hardware.

The control system may serve to load files, perform calculations, output files, control actuators such as motors, voice coils, solenoids, fans, and heaters, and acquire data from sensors, to automate or semi-automate apparatus which can implement the methods and steps described herein. Each method described herein, including any sequential steps that may be taken for the method's implementation and any modification of the behavior of the apparatus or control system as a result of human or sensor input, as well as combinations of such methods, may be implemented and performed by the control system, executing a program, or code, embodied in the control system. In some embodiments, multiple control systems may be employed, and portions of the functionality of the control system may be distributed across multiple pieces of hardware and/or software, or combined into a single piece of hardware running a single piece of software.

### Terminology

The term “ingredient” or “ingredients” refers to one or more distinct, edible food items used in the preparation of a an item to be consumed, and the term “food product” or “food products” refers to one or more edible food items ready to be consumed. The singular and plural forms of both phrases may be considered interchangeable, and the phrases themselves may not always be strictly applied herein and may be considered at least in some situations to be interchangeable.

The term “pouch” generally refers to a flexible package comprised of one or more materials in film form such as polymers and/or metals, but may be understood in some cases to refer to other containers, including ones which are more rigid.

The term “vessel” generally refers to a container able to hold ingredients/food products for purposes of storage, processing delivery/presentation/consumption, etc. and may be interchanged in many cases with other containers having similar functionality.

The term “dish” generally refers to a receptacle or vessel for serving or eating or drinking food, such as bowls, plates, cups, mugs, and glasses.

The term “meal” generally refers to one or more food items delivered for consumption, possibly involving processing of various kinds.

“Proximate” or “in proximity to” generally refers to close enough to achieve the required functional purpose, for example, in the context of a dispenser or dispensing system, it refers to a distance comparable to a dimension of a typical pouch and more preferably within a smaller distance.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature.

### General

Figures within this application are not necessarily to scale.

Motions are considered relative. Thus if object A moves relative to object B which is at rest, the equivalent effect of object B moving relative to object A which is at rest is also contemplated in the disclosure.

It will be understood that particular embodiments described herein are shown by way of illustration and not as limitations of the disclosure. The principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

It is intended that the aspects of the invention set forth herein represent independent invention descriptions which Applicant contemplates as full and complete invention descriptions that Applicant believes may be set forth as independent claims without need of importing additional limitations or elements, from other embodiments or aspects set forth herein, for interpretation or clarification other than when explicitly set forth in such independent claims once written. It is also understood that any variations of the aspects set forth herein represent individual and separate features that may form separate independent claims, be individually added to independent claims, or added as dependent claims to further define an invention being claimed by those respective dependent claims should they be written.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims presented hereafter.

1. A method for automatically transferring at least one food ingredient within at least one sealed flexible package to a receptacle, comprising:
(a) providing ingredient dispensing means, the dispensing means comprising an actuator-operated mechanized means for unsealing the at least one package;
(b) automatically operating the mechanized means to unseal the at least one flexible package;
wherein the at least one food ingredient is substantially dispensed from the unsealed package into the receptacle.

2. The method of claim I further comprising providing a temporary storage location for at least one sealed flexible package that contains at least one food ingredient.

3. The method of claim 2 further comprising causing an actuator to operate a mechanical means far conveying the at least one sealed package from the temporary storage location to a location more proximate the receptacle.

4. The method of claim 1 further comprising providing compressing means and operating the compressing means to compress the at least one package to assist in dispensing the at least one ingredient.

5. The method of claim 1 further comprising providing a blade, and relatively moving the blade and the package such that at least a portion of the package is moved around the edge of the blade to assist in dispensing the at least one ingredient.

6. The method of claim 1 wherein the package has at least two sides and wherein the means for unsealing comprises gripping means for grasping at least one side of the package, and peeling means for pulling the at least one side of the package away from another side of the package.

7. The method of claim 1 further comprising determining whether the ingredient is flowabie and compressing the package if the ingredient is flowable.

8. A method for dispensing a food ingredient from a package, comprising:
(a) providing a sealed package containing a food ingredient wherein the package comprises at least one flexible film divided into a left portion and a right portion with each portion having an inside and an outside surface with the inside surfaces facing each other and at least a portion of the inside surfaces contacting the ingredient and wherein the portions are sealed to one another to form at least one cavity containing the at least one ingredient and wherein adjacent to the at least one ingredient, the sealing comprises at least one operable seal;
(b) providing at least one blade having a lower edge, a near side, and a far side;
(c) passing an outside surface of a lower region of one of the portions adjacent to the near side and around the lower edge of the at least one blade to redirect the lower region of the portion to the far side in a direction different than that of the region on the near side of the at least one blade;
(d) tensioning the lower region on the far side of the partrsrn anti pulling it atound the edge while lowering the package relative to the at least one blade;
wherein the seal is opened and at least a portion of the ingredient is dispensed.

9. The method of claim 8 wherein the at least one operable seal joins the portions around at least part of the sides of the at least one ingredient as well as beneath the at least one ingredient and wherein the method further comprises pulling the lower region around the edge enough to at least partially separate the portions on the sides of the at least one ingredient.

10. The method of claim 8 further comprising continuing to pull the lower region around the edge to further separate the portions, wherein at least some of the ingredient adhering to the inside surface of the portion are detached from the surface.

11. The method of claim 10 wherein at least some of the ingredient comprises substantially all of the ingredient,

12. The method of claim 10 further comprising:
(a) providing at least one second blade having a lower edge, a near side, and a far side_{;}
(b) passing an outside surface of a lower region of the other portion adjacent to the near side and around the lower edge of the at least one second blade to redirect the lower region of the other portion to the far side in a direction different than that of the region on the near side of the at least one second blade;
(c) tensioning the lower region on the far side of the other portion and pulling the lower region of the other portion around the edge of the at least one second blade white lowering the package relative to the at least one second blade;
wherein the seal is opened rind at least a portion of the ingredientis dispensed.

13. A method for dispensing a food ingredient from a package, comprising:
(a) providing a sealed package containing a food ingredient wherein the package comprises at least one flexible film divided into a left portion and a right portion with each portion having on inside and an outside surface with the inside surfaces facing each other and at least a portion of the inside surfaces contacting the ingredient and wherein the portions are sealed to one another to form at least one cavity containing the at least one ingredient and wherein adjacent to the at least one ingredient, the sealing comprises at least one openable seal;
(b) grasping a lower region of the left portion using first mechanized grasping means;
(c) grasping a lower region of the right portion using second mechanized grasping means;
(d) separating the lower region of the left portion from the lower region of the right portion;
wherein the seal is pulled open and at least a portion of the ingredient is dispensed.

14. The method of claim 1 further comprising:
(i) a base, and a first surface having at least r the passage of air;
(ii) a sheet of material having a second and a third surface, the second surface able to contact the first surface of the base and conform to it when air is substantially withdrawn through the at least one port causing the first and second surfaces to come into dose comfort, and the third surface able to contact the food ingredient;
(iii) means for further preparing the ingredient selected from the group consisting of 1) heating, 2) cooling, 3) freezing, 4) boiling, 5) evaporating, and 6) dehydrating;
wherein one of the means of element (iii) is operated to further process the ingredient.
